(19) United States
(12) Patent Application Publication
(10) Pub. No.: US 2014/0292238 A1
(43) Pub. Date: Oct. 2, 2014

(54) Power Conversion Device

(71) Applicants: Kimihisa Furukawa, Tokyo (JP); Toshiyuki Ajima, Tokyo (JP); Hiroyuki Yamada, Hitachinaka (JP); Toshisada Mitsui, Hitachinaka (JP)

(72) Inventors: Kimihisa Furukawa, Tokyo (JP); Toshiyuki Ajima, Tokyo (JP); Hiroyuki Yamada, Hitachinaka (JP); Toshisada Mitsui, Hitachinaka (JP)

(73) Assignee: Hitachi Automotive Systems, Ltd., Hitachinaka-shi, Ibaraki (JP)

(21) Appl. No.: 14/240,598

(22) PCT Filed: Aug. 29, 2012
(86) PCT No.: PCT/JP2012/071834

§ 371 Date: May 15, 2014

(30) Foreign Application Priority Data
Aug. 31, 2011 (JP) 2011-188155

(51) Int. Cl. H02P 21/00

(52) U.S. Cl. CPC H02P 21/0096
USPC 318/400.02

(57) ABSTRACT

A power conversion device includes a switching circuit with multiple series circuits having upper arm switching elements connected in series with lower arm switching elements, receives DC power to generate AC power for a permanent magnet motor; a control circuit that calculates a state of the switching elements based on input information for each control cycle, and generates a control signal for controlling switching elements according; and a driver circuit that generates a drive signal that renders the switching elements conductive or non-conductive on the basis of the control signal from the control circuit. The control circuit predicts a locus of a d-axial magnetic flux and a locus of a q-axial magnetic flux, and calculates the state of the switching elements so that the d-axial magnetic flux falls within a given d-axial magnetic flux fluctuation range, and the q-axial magnetic flux falls within a given q-axial magnetic flux fluctuation range.

### TECHNICAL FIELD

The present invention relates to a power conversion device that converts a DC power into an AC power, or converts an AC power into a DC power.

### BACKGROUND ART

A power conversion device that receives a DC power, and converts the DC power into an AC power for supply to a rotating electrical machine includes a plurality of switching elements, and the switching elements repeats the switching operation to convert the supplied DC power into the AC power. Most of the power conversion devices are also used to convert the AC power induced in the rotating electrical machine into the DC power through the switching operation of the switching elements. It is general that the above-mentioned switching elements are controlled on the basis of a pulse width modulation system (hereinafter referred to “PWM”) using a carrier wave that is varied at a given frequency. A control precision is improved with an increase in the frequency of the carrier wave to have a tendency to smoothen a generated torque of the rotating electrical machine.

An example of the power conversion device is disclosed in JP-A-Sho-63(1988)-234878 (refer to PTL 1).

### CITATION LIST

### Patent Literature

PTL 1: JP-A-Sho-63(1988)-234878

### SUMMARY OF INVENTION

### Technical Problem

However, if the control system is of the general PWM system, when the above switching element switches from a cut-off state to a conduction state, or switches from the conduction state to the cut-off state, a power loss increases to increase the amount of heat generation. It is desirable to reduce the power loss of the above-mentioned switching elements, and the amount of heat generation in the switching elements can be reduced with the reduction of the power loss. To achieve this, it is desirable to reduce the number of switching the switching elements. However, as described above, if the frequency of the carrier wave is decreased for the purpose of reducing the number of switching the switching elements per unit time, a strain of the current output from the power conversion device becomes large, to lead to an increase in the motor loss.

Under the circumstances, the present invention has been made in view of the above problem, and aims at providing a power conversion device connected to a permanent magnet motor, which reduces the switching loss and improves safety while suppressing an increase in the motor loss as much as possible. Embodiments described below reflect preferable research achievement as products, and solve a variety of more specific problems preferable as the products. Specific problems solved by specific configurations and operation in the following embodiments will be described in a section of the following Description of Embodiments.

### Solution to Problem

According to a first aspect of the present invention, there is provided a power conversion device connected to a permanent magnet motor, including: a power switching circuit that has a plurality of series circuits each having an upper arm switching element connected in series with a lower arm switching element, receives a DC power to generate an AC power, and outputs the generated AC power to the permanent magnet motor; a control circuit that repetitively calculates a state of the switching elements on the basis of input information for each given control cycle, and generates a control signal for controlling conduction or cut-off of the switching elements according to an arithmetic result; and a driver circuit that generates a drive signal that renders the switching element conductive or non-conductive on the basis of the control signal from the control circuit. In the power conversion device, the control circuit predicts a locus of a d-axial magnetic flux which is a d-axial component of a magnetic flux developed in the permanent magnet motor, and a locus of a q-axial magnetic flux which is a q-axial component of the magnetic flux developed in the permanent magnet motor, and calculates the state of the switching elements so that the d-axial magnetic flux falls within a given d-axial magnetic flux fluctuation range, and the q-axial magnetic flux falls within a given q-axial magnetic flux fluctuation range, on the basis of a prediction result. Also, the d-axis is a coordinate axis defined along a main magnetic flux direction of a permanent magnet arranged in a rotor of the permanent magnet motor, and the q-axis is a coordinate axis defined along a direction orthogonal to the d-axis.

According to a second aspect of the present invention, in the power conversion device according to the first embodiment, it is preferable that the control circuit includes a coordinate converter that converts a voltage instruction signal of a rotating coordinate system defined by the d-axis and the q-axis based on the input information into a voltage instruction signal of a given stationary coordinate system; a voltage vector region retriever that retrieves a voltage vector region corresponding to the voltage instruction signal on the basis of the voltage instruction signal converted by the coordinate converter, and determines an output voltage vector corresponding to the retrieved voltage vector region; a predictor that predicts the locus of the d-axial magnetic flux and the locus of the q-axial magnetic flux on the basis of the output voltage vector determined by the voltage vector region retriever, compares the locus of the predicted d-axial magnetic flux with the d-axial magnetic flux fluctuation range, and the locus of q-axial magnetic flux with the q-axial magnetic flux fluctuation range, respectively, and calculates the state of the switching elements and a switching time; and a signal output unit that outputs the control signal on the basis of the state of the switching elements and the switching time calculated by the predictor.

According to a third aspect of the present invention, in the power conversion device according to the first or second embodiment, it is preferable that if an electrical resistance value of the permanent magnet is smaller than an electrical resistance value of an iron core of the rotor, the d-axial magnetic flux fluctuation range is set to be smaller than the q-axial magnetic flux fluctuation range, and if the electrical resistance value of the permanent magnet is larger than the electrical resistance value of the iron core of the rotor, the d-axial magnetic flux fluctuation range is set to be larger than the q-axial magnetic flux fluctuation range.

According to a fourth aspect of the present invention, there is provided a power conversion device connected to a permanent magnet motor, including: a power switching circuit that has a plurality of series circuits each having an upper arm switching element connected in series with a lower arm switching element, receives a DC power to generate an AC power, and outputs the generated AC power to the permanent magnet motor; a control circuit that repetitively calculates a state of the switching elements on the basis of input information for each given control cycle, and generates a control signal for controlling conduction or cut-off of the switching elements according to an arithmetic result; and a driver circuit that generates a drive signal that renders the switching element conductive or non-conductive on the basis of the control signal from the control circuit. In the power conversion device, the control circuit predicts a locus of a d-axial current which is a d-axial component of a current flowing in the permanent magnet motor, and a locus of a q-axial current which is a q-axial component of the current flowing in the permanent magnet motor, and calculates the state of the switching elements so that the d-axial current falls within a given d-axial current fluctuation range, and the q-axial current falls within a given q-axial current fluctuation range, on the basis of a prediction result. Also, the d-axis is a coordinate axis defined along a main magnetic flux direction of a permanent magnet arranged in a rotor of the permanent magnet motor, and the q-axis is a coordinate axis defined along a direction orthogonal to the d-axis.

According to a fifth aspect of the present invention, in the power conversion device according to the fourth embodiment, it is preferable that the control circuit includes: a coordinate converter that converts a voltage instruction signal of a rotating coordinate system defined by the d-axis and the q-axis based on the input information into a voltage instruction signal of a given stationary coordinate system; a voltage vector region retriever that retrieves a voltage vector region corresponding to the voltage instruction signal on the basis of the voltage instruction signal converted by the coordinate converter, and determines an output voltage vector corresponding to the retrieved voltage vector region; a predictor that predicts the locus of the d-axial current and the locus of the q-axial current on the basis of the output voltage vector determined by the voltage vector region retriever, compares the locus of the predicted d-axial current with the d-axial current fluctuation range, and the locus of q-axial current with the q-axial current fluctuation range, respectively, and calculates the state of the switching elements and a switching time; and a signal output unit that outputs the control signal on the basis of the state of the switching elements and the switching time calculated by the predictor.

According to a sixth aspect of the present invention, in the power conversion device according to the fourth or fifth embodiment, it is preferable that if an electrical resistance value of the permanent magnet is smaller than an electrical resistance value of an iron core of the rotor, the d-axial current fluctuation range is set to be smaller than the q-axial current fluctuation range, and if the electrical resistance value of the permanent magnet is larger than the electrical resistance value of the iron core of the rotor, the d-axial current fluctuation range is set to be larger than the q-axial current fluctuation range.

### Advantageous Effects of Invention

According to the present invention, in the power conversion device, an increase in the motor loss can be suppressed to some degree, and the switching loss can be further reduced.

In the following embodiment, the problems desired as the product are variously solved as described later.

### BRIEF DESCRIPTION OF DRAWINGS

FIG. 1 is a diagram illustrating a control block of a hybrid electric vehicle.

FIG. 2 is a diagram illustrating a circuit configuration of an inverter circuit 140.

FIG. 3 is an external perspective view of a power conversion device 200 according to an embodiment of the present invention.

FIG. 4 is an external perspective view of the power conversion device 200 according to the embodiment of the present invention.

FIG. 5 is a diagram illustrating a state in which a cover 8, a DC interface 137, and an AC interface 185 are removed from the power conversion device 200 illustrated in FIG. 4.

FIG. 6 is a diagram illustrating a state in which a housing 10 is removed from a flow channel forming body 12 in FIG. 5.

FIG. 7 is an exploded perspective view of the power conversion device 200.

FIG. 8 is an external perspective view of a configuration in which power modules 300U to 300W, a capacitor module 500, and a busbar assembly 800 are assembled into the flow channel forming body 12.

FIG. 9 is a diagram illustrating a state in which the busbar assembly 800 is removed from the flow channel forming body 12.

FIG. 10 is a perspective view of the flow channel forming body 12.

FIG. 11 is an exploded perspective view of the flow channel forming body 12 viewed from a rear surface side.

FIG. 12A is a perspective view of the power module 300U according to this embodiment.

FIG. 12B is a cross-sectional view of the power module 300U taken along a cross-section D and viewed from a direction E according to this embodiment.

FIG. 13A is a perspective view illustrating a state in which screws 309 and a second sealing resin 351 are removed from the power module 300U illustrated in FIGS. 12A and 12B.

FIG. 13B is a cross-sectional view of the power module 300U in a state illustrated in FIG. 13A, which is taken along the cross-section D and viewed from the direction E, as in FIG. 12B.

FIG. 13C is a cross-sectional view of the power module 300U before a fin 305 is pressurized to deform a curved portion 304A.

FIG. 14A is a perspective view illustrating a state in which a module case 304 is further removed from the power module 300U illustrated in FIGS. 13A and 13B.

FIG. 14B is a cross-sectional view of the power module 300U in a state illustrated in FIG. 14A, which is taken along the cross-section D and viewed from the direction E, as in FIG. 12B and FIG. 13B.

FIG. 15 is a perspective view illustrating the power module 300U in which a first sealing resin 348 and a wiring insulating portion 608 are further removed from a state illustrated in FIG. 14B.

FIG. 16 is a diagram illustrating a process of assembling a primary module sealing body 302.

FIG. 17 is an external perspective view of the capacitor module 500.

FIG. 18 is a perspective view illustrating the busbar assembly 800.

FIG. 19 is a diagram illustrating the flow channel forming body 12 in which the power modules 300U to 300W are fixed to opening portions 402a to 402c, and the capacitor module 500 is stored in a storage space 405.

FIG. 20 is a conceptual diagram illustrating a U phase voltage, a U phase current, a d-axial current, a q-axial current, and a magnetic flux when applying a PWM control.

FIG. 21 is a conceptual diagram illustrating the U phase voltage, the U phase current, the d-axial current, the q-axial current, and the magnetic flux when applying the PWM control.

FIG. 22 is a conceptual diagram illustrating the U phase voltage, the U phase current, the d-axial current, the q-axial current, and the magnetic flux when applying a modulation system according to the present invention.

FIG. 23 is a diagram illustrating respective voltage pulses of three phases of U, V, and W, a d-axial current ripple ΔId, a q-axial current ripple ΔIq, and respective currents of the three phases of U, V, and W when applying the modulation system according to the present invention.

FIG. 24 is a conceptual diagram illustrating a method of determining a desired output voltage vector in response to a given voltage instruction in the modulation system according to the present invention.

FIG. 25 is a diagram illustrating a method of selecting an instruction voltage vector and an output voltage vector, and an appearance of a change in the magnetic flux at the time of selection.

FIG. 26 is a diagram illustrating a method of selecting the instruction voltage vector and the output voltage vector, and an appearance of the change in the magnetic flux at the time of selection.

FIG. 27 is a diagram illustrating a method of selecting the instruction voltage vector and the output voltage vector, and an appearance of the change in the magnetic flux at the time of selection.

FIG. 28 is a diagram illustrating a method of selecting the instruction voltage vector and the output voltage vector, and an appearance of the change in the magnetic flux at the time of selection.

FIG. 29 is a conceptual diagram illustrating a state in which calculation results are output from a microcomputer terminal.

FIG. 30 is a diagram illustrating a motor control system using a control circuit according to the embodiment of the present invention.

FIG. 31 is a diagram illustrating a configuration of a pulse modulator.

FIG. 32 is a flowchart illustrating a procedure of generating pulses, which is conducted by the pulse modulator.

FIG. 33 is a diagram illustrating a concept of voltage vector region retrieval processing, which is conducted by a voltage vector region retriever.

FIG. 34 is a flowchart illustrating a flow of the voltage vector region retrieval processing.

FIG. 35A is a flowchart illustrating a flow of SW state prediction processing.

FIG. 35B is a flowchart illustrating a flow of the SW state prediction processing in another processing method.

FIG. 36 is a flowchart illustrating a flow of three-phase SW state conversion processing.

FIG. 37 is a diagram illustrating a basic principle of pulse generation by the pulse modulator according to this embodiment.

FIG. 38 is a diagram illustrating an example of pulse waveforms output when pulse continuity compensation is not conducted.

FIG. 39 is a diagram illustrating an example of the pulse waveforms output when the pulse continuity compensation is conducted.

FIG. 40 is a diagram illustrating an example of the pulse waveforms output when minimum pulse width limitation is conducted.

FIG. 41 is a flowchart illustrating a procedure of pulse correction processing in detail.

FIG. 42 is a diagram illustrating an example of the pulse waveforms when respective processing of Steps 941, 942, 943, and 944 is executed in sequence in the flowchart of FIG. 41.

FIG. 43 is a diagram illustrating an example of the pulse waveforms when the respective processing of Steps 941, 942, and 943 is executed in sequence, and the processing of Step 904 is not executed, in the flowchart of FIG. 41.

FIG. 44 is a diagram illustrating an example of the pulse waveforms when the respective processing of Steps 941, 942, 945, and 946 is executed in sequence in the flowchart of FIG. 41.

FIG. 45 is a diagram illustrating an example of the pulse waveforms when the respective processing of Steps 941, 942, and 945 is executed in sequence, and the processing of Step 946 is not executed, in the flowchart of FIG. 41.

FIG. 46 is a diagram illustrating an example of the pulse waveforms when the respective processing of Steps 941, 947, 948, and 949 is executed in sequence in the flowchart of FIG. 41.

FIG. 47 is a diagram illustrating an example of the pulse waveforms when the respective processing of Steps 941, 947, and 948 is executed in sequence, and the processing of Step 949 is not executed, in the flowchart of FIG. 41.

FIG. 48 is a diagram illustrating an example of the pulse waveforms when the respective processing of Steps 941, 947, 950, and 951 is executed in sequence in the flowchart of FIG. 41.

FIG. 49 is a diagram illustrating an example of the pulse waveforms when the respective processing of Steps 941, 947, 950, and 952 is executed in sequence in the flowchart of FIG. 41.

### DESCRIPTION OF EMBODIMENTS

In addition to the description in the section of Technical Problem and the section of Advantageous Effects of Invention described above, in the following embodiments, the desirable problem can be solved in commercialization of products, and desired advantages are obtained in the commercialization of products. Several problems and advantages will be described below, and even in the description of embodiments, specific solutions to the problems, and specific advantages will be described.

### [Reduction in Switching Frequency of Switching Elements]

In a power conversion device described in the following embodiments, in order to control the switching operation of switching elements on the basis of an AC magnetic flux ripple converted from a DC power, and a magnetic position signal of a motor, a drive signal is supplied from a driver circuit to the switching elements, and the switching elements conduct conduction or cut-off operation in association with a magnetic pole position of the motor. With the above configuration and action, the number of switching the switching elements per unit time, or the number of switching an AC power per one cycle can be reduced as compared with the general PWM system. Also, in the above configuration, although the switching frequency of the switching elements in a power switching circuit is reduced, there are advantageous in that a loss of the motor can be suppressed, and the loss associated with the switching operation can be reduced. This leads to a reduction in the heat generation of the switching elements in the power switching circuit, and the heat generation and demagnetization caused by a magnet eddy current of the motor.

In the embodiment described below, instead of a reduction in the fluctuation of the magnetic flux in a direction linked with a magnet of a rotor, a fluctuation of the magnetic flux in a direction not linked with the magnet, or small in a region linked with the magnet is allowed to enable the number of switching the switching elements in the power switching circuit per unit time to be reduced. The number of switching the switching elements in the power switching circuit can be reduced.

As the switching elements, elements which are high in operating speed, and can control both of conduction and cut-off operation on the basis of a control signal are desirable. As the elements of this type, there are, for example, insulated gate bipolar transistors (hereinafter referred to as “IGBT”), and field effect transistors (MOS transistors), and those elements are desirable from the viewpoints of response and controllability.

An AC power output from the above power conversion device is supplied to an inductance circuit formed of a rotating electrical machine, and an AC current flows on the basis of an action of the inductance. In the following embodiment, the rotating electrical machine that conducts the action of the motor or a generator as the inductance circuit will be exemplified. The application of the present invention for the purpose of generating the AC power for driving the rotating electrical machine is optimum from the viewpoint of the advantages. However, the present invention can be also used as the power conversion device that supplies the AC power to the inductance circuit other than the rotating electrical machine.

In the following embodiment, the motor as the rotating electrical machine and a motor generator used as a power generator will be described as an example.

### (Basic Control)

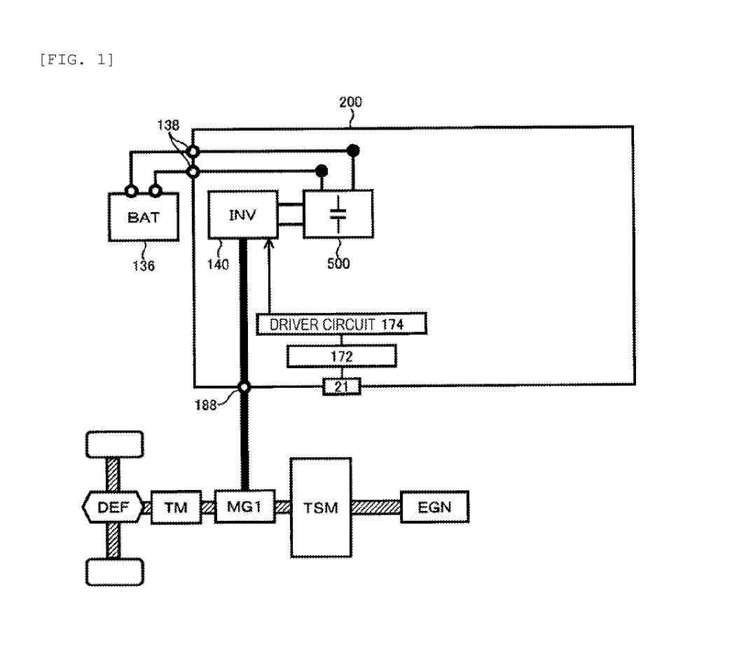

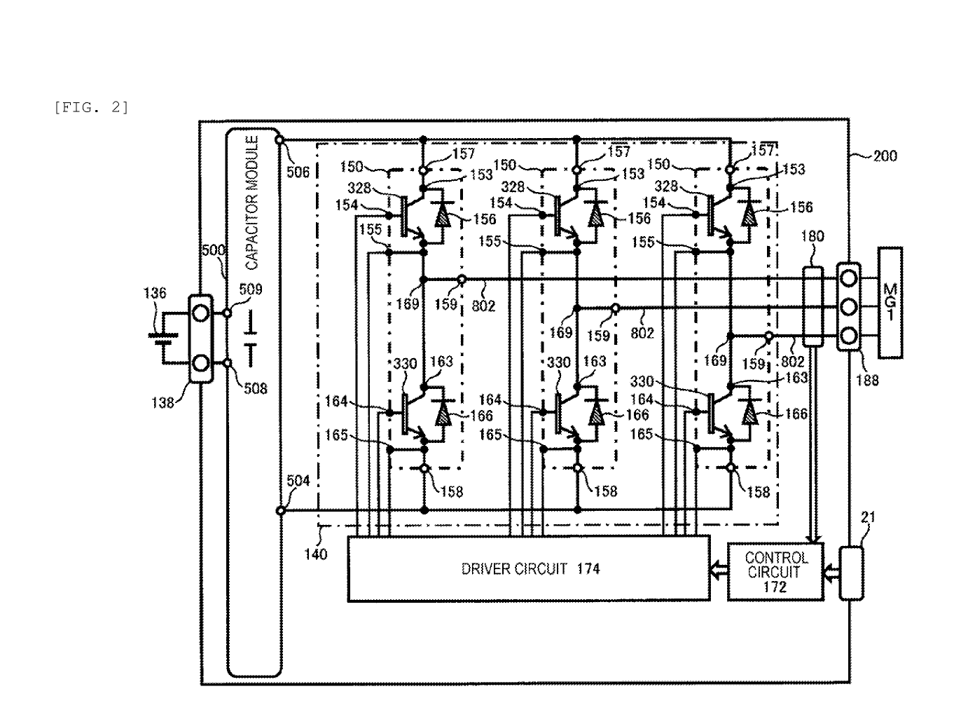

The power conversion device according to the embodiment of the present invention will be described in detail below with reference to the drawings. The power conversion device according to the embodiment of the present invention is applied to a power conversion device that generates an AC power for driving the rotating electrical machine of a hybrid electric vehicle (hereinafter referred to as “HEV”) or a pure electric vehicle (hereinafter referred to as “EV”). The power conversion device for the HEV and the power conversion device for the EV have a basic configuration and control in common with each other. As a representative example, a control configuration and a circuit configuration of the power conversion device when the power conversion device according to the embodiment of the present invention is applied to the hybrid electric vehicle will be described with reference to FIGS. 1 and 2.

FIG. 1 is a diagram illustrating a control block of a hybrid electric vehicle (hereinafter referred to as “HEV”). An engine EGN and a motor generator MG1 generate a travel torque of the vehicle. Also, the motor generator MG1 not only generates a rotating torque, but also has a function of converting a mechanical energy supplied to the motor generator MG1 from an external into an electric power.

The motor generator MG1 is a synchronous machine, and also operates as the motor or the power generator depending on a driving method as described above. When the motor generator MG1 is mounted in the vehicle, it is desirable that the motor generator MG1 is small in size, and a high output is obtained, and a synchronous electric motor of a permanent magnet type using a magnet such as neodymium is suitable for the motor generator MG1. Also, the synchronous electric motor of the permanent magnet type is smaller in the heat generation of the rotor than an induction motor, and excellent as the vehicle also from this viewpoint.

An output torque of the engine EGN on an output side is transmitted to the motor generator MG1 through a power transfer mechanism TSM, and a rotating torque from the power distribution mechanism TSM or the rotating torque generated by the motor generator MG1 is transmitted to wheels through a transmission TM and a differential gear DEF. On the other hand, in the driving of regenerative braking, a rotating torque is transmitted from the wheels to the motor generator MG1, and an AC power is generated on the basis of the supplied rotating torque. The generated AC power is converted into a DC power by a power conversion device 200 as will be described later, a high-voltage battery 136 is charged, and a charged power is again used as a travel energy.

Subsequently, the power conversion device 200 will be described. An inverter circuit 140 is electrically connected to the battery 136 through a DC connector 138, and the power is transferred between the battery 136 and the inverter circuit 140. When the motor generator MG1 operates as the motor, the inverter circuit 140 generates the AC power on the basis of the DC power supplied from the battery 136 through the DC connector 138, and supplies the AC power to the motor generator MG1 through an AC connector 188. A configuration of the motor generator MG1 and the inverter circuit 140 operates as a first motor generation unit.

In this embodiment, the first motor generation unit is actuated by the power of the battery 136 as a motor unit, as a result of which the vehicle can be driven by only the power of the motor generator MG1. Further, in this embodiment, the first motor generation unit is actuated as the motor unit by a power of an engine 120 or a power from the wheels to generate an electric power with which the battery 136 can be charged.

Also, although omitted from FIG. 1, the battery 136 is also used as a power supply for driving motors for accessories. The motors for accessories are, for example, a motor for driving a compressor of an air conditioner, or a motor for driving a hydraulic pump for control. The DC power is supplied from the battery 136 to an accessory power module, and the accessory power module generates an AC power, and supplies the AC power to the motors for accessories. The accessory power module basically has the same circuit configuration and function as those of the inverter circuit 140, and controls a phase and a frequency of an AC current, and the power to be supplied to the motors for auxiliaries. The power conversion device 200 includes a capacitor module 500 for smoothing the DC power which is supplied to the inverter circuit 140.

The power conversion device 200 is equipped with a communication connector 21 for receiving an instruction from a host control device, or transmitting data indicative of a state to the host control device. The power conversion device 200 calculates a controlled variable of the motor generator MG1 by a control circuit 172 on the basis of an instruction input from the connector 21, and further calculates whether the motor generator MG1 operates as the motor, or operates as the power generator. Then, the power conversion device 200 generates a control pulse on the basis of the calculation result, and supplies the control pulse to a driver circuit 174. The driver circuit 174 generates a drive pulse for controlling the inverter circuit 140 on the basis of the supplied control pulse.

Subsequently, a configuration of an electric circuit of the inverter circuit 140 will be described with reference to FIG. 2. FIG. 2 is a diagram illustrating a circuit configuration of the inverter circuit 140. In the following description, an insulated gate bipolar transistor is used as a semiconductor device, and hereinafter referred to as “IGBT” for short. A series circuit 150 of upper and lower arms is configured by an IGBT 328 and a diode 156 which operate as the upper arm, and an IGBT 330 and a diode 166 which operate as the lower arm. The inverter circuit 140 includes the respective series circuits 150 in correspondence with three phases of a U phase, a V phase, and a W phase of the AC power to be output. That is, the inverter circuit 140 as the power switching circuit includes a plurality of series circuits 150 each connecting the IGBT 328, which is the upper arm switching element, and the IGBT 330, which is the lower arm switching element, in series with each other.

Those three phases correspond to the respective winding wires of three phases of an armature winding wire in the motor generator MG1 in this embodiment. The series circuit 150 of the upper and lower arms in each of the three phases outputs an AC current from a connection point (intermediate electrode) 169 which is a midpoint portion of the series circuit. The intermediate electrode 169 is connected to the motor generator MG1 through AC busbars 802 to be described later, which is connected between an AC terminal 159 and the AC connector 188.

A collector electrode 153 of the IGBT 328 in the upper arm is electrically connected to a capacitor terminal 506 of the capacitor module 500 on a positive electrode side through a positive electrode terminal 157. Also, an emitter electrode of the IGBT 330 in the lower arm is electrically connected to a capacitor terminal 504 of the capacitor module 500 on a negative electrode side through a negative electrode terminal 158.

As described above, the control circuit 172 receives a control instruction from the host control device through the connector 21, and generates a control pulse which is a control signal for controlling the IGBT 328 or the IGBT 330 configuring the upper arm or the lower arm of the series circuit 150 for each of the phases, which configure the inverter circuit 140, on the basis of the control instruction, and supplies the control pulse to the driver circuit 174.

The driver circuit 174 supplies the drive pulse for controlling the IGBT 328 or the IGBT 330 configuring the upper arm or the lower arm of the series circuit 150 for each of the phases to the IGBT 328 or the IGBT 330 for each of the phases, on the basis of the above control pulse. Each of the IGBT 328 and the IGBT 330 conducts the conduction or cut-off operation on the basis of the drive pulse from the driver circuit 174, converts the DC power supplied from the battery 136 into a three-phase AC power, and the converted power is supplied to the motor generator MG1.

The IGBT 328 includes the collector electrode 153, a signal emitter electrode 155, and a gate electrode 154. Also, the IGBT 330 includes a collector electrode 163, a signal emitter electrode 165, and a gate electrode 164. The diode 156 is electrically connected between the collector electrode 153 and the emitter electrode 155. Also, the diode 166 is electrically connected between the collector electrode 163 and the emitter electrode 165.

As the switching power semiconductor device, there may be used a metal oxide semiconductor field effect transistor (hereinafter referred to as “MOSFET” for short). In this case, the diode 156 and the diode 166 are unnecessary. As the switching power semiconductor device, the IGBT is suitable for a case in which the DC voltage is relatively high, and the MOSFET is suitable for a case in which the DC voltage is relatively low.

The capacitor module 500 includes the capacitor terminal 506 on the positive electrode side, the capacitor terminal 504 on the negative electrode side, a power terminal 509 on the positive electrode side, and a power terminal 508 on the negative electrode side. The DC power of a high voltage from the battery 136 is supplied to the power terminal 509 on the positive electrode side and the power terminal 508 on the negative electrode side through the DC connector 138, and supplied to the inverter circuit 140 from the capacitor terminal 506 on the positive electrode side and the capacitor terminal 504 on the negative electrode side in the capacitor module 500.

On the other hand, the DC power converted from the AC power by the inverter circuit 140 is supplied to the capacitor module 500 from the capacitor terminal 506 on the positive electrode side and the capacitor terminal 504 on the negative electrode side. The DC power is supplied to the battery 136 from the power terminal 509 on the positive electrode side and the power terminal 508 on the negative electrode side through the DC connector 138, and stored in the battery 136.

The control circuit 172 includes a microcomputer (hereinafter referred to as “microcomputer”) for conducting arithmetic processing on the switching timing of the IGBT 328 and the IGBT 330. As input information to the microcomputer, there are a target torque value required for the motor generator MG1, a current value supplied from the series circuit 150 to the motor generator MG1, and a magnetic pole position of the rotor of the motor generator MG1.

The target torque value is based on an instruction signal output from the host control device not shown. The current value is detected on the basis of a detection signal by a current sensor 180. The magnetic pole position is detected on the basis of the detection signal output from a rotating magnetic pole sensor (not shown) such as a resolver which is equipped in the motor generator MG1. In this embodiment, the current sensor 180 detects the current values of three phases as an example. Alternatively, the current sensor 180 may be configured to detect the current vales for two phases, and obtain the currents for three phases through calculation.

A microcomputer within the control circuit 172 calculates current instruction values of the d- and q-axes of the motor generator MG1 on the basis of the input target torque value, calculates voltage instruction values of the B- and q-axes on the basis of differences between the calculated current instruction values of the d- and q-axes, and the detected current values of the d- and q-axes, and generates a pulsed drive signal according to the voltage instruction values of the d- and q-axes. The control circuit 172 has a function of generating a drive signal of a system according to the embodiment of the present invention which will be described later.

The d-axis is a coordinate axis defined along a main magnetic flux direction by a permanent magnet arranged in the rotor of the motor generator MG1 which is a permanent magnet motor. Also, the q-axis is a coordinate axis defined along a direction orthogonal to the d-axis (that is, the main magnetic flux).

This system is a modulation system that controls the switching operation of the IGBTs 328 and 330 which are the switching elements on the basis of a ripple of an AC waveform to be output, and a magnetic pole position signal of the motor.

In the case of driving the lower arm, the driver circuit 174 amplifies a signal of the pulsed modulation wave, and outputs this signal as the drive signal to the gate electrode of the IGBT 330 in the corresponding lower arm. Also, in the case of driving the upper arm, the driver circuit 174 shifts a level of a reference potential of the signal of the pulsed modulation wave to a level of a reference potential of the upper arm to amplify the signal of the pulsed modulation wave, and outputs this signal as the drive signal to the gate electrode of the IGBT 328 in the corresponding upper arm. With the above operation, the respective IGBTs 328 and 330 conduct the switching operation on the basis of the input drive signal. Through the switching operation of the respective IGBTs 328 and 330 which is thus conducted according to the drive signal (drive signal) from the driver circuit 174, the power conversion device 200 converts a voltage applied from the battery 136 which is a DC power supply into the respective output voltages of the U phase, the V phase, and the W phase which are each shifted by 2π/3rad in electric angle, and applies the output voltages to the motor generator MG1 which is a three-phase AC motor. The electric angle corresponds to a rotating state of the motor generator MG1, specifically, a position of the rotor, and is cyclically changed between 0 and 2π. When the electric angle is used as a parameter, the switching states of the respective IGBTs 328 and 330, that is, the respective output voltages of the U phase, the V phase, and the W phase can be determined according to a rotating state of the motor generator MG1.

Also, the microcomputer within the control circuit 172 detects abnormality (overcurrent, overvoltage, overtemperature, etc.), and protects the series circuit 150. For that reason, the sensing information is input to the control circuit 172. For example, information on a current flowing into emitter electrodes of the IGBT 328 and the IGBT 330 is input to the corresponding drive unit (IC) from the emitter electrode 155 for signals and the emitter electrode 165 for signals in the respective arms. With the above operation, the respective drive units (ICs) detects the overcurrent, and if the overcurrent is detected, the respective drive units stop the switching operation of the corresponding IGBTs 328 and 330, and protects the IGBTs 328 and 330 from overcurrent.

Information on a temperature of the series circuit 150 is input from a temperature sensor (not shown) disposed in the series circuit 150 to the microcomputer. Also, information on the voltage on the DC positive electrode side of the series circuit 150 is input to the microcomputer. The microcomputer conducts the overtemperature detection and the overvoltage detection on the basis of those pieces of information, and stops the switching operation of all of the IGBTs 328 and 330 if the overtemperature or the overvoltage is detected.

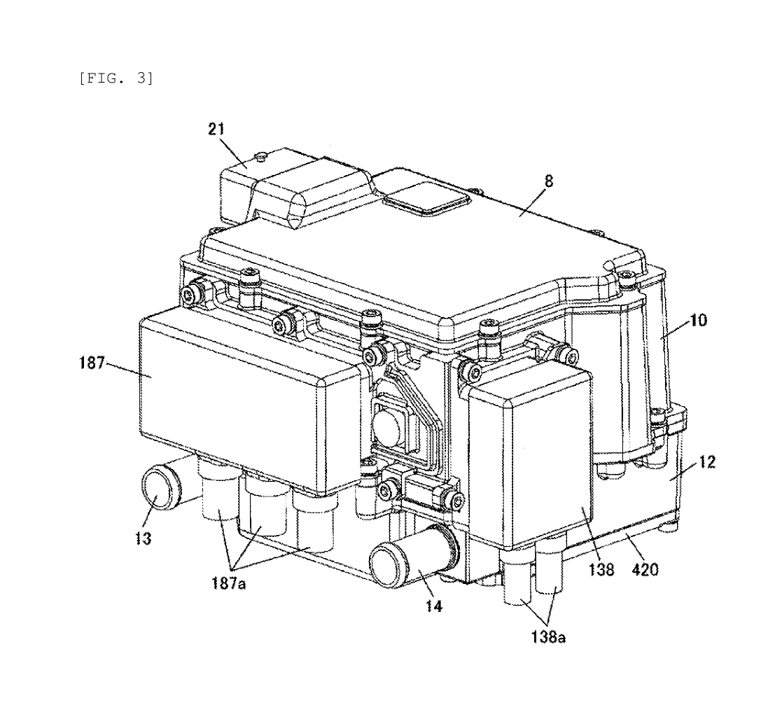

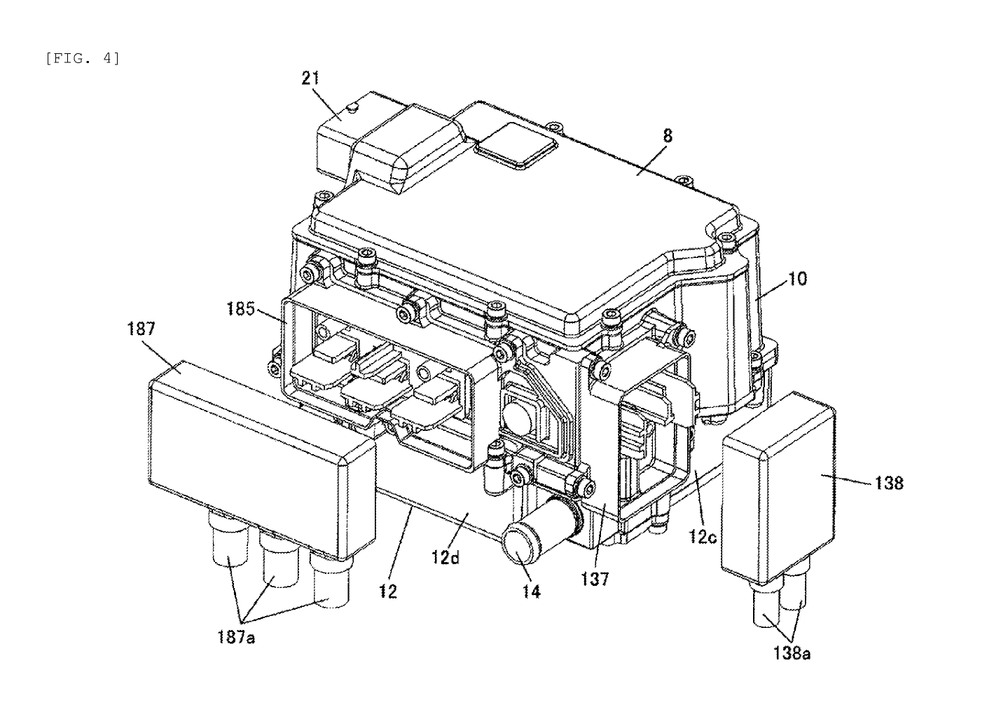

FIGS. 3 and 4 are external perspective views of the power conversion device 200 according to the embodiment of the present invention. FIG. 4 illustrates a state in which an AC connector 187 and the DC connector 138 are removed from the power conversion device 200. The power conversion device 200 according to this embodiment is downsized by being shaped into a cuboid substantially square in a planar configuration, and also has an advantage that it is easy to fit the power conversion device 200 to the vehicle. Reference numeral 8 denotes the cover, 10 is the housing, 12 is the flow channel forming body, 13 is an inlet piping of a cooling medium, 14 is an outlet piping, and 420 is a lower cover. The connector 21 is a signal connector disposed for connection to the external.

The cover 8 is fixed to an upper opening portion of the housing 10 in which circuit components configuring the power conversion device 200 are housed. The flow channel forming body 12 fixed to a lower portion of the housing 10 holds the power module 300 and the capacitor module 500, which will be described later, therein, and cools the power module 300 and the capacitor module 500 by the cooling medium. The cooling medium is frequently made of, for example, water, and will be described below as refrigerant. The inlet piping 13 and the outlet piping 14 are disposed on one side surface of the flow channel forming body 12, and the refrigerant supplied from the inlet piping 13 flows into a flow channel 19, which will be described later, within the flow channel forming body 12, and is discharged from the outlet piping 14. Even if directions along which the refrigerant inflows or outflows are changed, a cooling efficiency and a pressure loss are not largely affected by the change. That is, even if the refrigerant inflows from the outlet piping 14 side, and outflows from the inlet piping 13, the cooling efficiency and the pressure loss do not substantially change. That is, the power conversion device 200 according to this embodiment has an advantage that a layout of the inlet piping 13 and the outlet piping 14 can be changed according to a status of a refrigerant piping of the vehicle since the layout is symmetrical with respect to a center portion of the power conversion device 200.

The AC interface 185 in which the AC connector 187 is loaded, and the DC interface 137 in which the DC connector 138 is loaded are disposed on side surfaces of the housing 10. The AC interface 185 is disposed on the side surface in which the pipings 13 and 14 are disposed. AC wirings 187a of the AC connector 187 loaded in the AC interface 185 pass between the inlet pipings 13 and 14, and extend downward. The DC interface 137 is disposed on a side surface adjacent to the side surface on which the AC interface 185 is disposed, and DC wirings 138a of the DC connector 138 loaded in the DC interface 137 also extend below the power conversion device 200.

In this way, the AC interface 185, and the inlet pipings 13, 14 are arranged on a side of the same side surface 12d, and the AC wirings 187a are drawn downward so as to pass between the inlet pipings 13 and 14. Therefore, a space occupied by the inlet pipings 13, 14, the AC connector 187, and the AC wirings 187a can be reduced, and an upsized overall device can be reduced. Also, since the AC wirings 187a are drawn below the inlet pipings 13 and 14, routing of the AC wirings 187a becomes easy to improve the productivity.

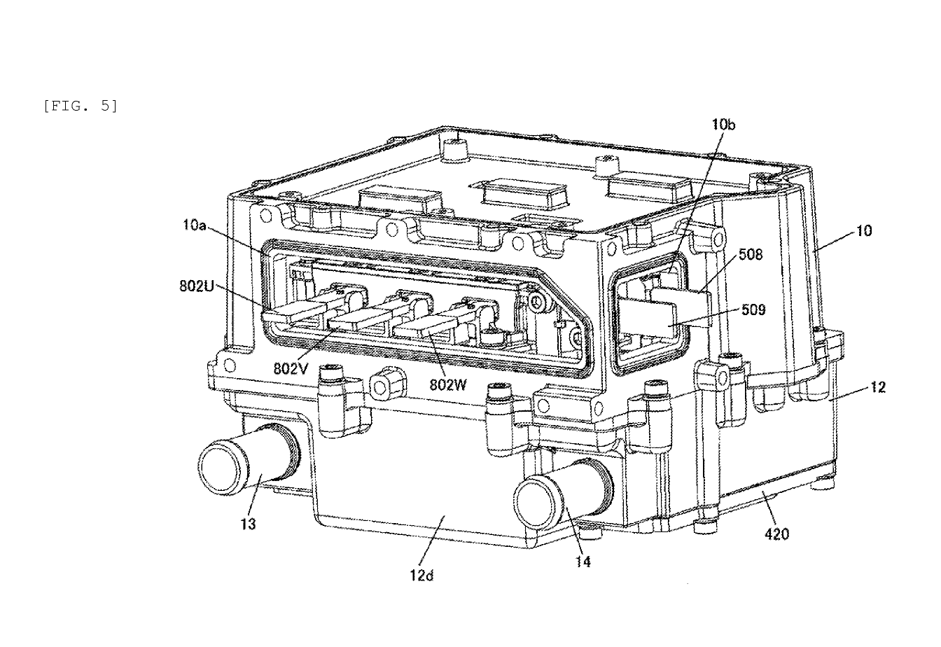

FIG. 5 is a diagram illustrating a state in which the cover 8, the DC interface 137, and the AC interface 185 are removed from the power conversion device 200 illustrated in FIG. 4. One side surface of the housing 10 is formed with an opening 10a to which the AC interface 185 is fixed, and another adjacent side surface is formed with an opening 10b to which the DC interface 137 is fixed. The three AC busbars 802, that is, a U phase AC busbar 802U, a V phase AC busbar 802V, and a W phase AC busbar 802W are projected from the opening 10a, and the power terminals 508 and 509 on the DC side are projected from the opening 10b.

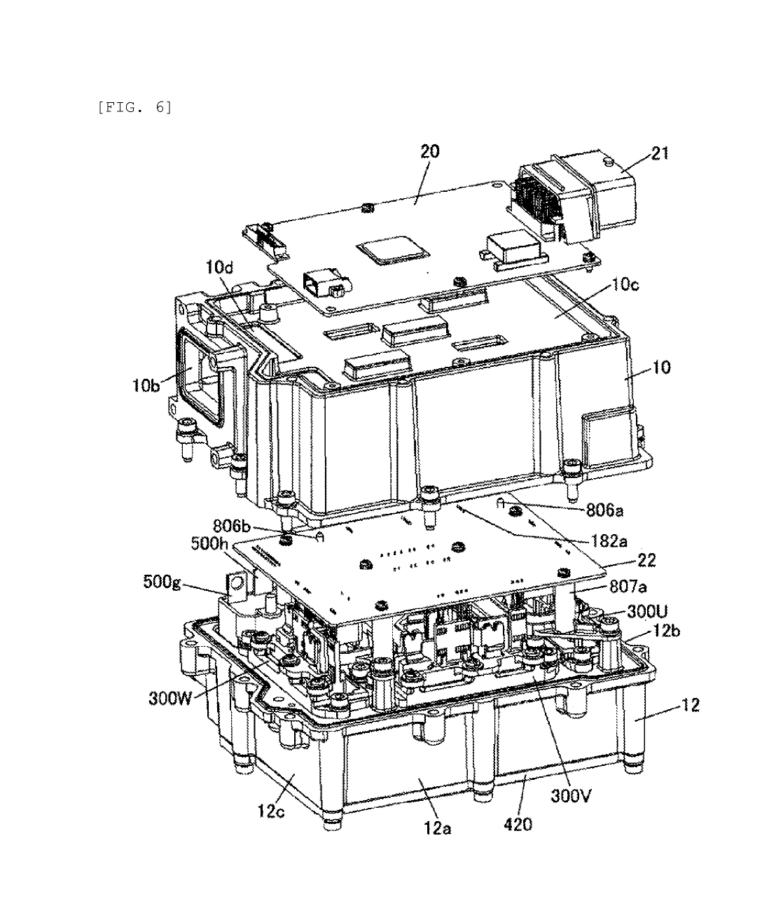

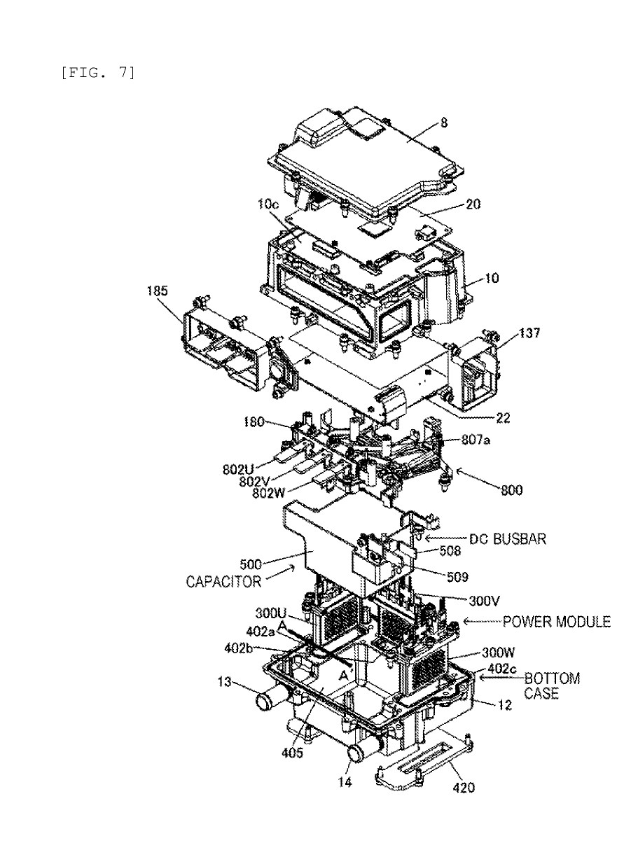

FIG. 6 is a diagram illustrating a state in which the housing 10 is removed from the flow channel forming body 12 in FIG. 5. The housing 10 has two storage spaces, and an upper storage space and a lower storage space are compartmented by a partition 10c. A control circuit board 20 to which the connector 21 is fixed is stored in the upper storage space, and a driver circuit board 22 and a busbar assembly 800 are stored in the lower storage space. The control circuit 172 illustrated in FIG. 2 is mounted on the control circuit board 20, and the driver circuit 174 is mounted on the driver circuit board 22. The control circuit board 20 and the driver circuit board 22 are connected to each other by a flat cable (refer to FIG. 7 to be described later) not shown, and the flat cable passes through a slit-like opening 10d formed in the partition 10c, and is drawn from the lower storage space to the upper storage space.

FIG. 7 is an exploded perspective view of the power conversion device 200. The control circuit board 20 on which the control circuit 172 is mounted as described above is arranged inside of the cover 8, that is, in the upper storage space of the housing 10. The cover 8 is formed with an opening 8a for the connector 21. A DC power of a low voltage for operating the control circuit within the power conversion device 200 is supplied from the connector 21.

Although described in detail later, the flow channel forming body 12 is formed with a flow channel in which the refrigerant inflows from the inlet piping 13 flows. The flow channel is formed of a U-shaped flow channel that allows the refrigerant to flow along three side surfaces of the flow channel forming body 12. The refrigerant inflowing from the inlet piping 13 inflows into the flow channel from one end of the U-shaped flow channel, and after the refrigerant has flown into the flow channel, the refrigerant outflows from the outlet piping 14 connected to the other end of the flow channel.

An upper surface of the flow channel is formed with three opening portions 402a to 402c, and the power modules 300U, 300V, and 300W each incorporating the series circuit 150 (refer to FIG. 1) therein are inserted into the flow channel from the respective opening portions 402a to 402c. The series circuit 150 of the U phase is incorporated into the power module 300U, the series circuit 150 of the V phase is incorporated into the power module 300V, and the series circuit 150 of the W phase is incorporated into the power module 300W. Those power modules 300U to 300W have the same configuration, and also have the same appearance configuration. The opening portions 402a to 402c are covered with flange portions of the inserted power modules 300U to 300W, respectively.

A storage space 405 for storing electrical components is formed in the flow channel forming body 12 so as to be surrounded by the U-shaped flow channel. In this embodiment, the capacitor module 500 is stored in the storage space 405. The capacitor module 500 stored in the storage space 405 is cooled by the refrigerant flowing in the flow channel. The busbar assembly 800 in which the AC busbars 802U to 802W are loaded is arranged above the capacitor module 500. The busbar assembly 800 is fixed to an upper surface of the flow channel forming body 12. The busbar assembly 800 is fixed with the current sensor 180.

The driver circuit board 22 is fixed to a support member 807a disposed in the busbar assembly 800 so as to be arranged above the busbar assembly 800. As described above, the control circuit board 20 and the driver circuit board 22 are connected to each other by a flat cable 23. The flat cable 23 passes through the slit-like opening 10d formed in the partition 10c, and is drawn from the lower storage space to the upper storage space.

In this way, the power modules 300U to 300W, the driver circuit board 22, and the control circuit board 20 are hierarchically arranged in the height direction, and the control circuit board 20 is arranged at a place farthest from the power modules 300U to 300W of a strong electric system. Therefore, the mixture of switching noise on the control circuit board 20 side can be reduced. Further, because the driver circuit board 22 and the control circuit board 20 are arranged in another storage space compartmented by the partition 10c, the partition 10c functions as an electromagnetic shield, and can reduce the noise mixed into the control circuit board 20 from the driver circuit board 22. The housing 10 is made of a metal material such as aluminum.

Further, because the control circuit board 20 is fixed to the partition 10c formed integrally with the housing 10, a mechanical resonance frequency of the control circuit board 20 becomes high with respect to vibration from an external. For that reason, the control circuit board 20 is hardly affected by the vibration from the vehicle side, and the reliability is improved.

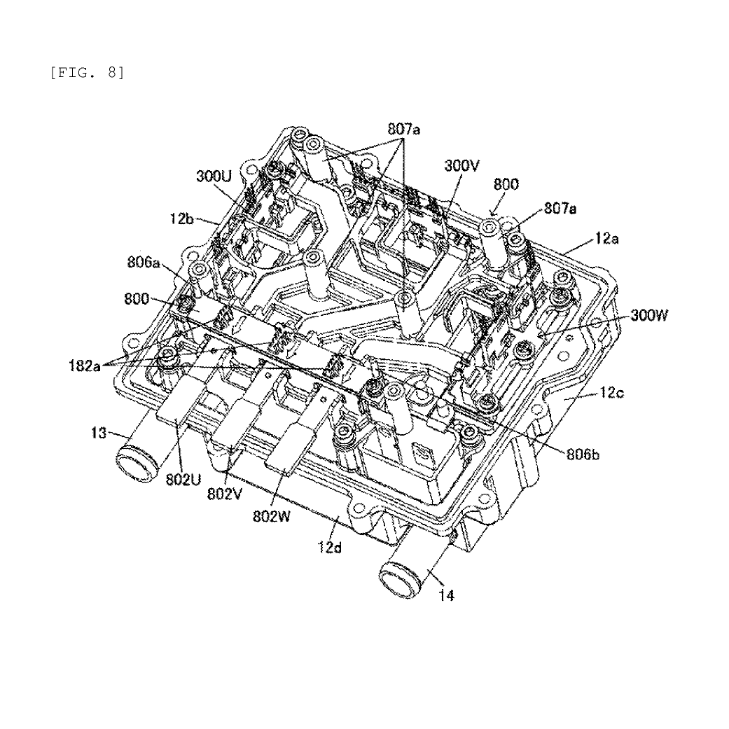

Hereinafter, the flow channel forming body 12, the power modules 300U to 300W fixed to the flow channel forming body 12, the capacitor module 500, and the busbar assembly 800 will be described in more detail. FIG. 8 is an external perspective view of a configuration in which the power modules 300U to 300W, the capacitor module 500, and the busbar assembly 800 are assembled into the flow channel forming body 12.

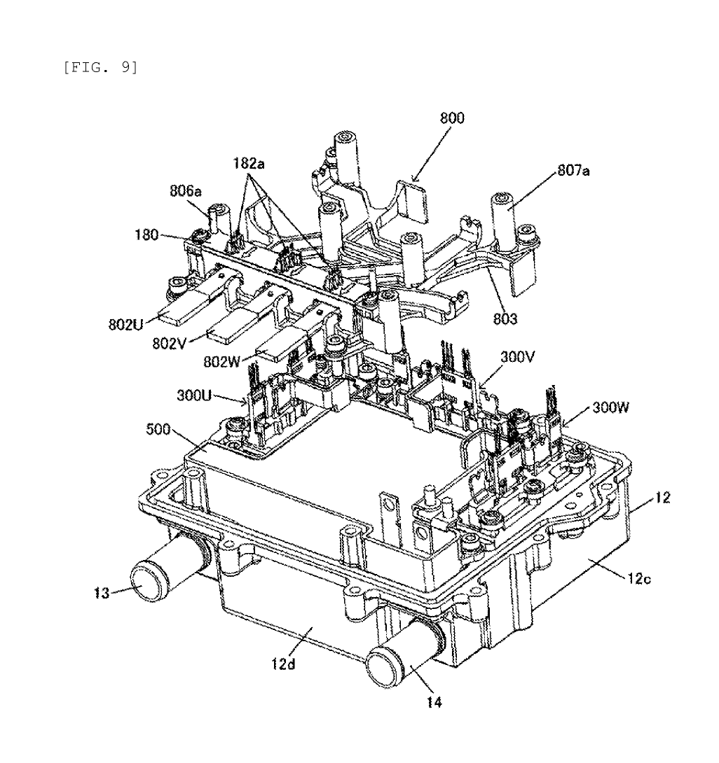

Also, FIG. 9 illustrates a state in which the busbar assembly 800 is removed from the flow channel forming body 12. The busbar assembly 800 is fixed to the flow channel forming body 12 by bolts.

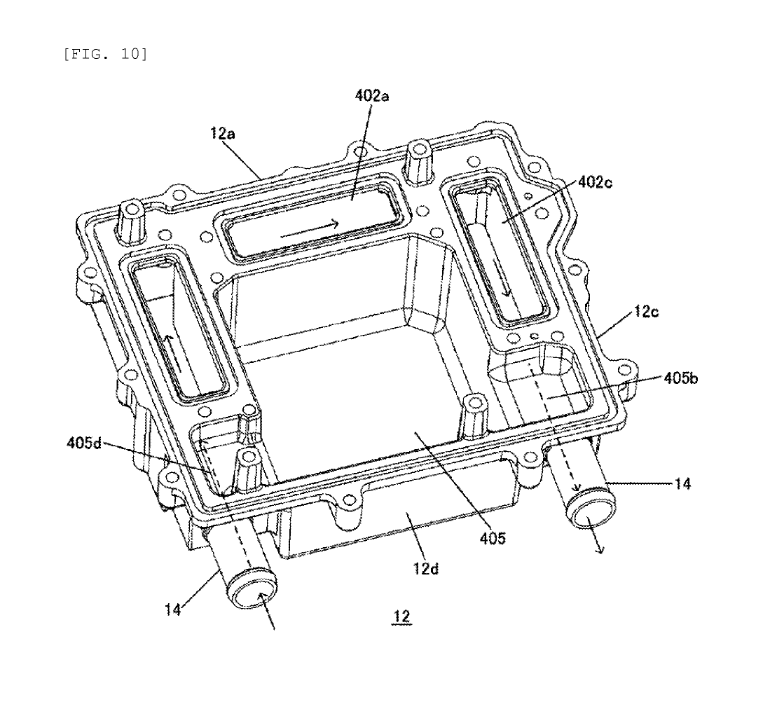

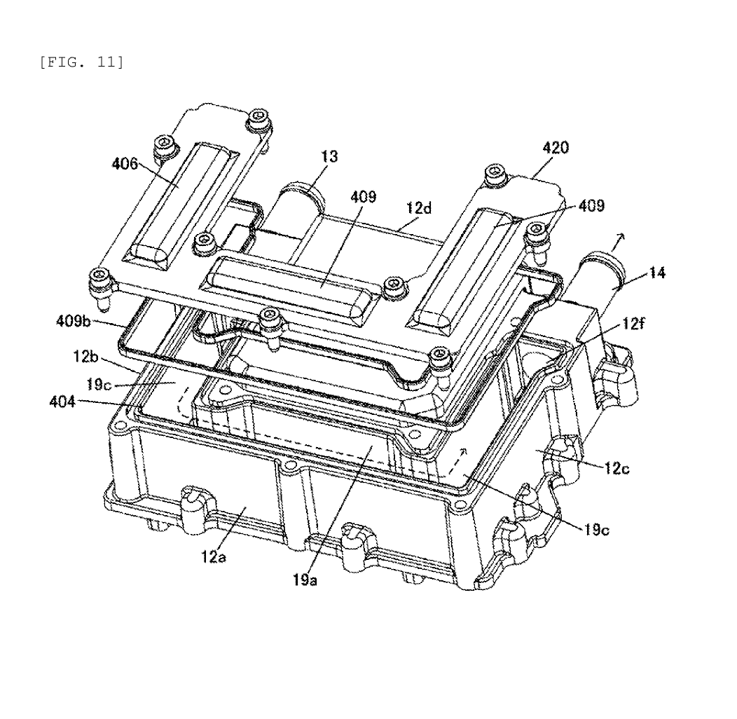

First, the flow channel forming body 12 will be described with reference to FIGS. 10 and 11. FIG. 10 is a perspective view of the flow channel forming body 12, and FIG. 11 is an exploded perspective view of the flow channel forming body 12 viewed from a rear surface side. As illustrated in FIG. 10, the flow channel forming body 12 is shaped into a cuboid substantially square in a planar configuration, and the inlet piping 13 and the outlet piping 14 are disposed in the side surface 12d. Portions of the side surface 12d in which the pipings 13 and 14 are disposed are formed with steps. As illustrated in FIG. 11, the flow channel 19 is formed in a U-shaped configuration along the remaining three side surfaces 12a to 12c. An opening portion 404 formed into a U-shaped configuration connected into one piece, which has substantially the same configuration as the cross-sectional configuration of the flow channel 19, is formed on a rear surface side of the flow channel forming body 12. The opening portion 404 is covered with the U-shaped lower cover 420. A sealing member 409a is disposed between the lower cover 420 and the flow channel forming body 12 to keep airtightness.

The U-shaped flow channel 19 is divided into three flow channel zones 19a, 19b, and 19c according to a direction along which the refrigerant flows. Although described later in detail, the first flow channel zone 19a is disposed along a side surface 12a at a position facing the side surface 12d in which the inlet pipings 13 and 14 are disposed, the second flow channel zone 19b is disposed along a side surface 12b adjacent to one side of the side surface 12a, and the third flow channel zone 19c is disposed along a side surface 12c adjacent to the other side of the side surface 12a. The refrigerant flows into the flow channel zone 19b from the inlet piping 13. The refrigerant flows into the flow channel zone 19b, the flow channel zone 19a, and the flow channel zone 19c in the stated order as indicated by a dashed arrow, and flows from the outlet piping 14.

As illustrated in FIG. 10, on an upper surface side of the flow channel forming body 12, the rectangular opening portion 402a which is parallel to the side surface 12a is formed at a position facing the flow channel zone 19a, the rectangular opening portion 402b which is parallel to the side surface 12b is formed at a position facing the flow channel zone 19b, and the rectangular opening portion 402c which is parallel to the side surface 12c is formed at a position facing the flow channel zone 19c. The power modules 300U to 300W are inserted into the flow channel 19 through the opening portions 402a to 402c, respectively.

As illustrated in FIG. 11, respective convex portions 406 projected downward from the flow channel 19 are formed on the lower cover 420 at positions facing the above-mentioned opening portions 402a to 402c. Those convex portions 406 are recessed when viewed from the flow channel 19 side, and lower end portions of the power modules 300U to 300W inserted from the opening portions 402a to 402c are inserted into those recesses. Since the flow channel forming body 12 is formed so that the opening portion 404 faces the opening portions 402a to 402c, the flow channel forming body 12 is easily manufactured by aluminum casting.

As illustrated in FIG. 10, the rectangular storage space 405, which is formed so that three sides of the flow channel forming body 12 are surrounded by the flow channel 19, is disposed in the flow channel forming body 12. The capacitor module 500 is stored in the storage space 405. Because the storage space 405 surrounded by the flow channel 19 is shaped into a cuboid, the capacitor module 500 can be shaped into a cuboid, and the productivity of the capacitor module 500 is enhanced.

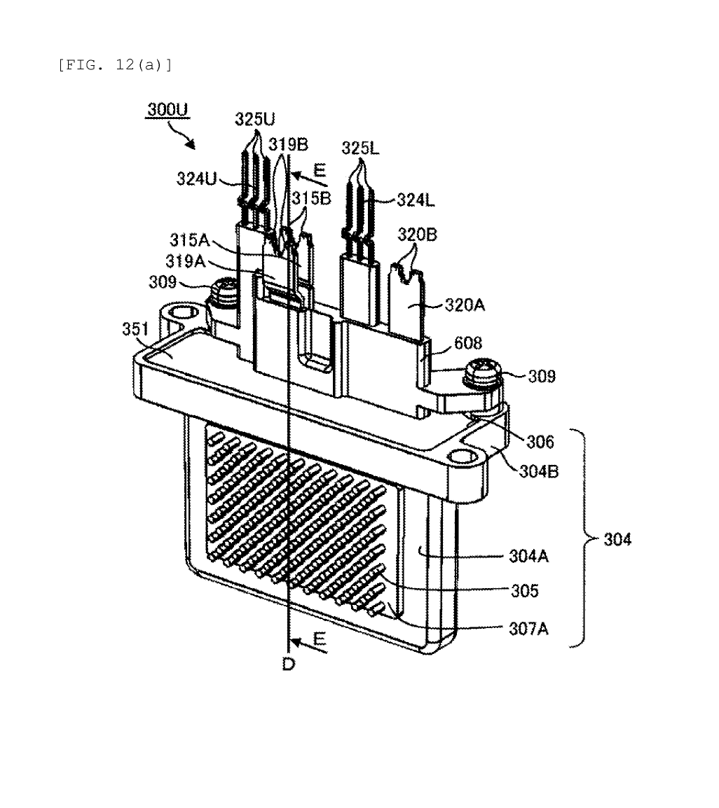

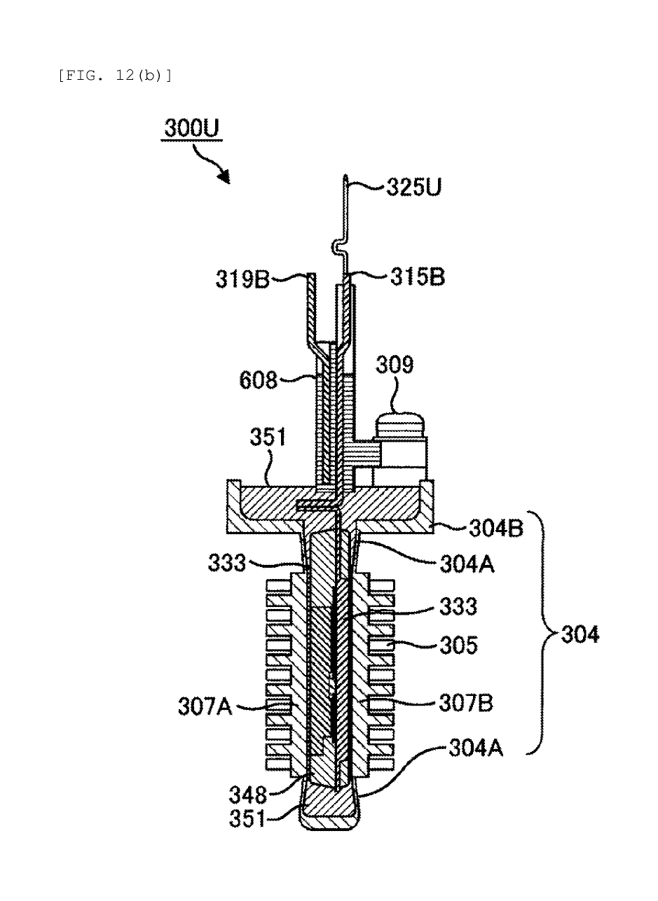

The detailed configurations of the power modules 300U to 300W and power modules 301a to 301c used in the inverter circuit 140 will be described with reference to FIGS. 12A, 12B, 13A, 13B, 13C, 14A, 14B, 15, and 16. The power modules 300U to 300W, and the power modules 301a to 301c have the same structure, and the structure of the power module 300U will be described representatively. In the above respective figures, a signal terminal 325U corresponds to the gate electrode 154 and the emitter electrode 155 illustrated in FIG. 2, and a signal terminal 325L corresponds to the gate electrode 164 and the emitter electrode 165 illustrated in FIG. 2. Also, a DC positive electrode terminal 315B is identical with the positive electrode terminal 157 illustrated in FIG. 2, and a DC negative electrode terminal 319B is identical with the negative electrode terminal 158 illustrated in FIG. 2. Also, an AC terminal 320B is identical with the AC terminal 159 illustrated in FIG. 2.

FIG. 12A is a perspective view of the power module 300U according to this embodiment. FIG. 12B is a cross-sectional view of the power module 300U taken along a cross-section D and viewed from a direction E according to this embodiment.

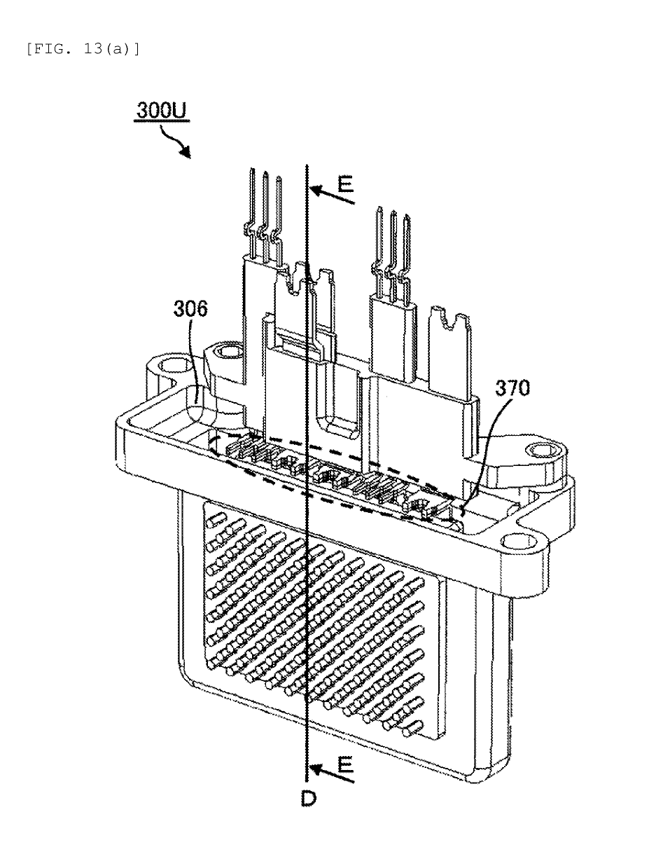

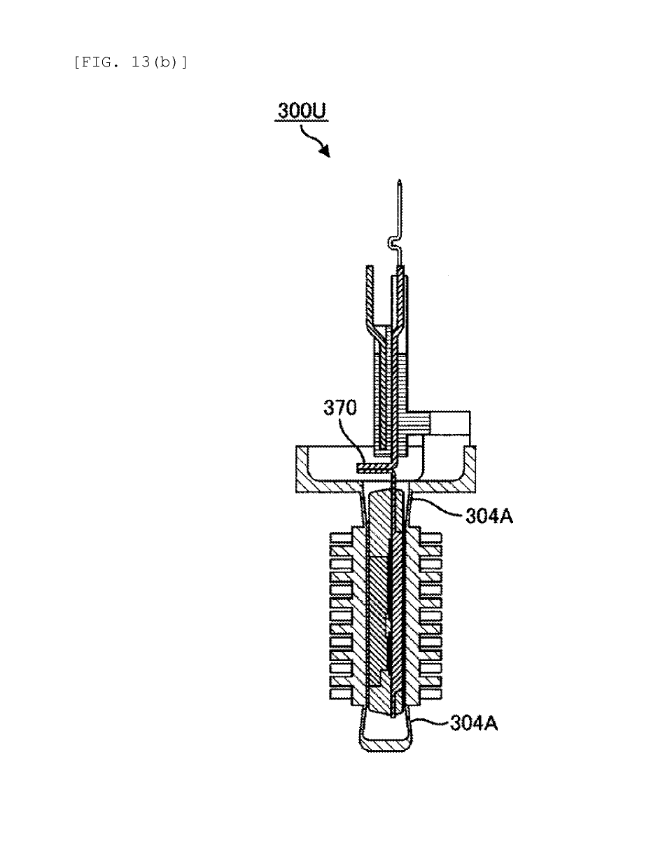

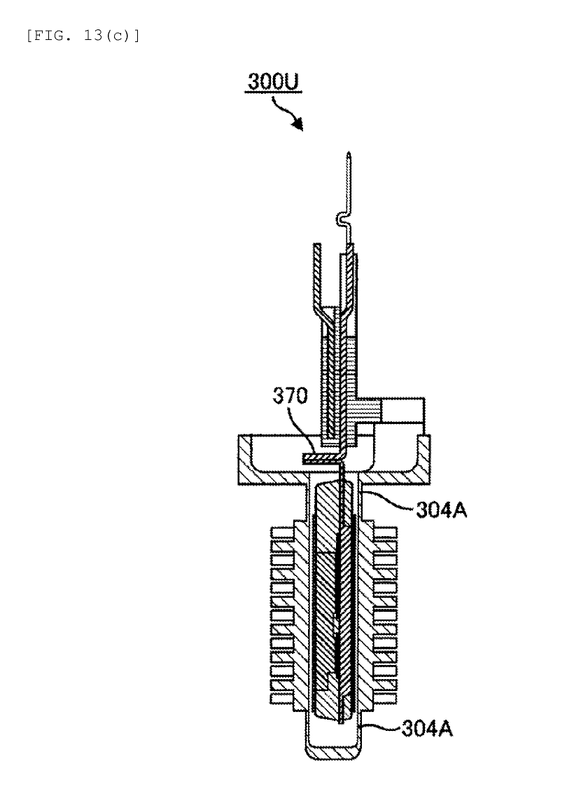

FIGS. 13A, 13B, and 13C are diagrams a state in which screws 309 and a second sealing resin 351 are removed from the power module 300U illustrated in FIGS. 12A and 12B, for facilitating understanding. FIG. 13A is a perspective view thereof, and FIG. 13B is a cross-sectional view of the power module 300U in a state illustrated in FIG. 13A, which is taken along the cross-section D and viewed from the direction E, as in FIG. 12B. Also, FIG. 13C is a cross-sectional view of the power module 300U before a fin 305 is pressurized to deform a curved portion 304A.

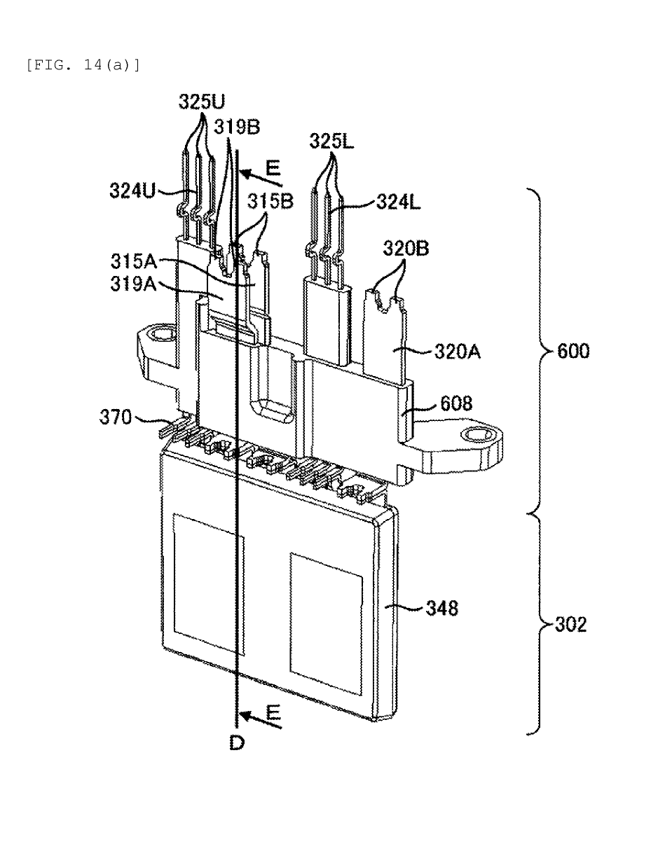

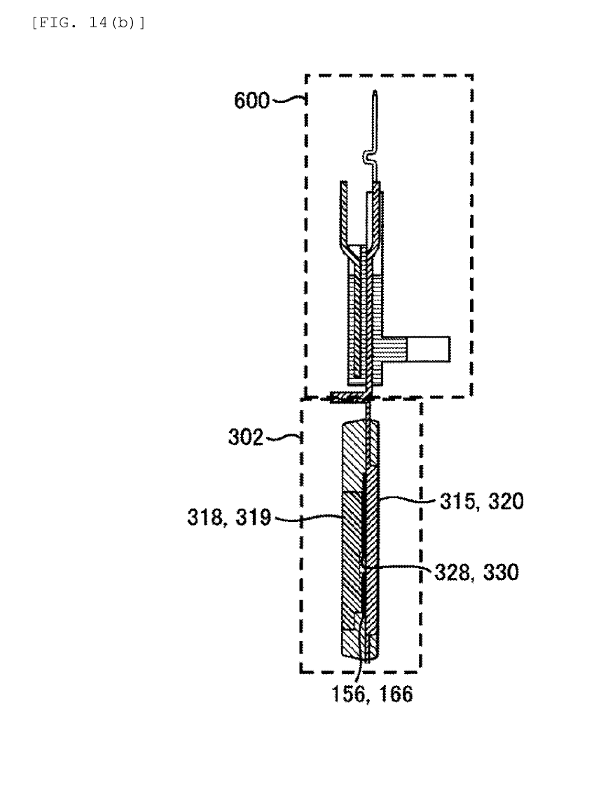

FIGS. 14A and 14B are diagrams illustrating a state in which the module case 304 is further removed from the power module 300U illustrated in FIGS. 13A and 13B. FIG. 14A is a perspective view thereof, and FIG. 14B is a cross-sectional view of the power module 300U in a state illustrated in FIG. 14A, which is taken along the cross-section D and viewed from the direction E, as in FIG. 12B and FIG. 13B.

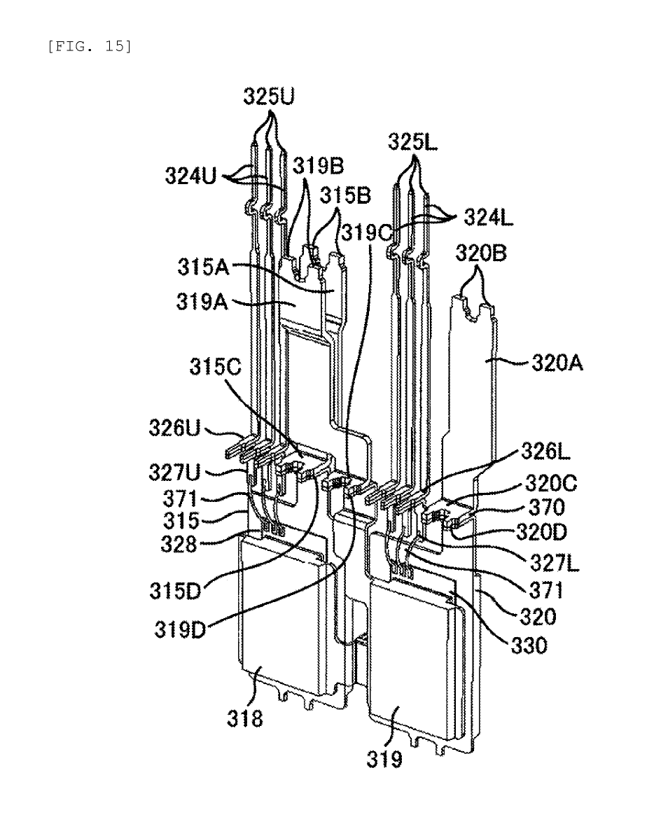

FIG. 15 is a perspective view illustrating the power module 300U in which a first sealing resin 348 and a wiring insulating portion 608 are further removed from a state illustrated in FIGS. 14A and 14B.

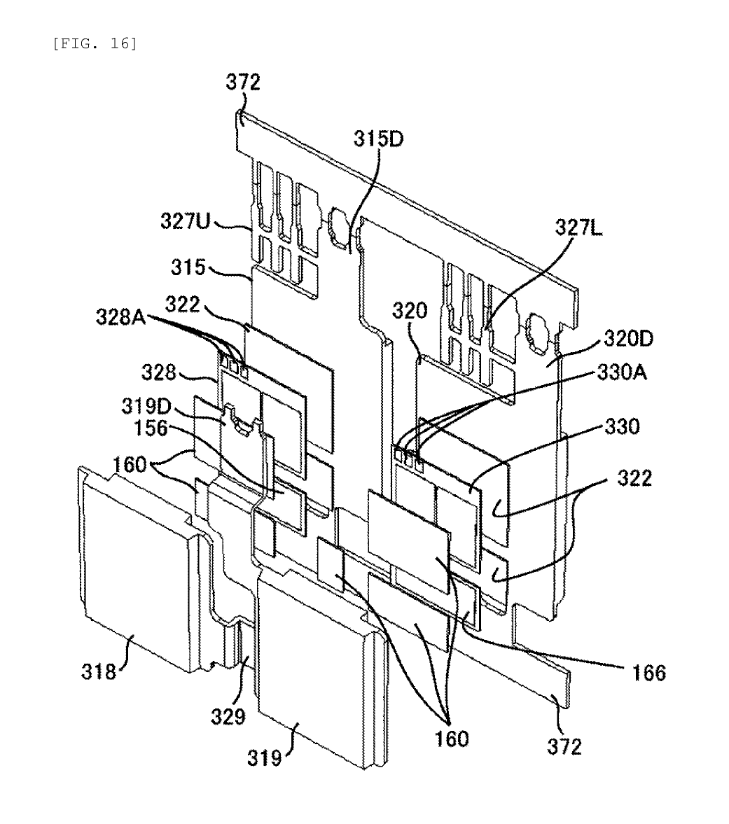

FIG. 16 is a diagram illustrating a process of assembling a primary module sealing body 302.

The power semiconductor device (IGBT 328, IGBT 330, diode 156, diode 166) configuring the series circuit 150 of the upper and lower arms is fixed from both surfaces thereof by conductor plates 315 and 318, or by conductor plates 320 and 319, as illustrated in FIGS. 14B and 15. The conductor plate 315 is sealed by the first sealing resin 348 in a state where a radiation surface thereof is exposed, and an insulating sheet 333 is bonded to the radiation surface by thermocompression. The first sealing resin 348 has a polyhedral configuration (in this example, a substantially rectangular configuration) as illustrated in FIG. 14A.

The primary module sealing body 302 sealed by the first sealing resin 348 is inserted into the module case 304, and thermocompression-bonded to an inner surface of the module case 304 which is a CAN cooler through the insulating sheet 333. In this example, the CAN cooler is a cooler having a cylindrical configuration having an insertion port 306 in one surface, and a bottom on the other surface. Voids remaining in the interior of the module case 304 are filled with the second sealing resin 351.

The module case 304 is made of a member having an electric conductivity, for example, an aluminum alloy material (Al, AlSi, AlSiC, Al—C, etc.), and integrally molded in a seamless state. The module case 304 has a structure in which no opening is provided except for the insertion port 306, and the insertion port 306 has an outer periphery surrounded by a flange portion 304B. Also, as illustrated in FIG. 12A, a first radiation surface 307A and a second radiation surface 307B each having a surface larger than the other surfaces are arranged to face each other, and the respective power semiconductor devices (IGBT 328, IGBT 330, diode 156, diode 166) are arranged to face those radiation surfaces. Three surfaces connecting the first radiation surface 307A and the second radiation surface 307B which face each other configure a surface sealed with a width narrower than that of the first radiation surface 307A and the second radiation surface 307B, and the insertion port 306 is formed in a surface of the remaining side. A shape of the module case 304 does not need to be an accurate cuboid, and corners of the module case 304 may be curved as illustrated in FIG. 12A.

With the use of the metal case thus configured, even if even the module case 304 is inserted into the flow channel 19 in which the refrigerant such as water or oil flows, because refrigerant sealing can be ensured by the flange portion 304B, a cooling medium can be prevented from entering the interior of the module case 304 with a simple configuration. Also, the fin 305 is evenly formed on each of the first radiation surface 307A and the second radiation surface 307B which face each other. Further, the curved portion 304A having a thickness extremely thinned is formed on an outer periphery of the first radiation surface 307A and the second radiation surface 307B. Because the curved portion 304A is extremely thinned to a degree easily deformed by pressurizing the fin 305, the productivity after the primary module sealing body 302 has been inserted into the device is improved.

As described above, the conductor plate 315 is thermocompression-bonded to an inner wall of the module case 304 through the insulating sheet 333, as a result of which the voids between the conductor plate 315 and the inner wall of the module case 304 can be reduced, and the heat generated in the power semiconductor device can be efficiently transmitted to the fin 305. Further, the insulating sheet 333 has a certain level of thickness and flexibility with the results that the generation of thermal stress can be absorbed by the insulating sheet 333, and is excellently used in the power conversion device for vehicle which is severe in a change in temperature.

A DC positive electrode wiring 315A and a DC negative electrode wiring 319A which are made of metal for electric connection to the capacitor module 500 are disposed outside of the module case 304. DC positive electrode terminals 315B (157) and DC negative electrode terminals 319B (158) are formed at respective leading ends thereof. Also, an AC wiring 320A made of metal for supplying an AC power to the motor generator MG1 is provided, and the AC terminals 320B (159) are formed on a leading end thereof. In this embodiment, as illustrated in FIG. 15, the DC positive electrode wiring 315A is connected to the conductor plate 315, the DC negative electrode wiring 319A is connected to the conductor plate 319, and the AC wiring 320A is connected to the conductor plate 320.

Signal wirings 324U and 324L made of metal for electric connection to the driver circuit 174 are further disposed outside of the module case 304. The signal terminals 325U (154, 155) and the signal terminals 325L (164: gate electrode, 165: emitter electrode) are formed on leading ends thereof. In this embodiment, as illustrated in FIG. 15, the signal wirings 324U are connected to the IGBT 328, and the Signal wirings 324L are connected to the IGBT 328.

The DC positive electrode wiring 315A, the DC negative electrode wiring 319A, the AC wiring 320A, the signal wirings 324U, and the signal wirings 324L are integrally molded as an auxiliary mold body 600 in a state where the respective components are mutually isolated from each other by the wiring insulating portion 608 molded with a resin material. The wiring insulating portion 608 also acts as a support member for supporting the respective wirings, and the resin material used for the wiring insulating portion 608 is suitably made of a thermosetting resin or a thermoplastic resin having an insulating property. As a result, the insulating property among the DC positive electrode wiring 315A, the DC negative electrode wiring 319A, the AC wiring 320A, the signal wirings 324U, and the signal wirings 324L can be ensured to enable high density wiring. The auxiliary mold body 600 is metal-bonded to the primary module sealing body 302 in a connection portion 370, and thereafter fixed to the module case 304 with the screws 309 that penetrate through threaded holes provided in the wiring insulating portion 608. The metal bond between the primary module sealing body 302 and the auxiliary mold body 600 in the connection portion 370 can be conducted by, for example, TIG welding.

The DC positive electrode wiring 315A and the DC negative electrode wiring 319A are stacked on each other in a state where the DC positive electrode wiring 315A and the DC negative electrode wiring 319A face each other through the wiring insulating portion 608, and shaped to extend substantially in parallel. With the above arrangement and shape, currents that instantaneously flow therein during the operation of switching the power semiconductor device are countercurrent, and flow in opposite directions. As a result, magnetic fields developed by the currents operate to cancel each other, and this operation enables low impedance. The AC wiring 320A and the signal terminals 325U, 325L also extend toward the same direction as that of the DC positive electrode wiring 315A and the DC negative electrode wiring 319A.

The connection portion 370 in which the primary module sealing body 302 and the auxiliary mold body 600 are connected to each other by the metal bond is sealed within the module case 304 with the second sealing resin 351. As a result, because a necessary insulation distance can be stably ensured between the connection portion 370 and the module case 304, the downsized power module 300U can be realized as compared with a case in which the connection portion 370 is not sealed.

As illustrated in FIG. 15, an auxiliary module side DC positive electrode connection terminal 315C, an auxiliary module side DC negative electrode connection terminal 319C, an auxiliary module side AC connection terminal 320C, an auxiliary module side signal connection terminal 326U, and an auxiliary module side signal connection terminal 326L are aligned on the auxiliary mold body 600 side of the connection portion 370. On the other hand, on the primary module sealing body 302 side of the connection portion 370, a device side DC positive electrode connection terminal 315D, a device side DC negative electrode connection terminal 319D, a device side AC connection terminal 320D, a device side signal connection terminal 327U, and a device side signal connection terminal 327L are aligned along one surface of the first sealing resin 348 having a polyhedral shape. In this way, with a structure in which the respective terminals are aligned in the connection portion 370, the primary module sealing body 302 is easily manufactured by a transfer mold.

In this example, a positional relationship of the respective terminals when portions extended outward from the first sealing resin 348 of the primary module sealing body 302 are viewed as one terminal for each kind of the portions will be described. In the following description, the terminal configured by the DC positive electrode wiring 315A (including the DC positive electrode terminals 315B and the auxiliary module side DC positive electrode connection terminal 315C) and the device side DC positive electrode connection terminal 315D are called “positive electrode side terminal”. The terminal configured by the DC negative electrode wiring 319A (including the DC negative electrode terminals 319B and the auxiliary module side DC negative electrode connection terminal 319C) and the device side DC positive electrode connection terminal 315D are called “negative electrode side terminal”. The terminal configured by the AC wiring 320A (including the AC terminal 320B and the auxiliary module side AC connection terminal 320C) and the device side AC connection terminal 320D is called “output terminal”. The terminal configured by the signal wirings 324U (including the signal terminal 325U and the auxiliary module side signal connection terminal 326U) and the device side signal connection terminal 327U is called “upper arm signal terminal”. The terminal configured by the signal wirings 324L (including the signal terminal 325L and the auxiliary module side signal connection terminal 326L) and the device side signal connection terminal 327L is called “lower arm signal terminal”.

The above respective terminals are projected from the first sealing resin 348 and the second sealing resin 351 through the connection portion 370. The respective projected portions (the device side DC positive electrode connection terminal 315D, the device side DC negative electrode connection terminal 319D, the device side AC connection terminal 320D, the device side signal connection terminal 327U, and the device side signal connection terminal 327L) from the first sealing resin 348 are aligned along one surface of the first sealing resin 348 having the polyhedral shape as described above. Also, the positive side terminal and the negative side terminal are projected from the second sealing resin 351 in a stacked state, and extended to the external of the module case 304. With the above configuration, an excessive stress exerted on connection portions between the power semiconductor device and the above terminals, or a gap between molds can be prevented from occurring in clamping the molds when the power semiconductor device is sealed with the first sealing resin 348 to manufacture the primary module sealing body 302. Also, because the magnetic fluxes canceling each other are generated by the opposing currents flowing in the respective positive electrode side terminal and negative electrode side terminal, the inductance can be reduced.

On the auxiliary mold body 600 side, the auxiliary module side DC positive electrode connection terminal 315C and the auxiliary module side DC negative electrode connection terminal 319C are formed on leading ends of the DC positive electrode wiring 315A and the DC negative electrode wiring 319A on the opposite side of the DC positive electrode terminals 315B and the DC negative electrode terminals 319B, respectively. Also, the auxiliary module side AC connection terminal 320C is formed on a leading end of the AC wiring 320A on the opposite side of the AC terminal 320B. The auxiliary module side signal connection terminals 326U and 326L are formed on leading ends of the signal wirings 324U and 324L on the opposite side of the signal terminals 325U and 325L, respectively.

On the other hand, on the primary module sealing body 302 side, the device side DC positive electrode connection terminal 315D, the device side DC negative electrode connection terminal 319D, and the device side AC connection terminal 320D are formed on the conductor plates 315, 319, and 320, respectively. Also, the device side signal connection terminals 327U and 327L are connected to the IGBTs 328 and 330 by bonding wires 371, respectively.

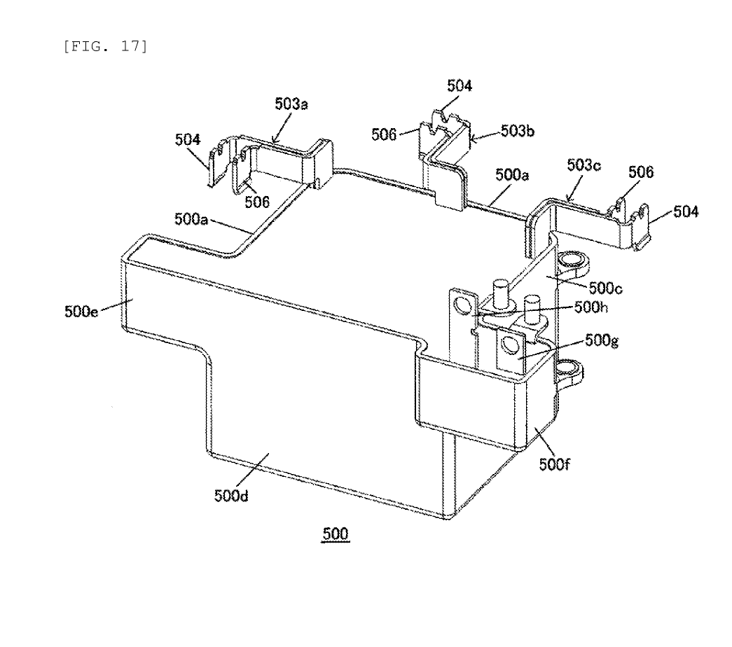

FIG. 17 is an external perspective view of the capacitor module 500. A plurality of capacitor cells is disposed within the capacitor module 500. On an upper surface of the capacitor module 500, capacitor terminals 503a to 503c are provided to be projected in proximity to a surface that faces the flow channel 19 of the capacitor module 500. The capacitor terminals 503a to 503c are formed to correspond to the positive electrode terminals 157 and the negative electrode terminals 158 of the respective power modules 300. The capacitor terminals 503a to 503c have the same shape, and an insulating sheet is disposed between the negative electrode side capacitor terminal 504 and the positive electrode side capacitor terminal 506 configuring the capacitor terminals 503a to 503c to ensure insulation between the terminals.

Projecting portions 500e and 500f are formed on an upper portion of a side surface 500d of the capacitor module 500. A discharge resistor is mounted within the projecting portion 500e, and a Y-capacitor for measure against common mode noise is mounted within the projecting portion 500f. Also, the power terminals 508 and 509 illustrated in FIG. 5 are attached to terminals 500g and 500h projected from an upper surface of the projecting portion 500f. As illustrated in FIG. 10, concave portions 405a and 405b are formed between openings 402b, 402c and the side surface 12d, and when the capacitor module 500 is stored in the storage space 405 of the flow channel forming body 12, the projecting portion 500e is stored in the concave portion 405a, and the projecting portion 500f is stored in the concave portion 405b.

The discharge resistor mounted within the projecting portion 500e is a resistor for discharging electric discharge stored in the capacitor cells within the capacitor module 500 when the inverter stops. Since the concave portion 405a in which the projecting portion 500e is stored is disposed immediately above the flow channel of the refrigerant that inflows from the inlet piping 13, a rising in the temperature of the discharge resistor during discharge can be suppressed.

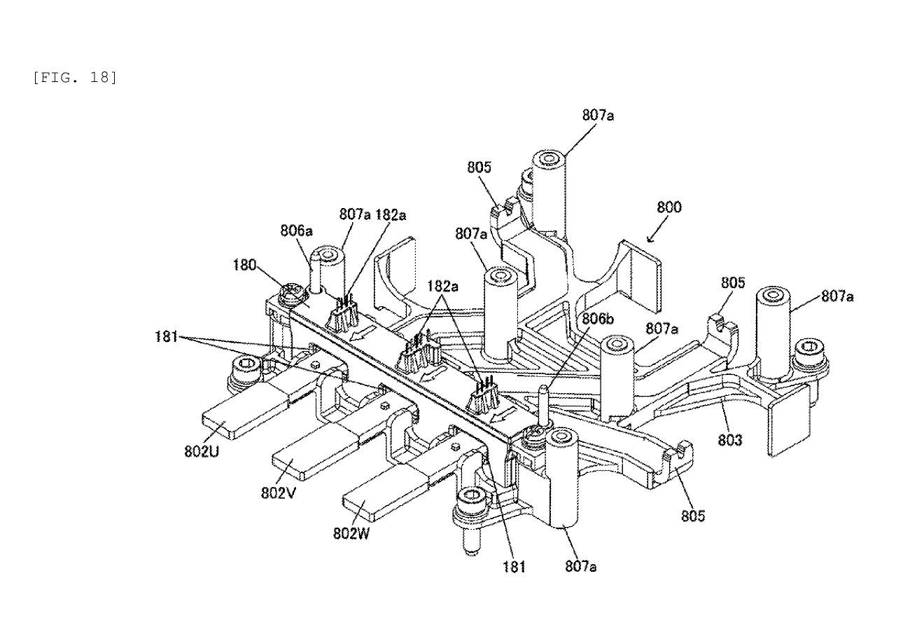

FIG. 18 is a perspective view illustrating the busbar assembly 800. The busbar assembly 800 includes the AC busbars 802U, 802V, and 802W of the U, V, and W phases, a holding member 803 for holding and fixing the AC busbars 802U to 802W, and the current sensor 180 for detecting the AC current which flows the AC busbars 802U to 802W. The AC busbars 802U to 802W are each formed of a wide conductor. A plurality of the support members 807a for holding the driver circuit board 22 is formed on the holding member 803 made of an insulating material such as resin so as to be projected upward from the holding member 803.

The current sensor 180 is arranged on the busbar assembly 800 so as to be parallel with the side surface 12d at a position close to the side surface 12d of the flow channel forming body 12 when the busbar assembly 800 is fixed onto the flow channel forming body 12 as illustrated in FIG. 8. Through-holes 181 through which the AC busbars 802U to 802W penetrate are formed on the side surface of the current sensor 180. Sensor elements are disposed in portions where the through-holes 181 of the current sensor 180 are formed, and signal lines 182a of the respective sensor elements are projected from an upper surface of the current sensor 180. The respective sensor elements are aligned in an extension direction of the current sensor 180, that is, in an extension direction of the side surface 12d of the flow channel forming body 12. The AC busbars 802U to 802W penetrate through the respective through-holes 181, and the leading ends of the AC busbars 802U to 802W are projected.

As illustrated in FIG. 18, projection portions 806a and 806b for positioning are formed on the holding member 803 so as to be projected upward. The current sensor 180 is fixed to the holding member 803 by screwing. In this fixation, the projection portions 806a and 806b are engaged with positioning holes formed in a frame of the current sensor 180, to thereby position the current sensor 180. Further, in fixing the driver circuit board 22 to the support member 807a, when the projection portions 806a and 806b for positioning are engaged with positioning holes formed in the driver circuit board 22 side whereby the signal lines 182a of the current sensor 180 are positioned to the through-holes of the driver circuit board 22. The signal lines 182a are joined to a wiring pattern of the driver circuit board 22 by soldering.

In this embodiment, the holding member 803, the support member 807a, and the projection portions 806a, 806b are integrally formed with a resin. In this way, since the holding member 803 includes a function of positioning the current sensor 180 and the driver circuit board 22, the assembling and solder connecting work between the signal lines 182a and the driver circuit board 22 become easy. Also, with the provision of a mechanism for holding the current sensor 180 and the driver circuit board 22 in the holding member 803, the number of parts in the overall power conversion device can be reduced.

The AC busbars 802U to 802W are fixed to the holding member 803 so that the wide surfaces become horizontal, and a connection portion 805 connected to the AC terminal 159 of the power modules 300U to 300W erects vertically. A leading end of the connection portion 805 has a concave-convex shape, and a heat is concentrated on the concave-convex portion during welding.

Since the current sensor 180 is arranged in parallel to the side surface 12d of the flow channel forming body 12 as described above, the respective AC busbars 802U to 802W projected from the through-holes 181 of the current sensor 180 are arranged on the side surface 12d of the flow channel forming body 12. Since the respective power modules 300U to 300W are arranged in the flow channel zones 19a, 19b, and 19c formed along the side surfaces 12a, 12b, and 12c of the flow channel forming body 12, the connection portion 805 of the AC busbars 802U to 802W is arranged at positions corresponding to the side surfaces 12a to 12c of the busbar assembly 800. As a result, as illustrated in FIG. 8, the U phase AC busbar 802U is extended from the power module 300U arranged in proximity to the side surface 12b to the side surface 12d. The V phase AC busbar 802V is extended from the power module 300V arranged in proximity to the side surface 12a to the side surface 12d. The W phase AC busbar 802W is extended from the power module 300W arranged in proximity to the side surface 12c to the side surface 12d.

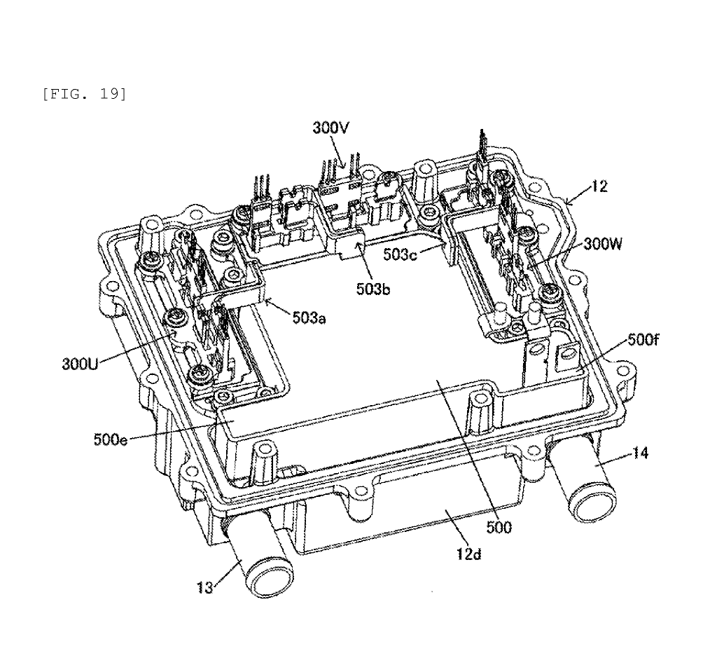

FIG. 19 is a diagram illustrating the flow channel forming body 12 in which the power modules 300U to 300W are fixed to the opening portions 402a to 402c, and the capacitor module 500 is stored in the storage space 405. In an example illustrated in FIG. 19, the power module 300U of the U phase is fixed to the opening 402b, the power module 300V of the V phase is fixed to the opening 402a, and the power module 300W of the W phase is fixed to the opening 402c. Thereafter, the capacitor module 500 is stored in the storage space 405, and the terminals on the capacitor side are connected to the terminals of the respective power modules by welding. The respective terminals are projected from an upper end surface of the flow channel forming body 12, and a welding machine approaches from above, and welding operation is conducted.

The DC positive electrode terminals 315B and the DC negative electrode terminals 319B of the respective power modules 300U to 300W arranged in a U-shaped configuration are connected to the capacitor terminals 503a to 503c projected from the upper surface of the capacitor module 500 illustrated in FIG. 17. Because the three power modules 300U to 300W are disposed to surround the capacitor module 500, positional relationships of the respective power modules 300U to 300W to the capacitor module 500 become equal to each other, and the power modules 300U to 300W can be connected to the capacitor module 500 with the use of the capacitor terminals 503a to 503c having the same configuration in a balanced manner. For that reason, circuit constants of the capacitor module 500 and the power modules 300U to 300W are easily balanced in each of the three phases, resulting in a structure in which current easily inflows and outflows.

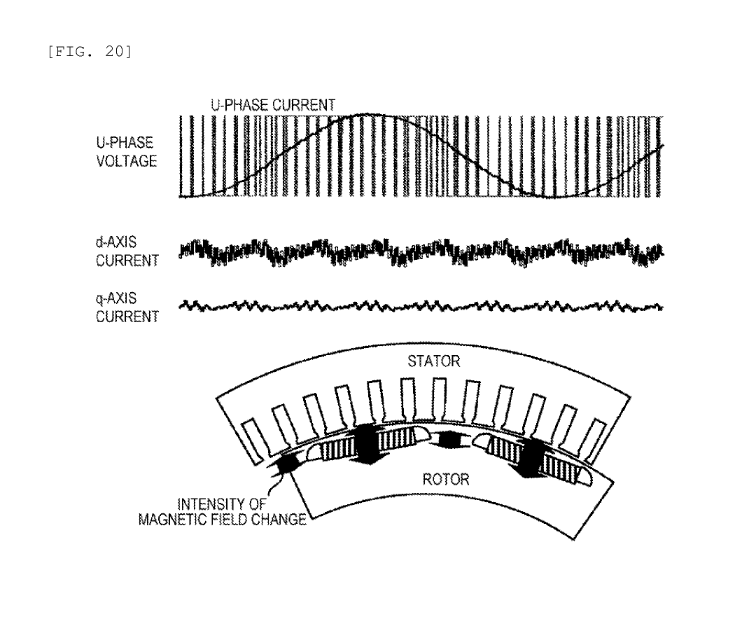

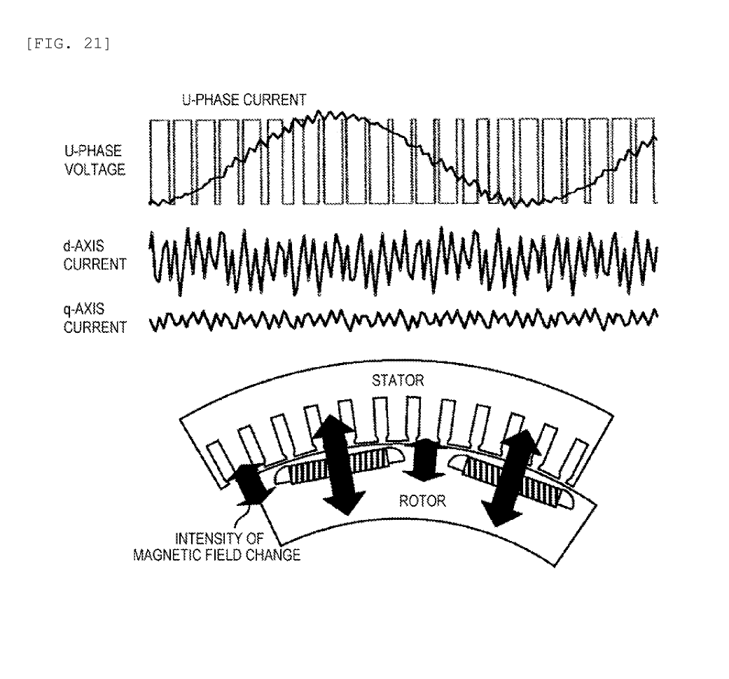

Subsequently, in order to describe a modulation system according to the present invention, a conventional PWM control will be first described with reference to FIGS. 20 and 21. FIGS. 20 and 21 are conceptual diagrams of fluctuations of a U phase voltage, a U phase current, a d-axial current, a q-axial current, and a magnetic flux when applying a PWM control. The PWM control is a system that determines conduction or cut-off timing of the switching elements on the basis of a size comparison between a carrier wave having a given frequency and an AC waveform to be output, to control the switching elements. When the PWM control is used, if a carrier frequency is set to be higher as illustrated in FIG. 20, the number of switching operation per unit time is increased, and a loss of the inverter, in particular, the switching loss is increased. However, the AC power small in pulsation can be supplied to the motor, and the control small in the motor loss is enabled. On the other hand, if the carrier frequency is set to be lower as illustrated in FIG. 21, the number of switching operation per unit time is decreased, and the switching loss of the inverter is reduced. However, the AC power large in pulsation is supplied to the motor, and control large in the motor loss is conducted. That is, in the PWM control, the inverter loss and the motor loss have a relationship of trade-off. When the loss when the permanent magnet synchronous machine using a neodymium magnet is driven by the inverter is investigated, a result that an eddy current loss of the magnet becomes noticeable may be obtained. The eddy current loss of the magnet is caused by a slot harmonic caused by a slot shape of the motor, and a current harmonic included in a current flowing in the winding wire of a motor stator. In the PWM control, the eddy current loss of the magnet is changed according to a difference in the switching frequency. This is caused by a difference in the behavior of the ripple of the current harmonic. A mechanism of the eddy current loss of the magnet will be described below, paying attention to the current harmonic. A magnetomotive force harmonic caused by the current harmonic becomes a harmonic of a magnetic flux by a magnetic circuit of the motor, and fluctuates the magnetic flux of the rotor. The rotor of the permanent magnet synchronous machine is generally formed of a silicon steel plate and a neodymium magnet, and the respective members have a conductive property. For that reason, an eddy current is generated orthogonally to a fluctuation direction of the harmonic of the magnetic flux that penetrates through the interior of those members. In this situation, because the neodymium magnet is higher in electric conductivity than the silicon steel plate, the eddy current more easily flows in the neodymium magnet for the harmonic of the magnetic flux, and the eddy current loss occurring in the neodymium magnet becomes noticeable. In the conventional PWM control, the harmonic quantities of the magnetic flux poured into the respective neodymium magnet and silicon steel plate cannot be controlled, distinctively. Therefore, in order to reduce the eddy current loss, the conventional PWM control is limited to a method in which the number of switching operation in the inverter per unit time is increased to reduce the overall magnetic flux harmonic. On the other hand, in the modulation system according to the present invention, the fluctuation of the magnetic flux that penetrates through the neodymium magnet can be selectively reduced, and the eddy current loss of the rotor can be reduced, without any increase in the number of switching operation in the inverter per unit time.

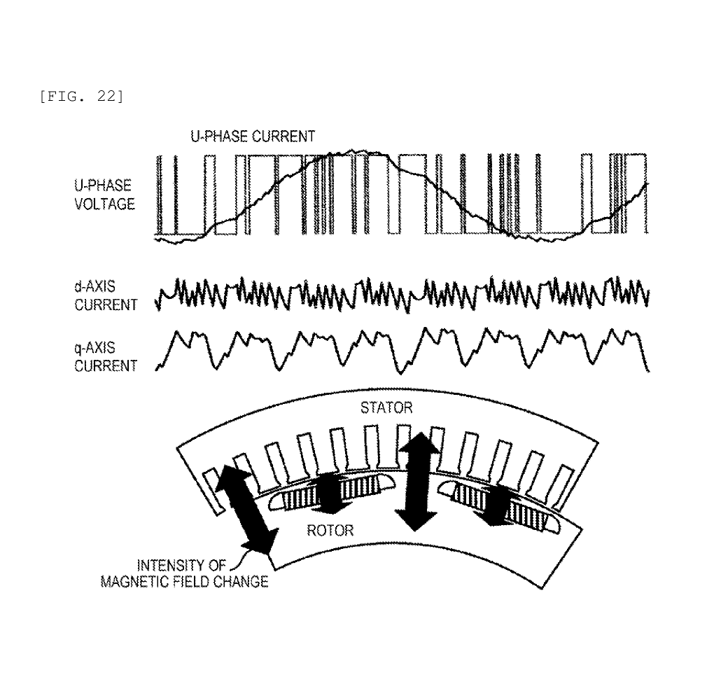

FIG. 22 is a conceptual diagram illustrating the U phase voltage, the U phase current, the d-axial current, the q-axial current, and the magnetic flux when applying the modulation system according to the present invention. In the modulation system according to the present invention, the ripples of the d-axial magnetic flux and the q-axial magnetic flux are controlled, respectively, so that a variation of the magnetic flux on the rotor can be arbitrarily controlled, by a method described later. The fluctuation of the magnetic flux that penetrates through the neodymium magnet is reduced more than the fluctuation of the magnetic flux that penetrates through the silicon steel plate under this control. As a result, the generation of the eddy current in the neodymium magnet can be suppressed, and the motor loss can be reduced. At the same time, the number of switching operation in the inverter is thinned to also reduce the inverter loss.

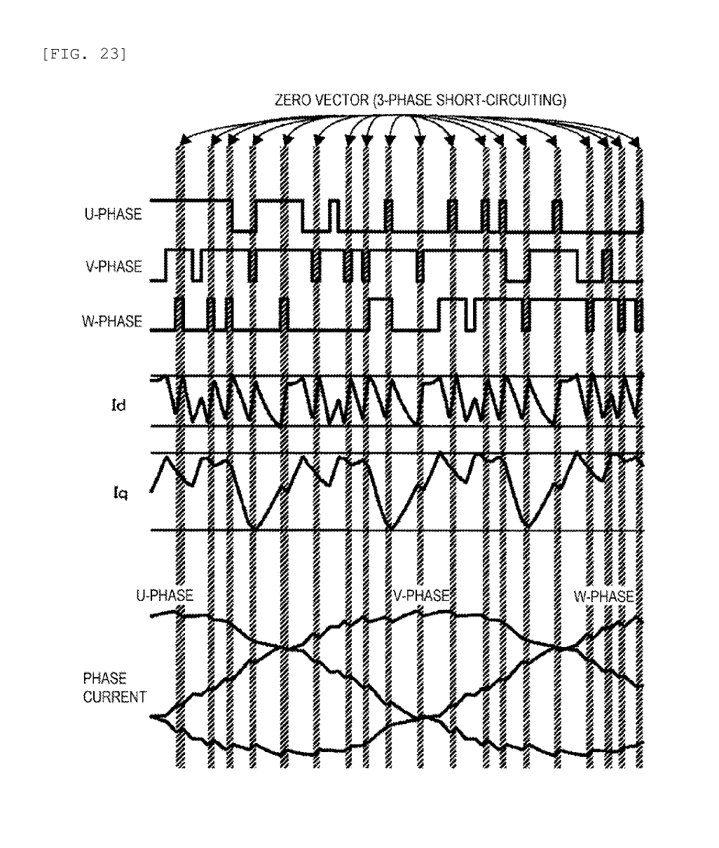

FIG. 23 illustrates the respective voltage pulses of the three phases of U, V, and W, the d-axial current Id, the q-axial current Iq, and the respective currents of the three phases of U, V, and W when applying the modulation system according to the present invention. As is apparent from an appearance of the d-axial current Id and the q-axial current Iq, it is understood that in the modulation system according to the present invention, the current ripple falls within a prescribed range under the control. As a result, the currents of the respective U, V, and W phases also become substantially sinusoidal. On the other hand, in the voltage pulse of each phase, the switching operation is not conducted in a given cycle as in the PWM control, and a switching interval has no precise regularity. That is, since this system determines the switching timing on the basis of the current ripple, the loss of the motor is carefully managed, and minute switching operation is not conducted unnecessarily. For that reason, there is the effect of a reduction in the number of switching operation.

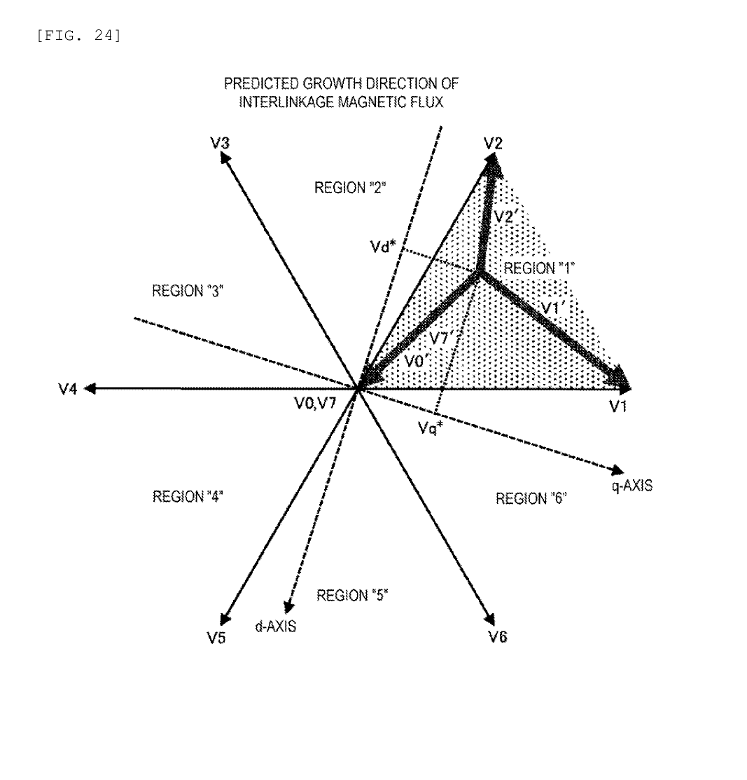

FIG. 24 is an exemplary conceptual diagram illustrating a method of determining a desired output voltage vector in response to a given voltage instruction in the modulation system according to the present invention. In the drawing, an instruction voltage vector, an output voltage vector, and a relative voltage vector between the output voltage vector and the instruction voltage vector are illustrated. When the d-axial and q-axial directions, and the instruction voltage vector V*=(Vd*, Vq*) have a positional relationship illustrated in the figure, the instruction voltage vector V* belongs to a region “1”.

In general, the inverter (2-level inverter) can output only voltages of eight kinds including voltage vectors V1 to V6, and zero voltage vectors V0, V7, and cannot directly express the instruction voltage vector V* instantaneously. Therefore, any one of the eight kinds of voltage vectors outputtable from the inverter is sequentially selected, and a control is made so that a mean value for a given time matches the instruction voltage vector V. In the example of FIG. 24, since the instruction voltage vector V* belongs to a region “1”, the voltage vectors V1, V2, V0, and V7 in proximity to the instruction voltage vector V* are sequentially selected as the output voltage vector so that a mean voltage of those output voltage vectors can match the instruction voltage vector V. Even if the other voltage vectors V3, V4, V5, and V6 are selected, the mean voltage can match the instruction voltage vector V. However, since the fluctuation of the magnetic flux is large, and in order to suppress the fluctuation, the number of switching operation may be increased. Therefore, this embodiment does not conduct this selection.

As described above, the respective output voltage vectors of V1, V2, V0, and V7 selected for the region “1” are integrated with time, to thereby form the magnetic flux. In this example, if Vd* and Vq* are constant, and the rotating velocity of the motor is also constant, a target locus of the magnetic flux by voltage-time integration of the instruction voltage vector V* becomes a circle having a given radius. On the other hand, a locus of the magnetic flux developed by the time integration of the respective output voltage vectors of V1, V2, V0, and V7 attempts to follow the target locus of the magnetic flux caused by the instruction voltage vector V*, but does not completely follow the target locus, and the fluctuation component remains. According to the present invention, in order to control a variation in the magnetic flux, a difference between the target locus and the real locus of the magnetic flux, that is, a variation in the magnetic flux needs to be microscopically captured. A voltage caused by the fluctuation in the magnetic flux is expressed by relative voltage vectors V1′, V2′, V0′, and V7′, and those voltages are defined by the output voltage vectors V1, V2, V0, V7, and the instruction voltage vector V* as follows.

V2′=V2−V*

V1′=V1−V*

V0′=V7′=V0−V*=V7−V* (1)

In Expression (1), each of V0 and V7 is a vector zero in magnitude on a plane of FIG. 24. Therefore, both of V0′ and V7′ are voltage vectors identical in magnitude and direction. Even if any one of V0 and V7 is selected as the output voltage, no difference is present in the locus of the magnetic flux, but a difference may be present in the number of switching operation in the inverter. Therefore, it is preferable to select any voltage smaller in the number of switching operation.

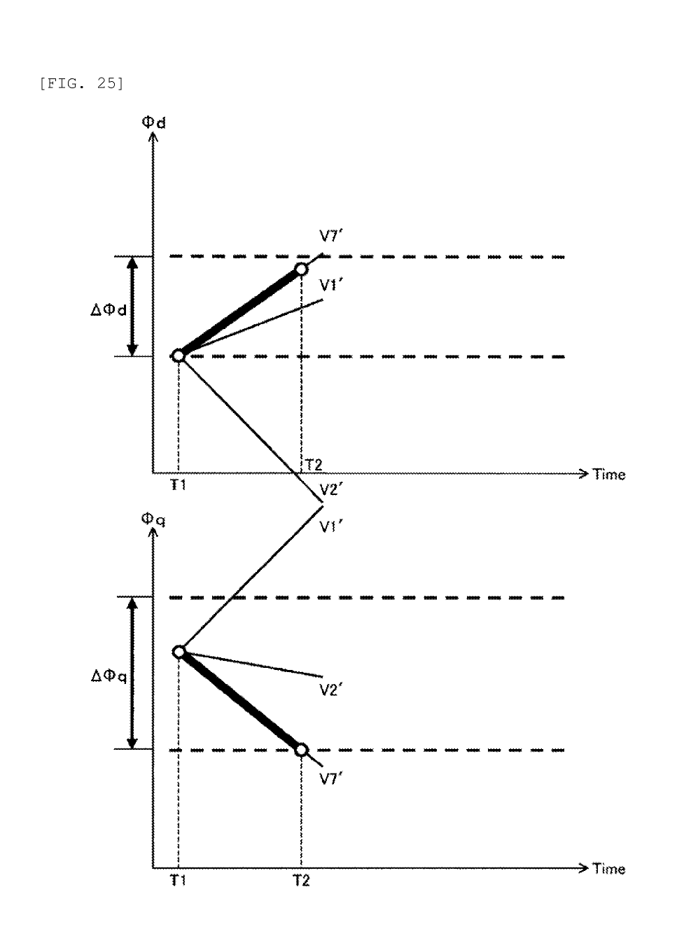

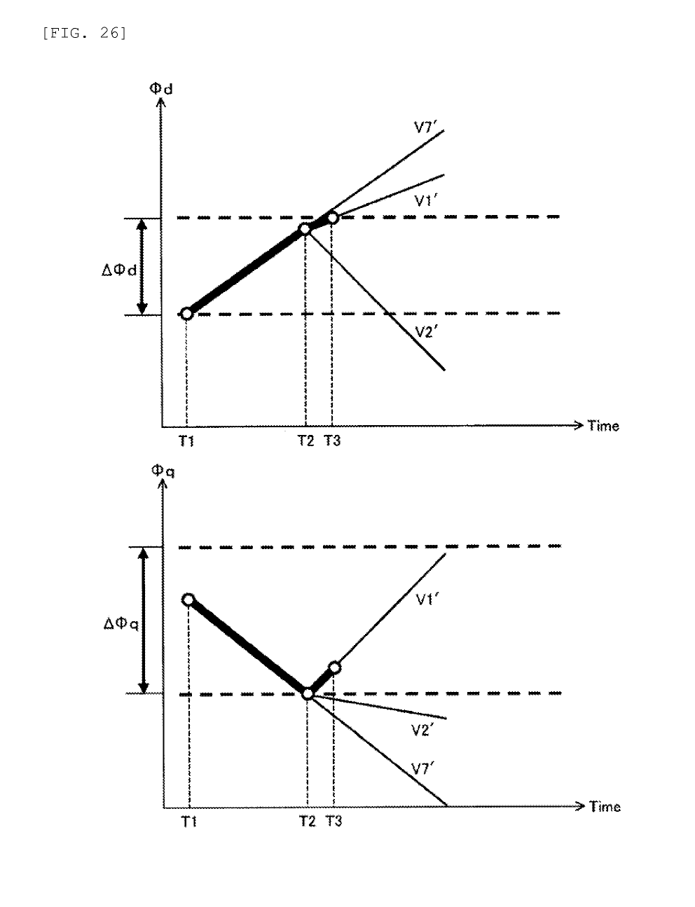

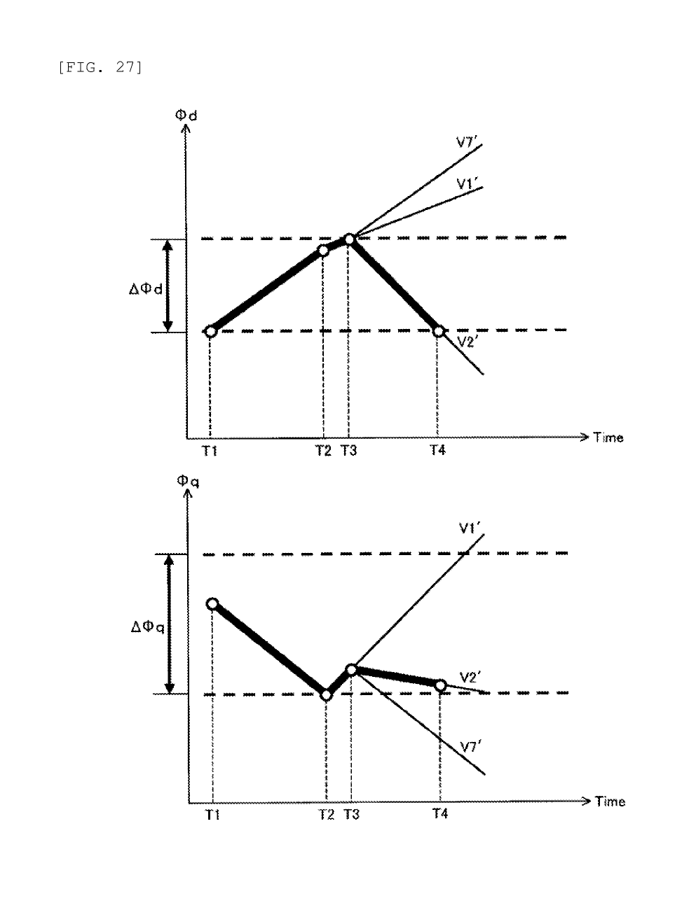

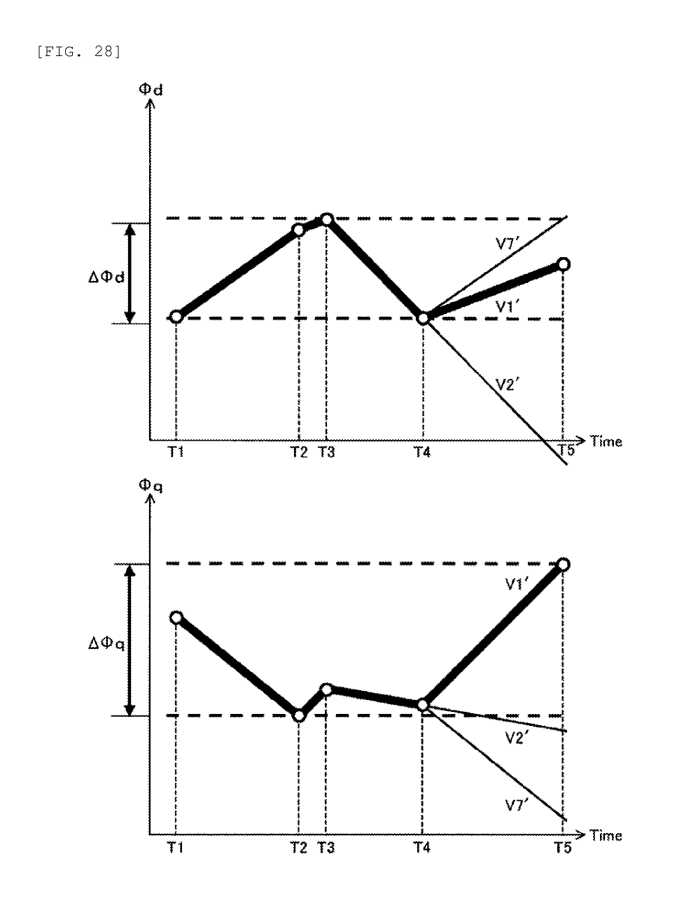

FIGS. 25 to 28 illustrate a method of selecting the output voltage vectors V1, V2, and V7 to the instruction voltage vector V* in FIG. 24, and an appearance of a change in the magnetic flux at the time of selection. In FIG. 25, when the output voltage vector V1, V2, or V7 is output from an initial state of the magnetic flux at a time T1 by the inverter, the relative voltage vector V1′, V2′, or V7′ is applied to the motor in response to the output of the output voltage vector. The magnetic fluxes are changed in directions shown by those relative voltage vectors. A change in the magnetic flux is drawn on the basis of the magnitude and the direction of the respective relative voltage vectors V1′, V2′, and V7′ in FIG. 24. In this example, it is found from the figure that the relative voltage vector in which the magnetic flux can stay within both ranges of the d-axial magnetic flux fluctuation range Δφd and the q-axial magnetic flux fluctuation range Δφg indicated by dotted lines in the figure for the longest time is the relative voltage vector V7′ among those three relative voltage vectors. That is, at the time T1, the output voltage vector V7 corresponding to the relative voltage vector V7′ is selected from the above output voltage vectors V1, V2, and V7 whereby a time interval till a subsequent switch state changeover can be maximized while limiting the magnetic flux fluctuation range within a specified range. In this example, at a time T2 shown in the figure, the subsequent switch state changeover is conducted. Likewise, in FIG. 26, the output voltage vector V1 is selected to determine a time T3 of the subsequent switch state changeover. In FIG. 27, the output voltage vector V2 is selected to determine a time T4 of the subsequent switch state changeover. In FIG. 28, the output voltage vector V1 is selected to determine a time T5 of the subsequent switch state changeover. In this way, the output voltage vectors and the times at which the switch state changeover is conducted are sequentially determined in a retrieval manner, as a result of which the fluctuation of the magnetic flux can be limited.

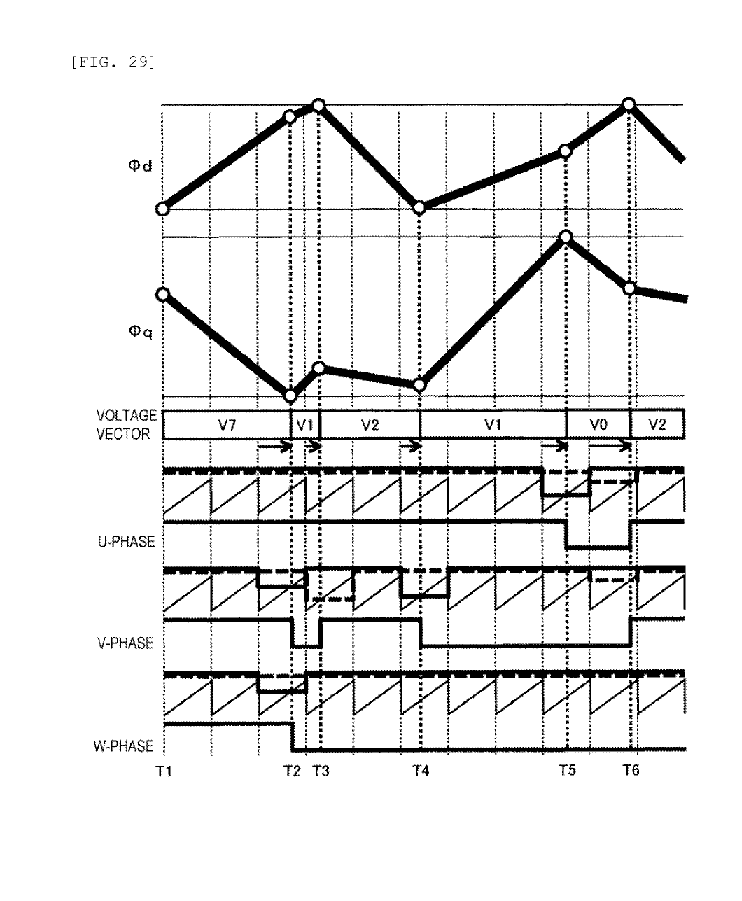

Through the processes of FIGS. 25 to 28 described above, the output voltage vector to the instruction voltage vector V*, the timing of the switch changeover, and the loci of the d-axial magnetic flux φd and the q-axial magnetic flux φq generated in response to this timing, are obtained. In the present invention, the locus of the magnetic flux is simulated within the microcomputer in the above-mentioned method with the use of the microcomputer within the control circuit 172 illustrated in FIGS. 1 and 2 to calculate the switching timing. A concept when outputting the calculation result from a microcomputer terminal is illustrated in FIG. 29. An upper stage of the figure illustrates the loci of the d-axial magnetic flux φd and the q-axial magnetic flux φq which are simulated within the microcomputer. A middle stage of the figure represents a voltage vector to be selected for the purpose of obtaining the loci of the d-axial magnetic flux φd and the q-axis φq in the upper stage. A lower stage of the figure represents a generation process of the pulses of the U, V, and W phases within the microcomputer. In the lower stage of the figure, sawtooth waves represent a timer counter, dotted lines represent a register value, and a solid line represents a switching state of the gate of the upper arm. The switching state of the lower arm is complementarily generated from the upper arm, and therefore will be omitted from the drawing. Although the switching state of the lower arm is to be determined also taking the generation mechanism of the dead time into account from a practical viewpoint, a fundamental operation will be described in this example. First, the loci of the d-axial magnetic flux φd and the q-axial magnetic flux φq illustrated in the upper stage are determined to determine the voltage vector to be selected, and the switching timing. Since this voltage vector is uniquely associated with the switching patterns of the U, V, and W phases, the switch state of the respective phases, which is changed with time, is determined. A timing at which the switch state of the respective phases switches is determined as a timing at which a time counter value of the sawtooth wave matches a register value set according to the switching timing in the microcomputer. In this example, in order to conducting the switching operation at an arbitrary timing, the register value can be arbitrarily set in the microcomputer. However, the number of switching timing that can be set in a zone of one sawtooth wave is one. For example, when attention is paid to the V phase, the register value is appropriately set in the zone of the sawtooth wave including the time T2, as a result of which the switching state can be switched from on to off at the time T2. This processing is implemented for the respective U, V, and W phases at an arbitrary timing, thereby being capable of obtaining an arbitrary pulse. The details will be described later.

It is determined that the d-axial magnetic flux fluctuation range Δφd and the q-axial magnetic flux fluctuation range Δφq illustrated in FIGS. 25 to 28 are determined according to a relationship between an electric resistance value of the permanent magnet (neodymium magnet) disposed in the rotor of the motor to be controlled, and an electric resistance value of an iron core of the rotor. Specifically, if the electric resistance value of the permanent magnet disposed in the rotor is smaller than the electric resistance value of the iron core of the rotor, the d-axial magnetic flux fluctuation range Δφd is set to be smaller than the q-axial magnetic flux fluctuation range Δφq. On the contrary, if the electric resistance value of the permanent magnet disposed in the rotor is larger than the electric resistance value of the iron core of the rotor, the d-axial magnetic flux fluctuation range Δφd is set to be larger than the q-axial magnetic flux fluctuation range Δφq. With the above configuration, the motor loss can be further reduced.

Subsequently, a configuration of the control circuit 172 according to the embodiment of the present invention will be described.

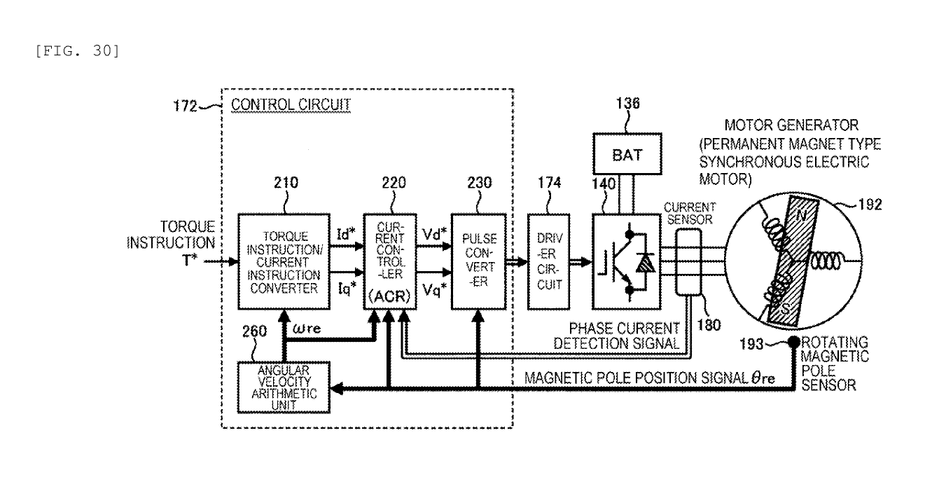

A motor control system of the control circuit 172 according to the embodiment of the present invention is illustrated in FIG. 30. A torque instruction T* is input to the control circuit 172 as the target torque value by a host control device. The torque instruction T* is input to a torque instruction/current instruction converter 210 in the control circuit 172. An angular velocity arithmetic unit 260 calculates an electric angular velocity care on the basis of a magnetic pole position signal θre of a motor generator 192 (corresponding to the motor generator MG1 in FIGS. 1 and 2) which is detected by a rotating magnetic pole sensor 193. The torque instruction/current instruction converter 210 obtains a d-axial current instruction signal Id* and a q-axial current instruction signal Iq* on the basis of the input torque instruction T* and the electric angular velocity care calculated by the angular velocity arithmetic unit 260 with the use of data of a torque-rotating velocity map stored in advance. The d-axial current instruction signal Id* and the q-axial current instruction signal Iq* obtained in the torque instruction/current instruction converter 210 are output to a current controller (ACR) 220.

Phase current detection signals Iu, Iv, and Iw of the motor generator 192, which are detected by the current sensor 180, are converted into a d-axial current signal Id and a q-axial current signal Iq on the basis of the magnetic pole position signal θre from the rotating magnetic pole sensor 193, by a 3-phase to 2-phase converter not shown on the control circuit 172. The current controller (ACR) 220 calculates a d-axial voltage instruction signal Vd* and a q-axial voltage instruction signal Vq* on the basis of the d-axial current instruction signal Id* and the q-axial current instruction signal Iq* output from the torque instruction/current instruction converter 210, and the d-axial current instruction signal Id* and the q-axial current instruction signal Iq* converted from the phase current detection signals Iu, Iv, and Iw. In this situation, the d-axial voltage instruction signal Vd* and the q-axial voltage instruction signal Vq* are determined so that the current that flows in the motor generator 192 follows the d-axial current instruction signal Id* and the q-axial current instruction signal Iq*. The d-axial voltage instruction signal Vd* and the q-axial voltage instruction signal Vq* obtained in the current controller (ACR) 220 are output to a pulse modulator 230.

The pulse modulator 230 generates six kinds of pulse signals corresponding to the respective upper and lower arms of the U phase, the V phase, and the W phase, on the basis of the d-axial voltage instruction signal Vd* and the q-axial voltage instruction signal Vq* from the current controller 220, and the magnetic pole position signal θre from the rotating magnetic pole sensor 193. Then, the pulse modulator 230 outputs the generated pulse signals to the driver circuit 174. On the basis of the generated pulse signals, a drive signal is output to the respective switching elements in the inverter circuit 140 from the driver circuit 174.

In the above-mentioned manner, the pulse signals are output as modulation waves from the control circuit 172 to the driver circuit 174. In response to the modulation wave, a drive signal for rendering the switching elements conductive or non-conducive is output from the driver circuit 174 to the respective switching elements of the inverter circuit 140, that is, the IGBT 328 for the upper arm and the IGBT 330 for the lower arm.

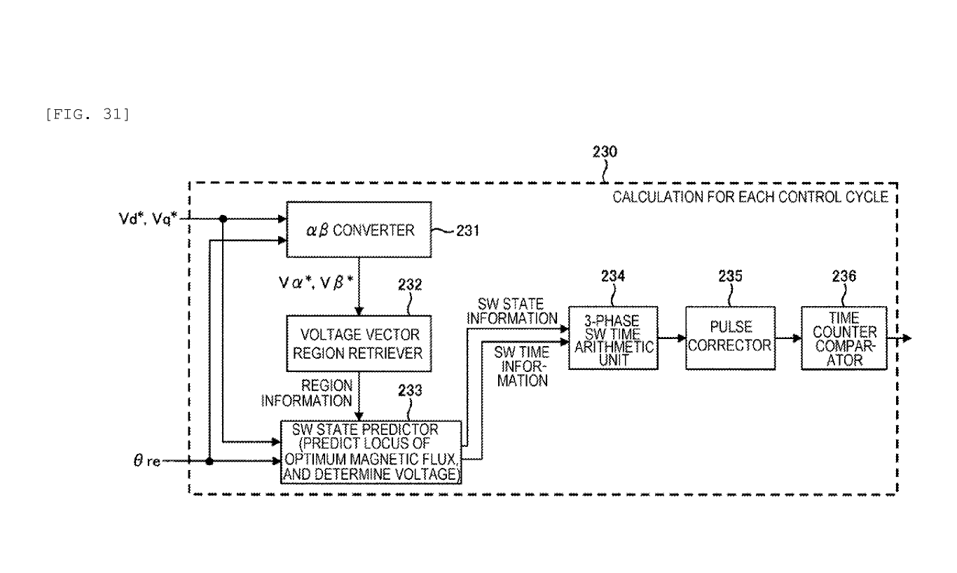

A configuration of the pulse modulator 230 is illustrated in FIG. 31. The pulse modulator 230 includes an αβ converter 231, a voltage vector region retriever 232, an SW state predictor 233, a three-phase SW time arithmetic unit 234, a pulse corrector 235, and a time counter comparator 236. The d-axial voltage instruction signal Vd* and the q-axial voltage instruction signal Vq* output from the current controller 220 are input to the αβ converter 231 and the SW state predictor 233 in the pulse modulator 230.

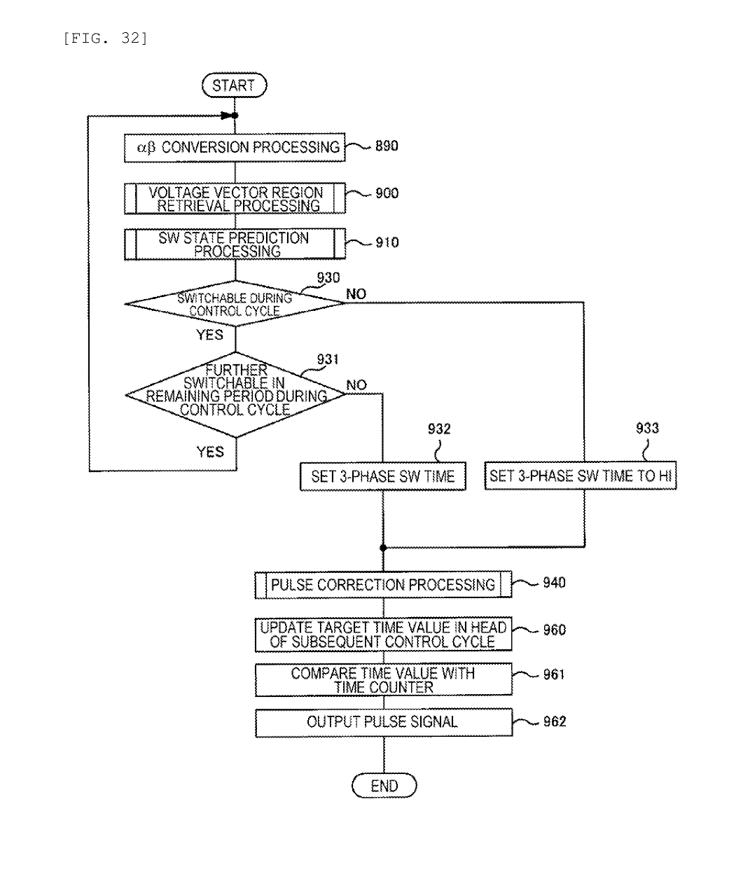

FIG. 32 is a flowchart illustrating a procedure of generating pulses, which is conducted by the pulse modulator 230. The pulse modulator 230 executes the respective processing steps in the flowchart illustrated in FIG. 32 every given control cycle to conduct the pulse generation with the use of the respective configurations illustrated in FIG. 31.

In Step 890, the αβ conversion processing is conducted with the use of the αβ converter 231. In the αβ conversion processing, the αβ converter 231 converts a voltage instruction signal of a dq axis rotating coordinate system, which is represented by the d-axial voltage instruction signal Vd* and the q-axial voltage instruction signal Vq* into a voltage instruction signal of an αβ axis stationary coordinate system, which is represented by an a-axis voltage instruction signal Vα* and a β-axial voltage instruction signal Vβ*, by the magnetic pole position signal θre of the rotating magnetic pole sensor 193. The conversion is represented by Expression (2).

Vα*=cos(θre)Vd*−sin(θre)Vq*

Vβ*=sin(θre)Vd*+cos(θre)Vq* (2)

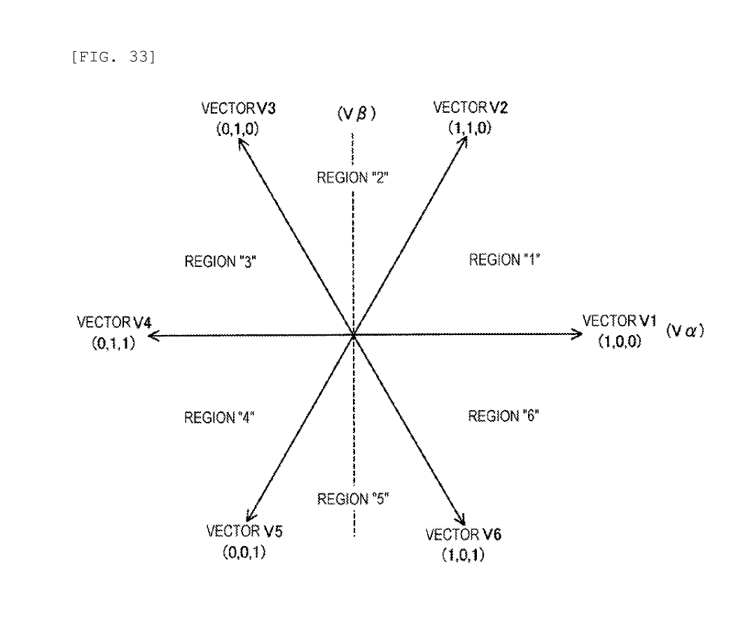

In Step 900, voltage vector region retrieval processing is conducted with the use of the voltage vector region retriever 232. In the voltage vector region retrieval processing, the voltage vector region retriever 232 retrieves a region of the voltage vector on the basis of the a-axis voltage instruction signal Vα* and the β-axial voltage instruction signal Vβ* from the αβ converter 231. A concept of the voltage vector region retrieval processing which is conducted by the voltage vector region retriever 232 will be described with reference to a vector diagram of FIG. 33. The a-axis voltage instruction signal Vα* and the β-axial voltage instruction signal Vβ* from the αβ converter 231 can be drawn as one vector on an αβ plane. The αβ plane is divided into six regions “1” to “6” compartmented by each 60° as illustrated in FIG. 33. A vector on the αβ plane corresponding to the a-axis voltage instruction signal Vα* and the β-axial voltage instruction signal Vβ* belongs to any one of those regions. The voltage vector region retriever 232 retrieves this region, and outputs voltage vector information corresponding to the retrieved region to the SW state predictor 233 which will be described later.

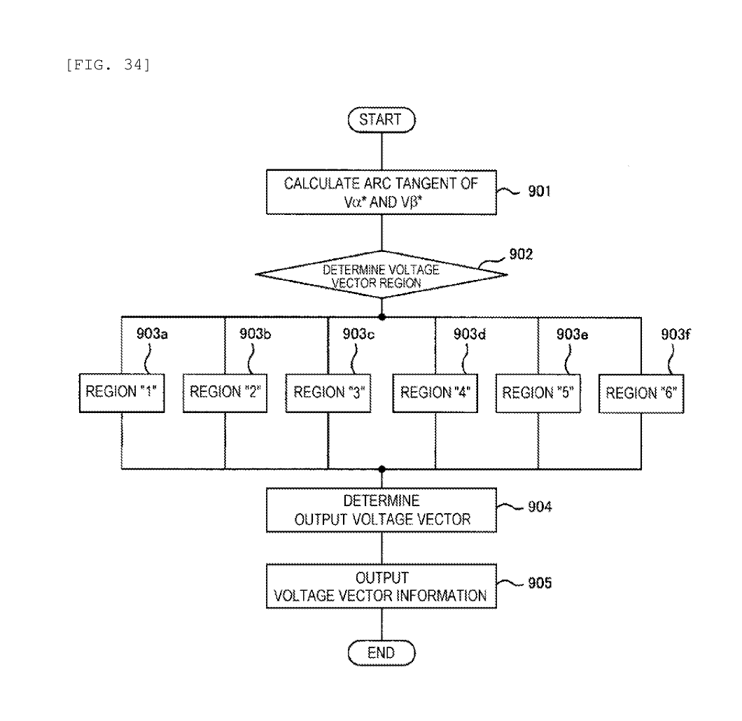

FIG. 34 is a flowchart illustrating a flow of the voltage vector region retrieval processing described above. In Step 901, the voltage vector region retriever 232 conducts arc tangent operation on the a-axis voltage instruction signal Vα* and the β-axial voltage instruction signal Vβ*. In this example, the voltage vector region retriever 232 obtains a deviation angle θv formed between the voltage vector produced by the a-axis voltage instruction signal Vα* and the β-axial voltage instruction signal Vβ*, and an a-axis on the αβ plane, through Expression (3).

θv=arctan(Vβ*/Vα*) (3)

In Step 902, the voltage vector region retriever 232 conducts processing of determining which angular range of the sixth regions “1” to “6” in FIG. 33 the deviation angle θv obtained in Step S901 belongs to. According to the determination result, the voltage vector region retriever 232 executes any processing of Steps 903a to 903f, and specifies any one of the regions “1” to “6” as the voltage vector region.

In Step 904, the voltage vector region retriever 232 determines the output voltage vector corresponding to the voltage vector region specified by any one of Steps 903a to 903f. In this example, the voltage vector region retriever 232 determines two voltage vectors closest to the specified voltage vector region as the output voltage vectors. For example, if the region “1” is obtained as the voltage vector region in Step 903a, it is understood from FIG. 33 that the region “1” is close to a voltage vector V1 (1, 0, 0) and a voltage vector V2 (1, 1, 0). Therefore, the voltage vector region retriever 232 determines the voltage vectors V1 and V2 as the output voltage vectors. Likewise, when the regions “2” to “6” are obtained as the voltage vector regions in Steps 903b to 903f, the voltage vector region retriever 232 determines two voltage vectors corresponding to each region as the output voltage vectors.

In Step 905, the voltage vector region retriever 232 outputs voltage vector information indicative of the output voltage vector determined in Step 904 to the SW state predictor 233. After Step 905 has been executed, the voltage vector region retrieval processing by the voltage vector region retriever 232 is completed, and the flow proceeds to Step 910.

In Step S910, the SW state prediction processing is conducted with the SW state predictor 233. In the SW state prediction processing, the SW state predictor 233 predicts the locus of the d-axial magnetic flux φd and the locus of the q-axial magnetic flux φq every control cycle, on the basis of the voltage vector information output from the voltage vector region retriever 232 in the voltage vector region retrieval processing of Step 900, and the d-axial voltage instruction signal Vd* and the q-axial voltage instruction signal Vq* which are input from the current controller 220, and the magnetic pole position signal θre of the rotating magnetic pole sensor 193. The SW state predictor 233 determines the switching state and the switching time according to the prediction results. The switching state indicates whether the voltage levels of the respective arms of the three phases of U, V, and W are high or low, and the switching time represents a time since a control cycle in question starts until a subsequent switch changeover is conducted. In this example, the output voltage vector and the switching time are calculated with the simulation of the locus of the magnetic flux according to the above-mentioned method described with reference to FIGS. 25 to 28. From this calculation result, the SW state predictor 233 predicts the switching state and the switching time in the subsequent control cycle, and outputs the SW state information and the SW time information.

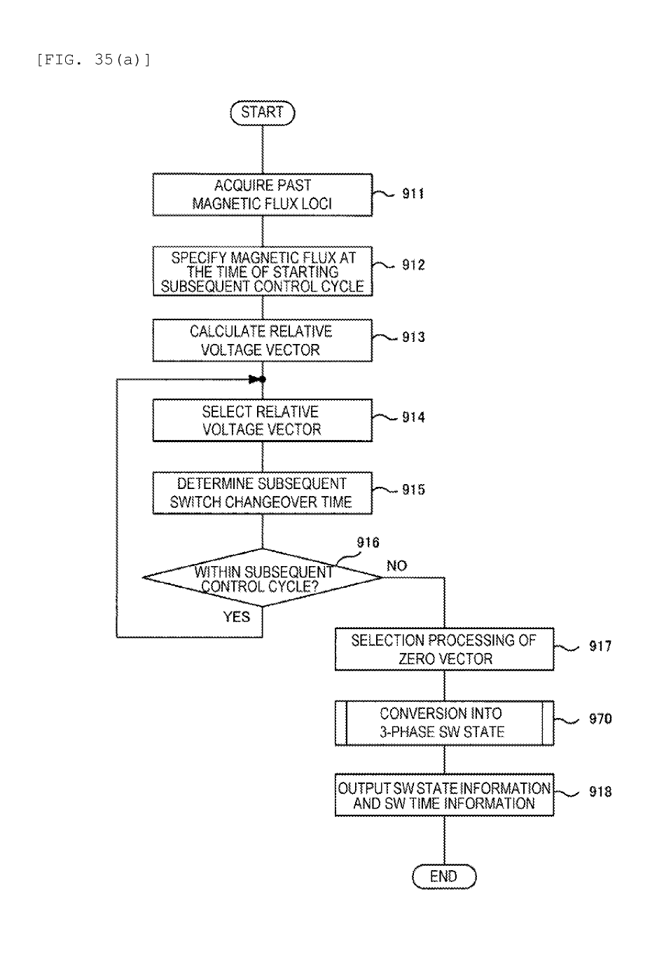

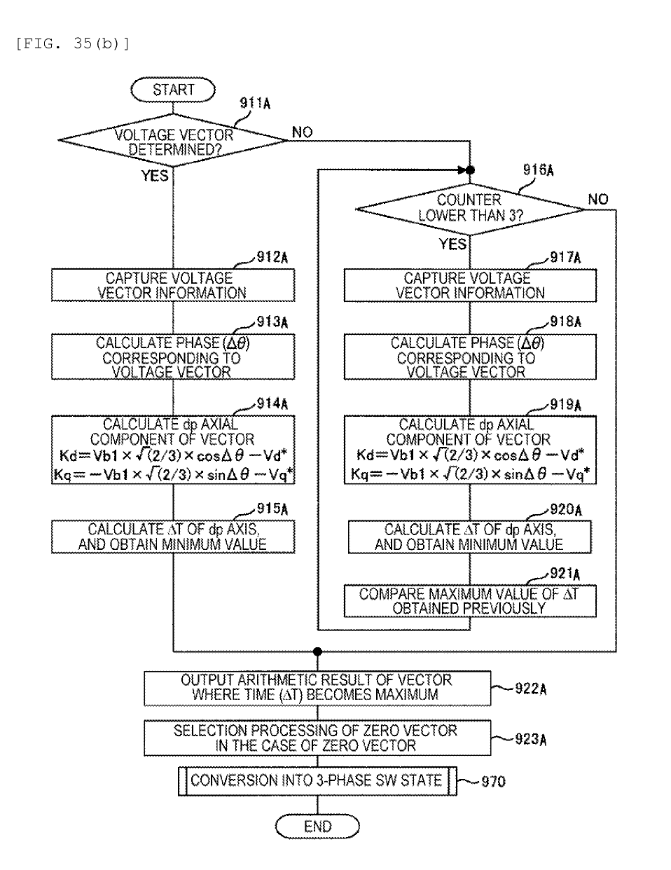

FIG. 35A is a flowchart illustrating a flow of the SW state prediction processing which is conducted by the SW state predictor 233. In Step 911, the SW state predictor 233 acquires the loci of the magnetic fluxes obtained in the past processing.

In Step 912, the SW state predictor 233 specifies the magnetic flux at the time of starting a subsequent control cycle on the basis of the loci of the past magnetic fluxes acquired in Step 911. In this example, as illustrated in FIGS. 25 to 28, the SW state predictor 233 specifies the respective magnitudes of the magnetic fluxes at the time of starting the subsequent control cycle, for the d-axial magnetic flux φd and the q-axial magnetic flux φq, according to the loci of the respective magnetic fluxes.

In Step 913, the SW state predictor 233 calculates the relative voltage vector on the basis of the voltage vector information from the voltage vector region retriever 232, the d-axial voltage instruction signal Vd*, and the q-axial voltage instruction signal Vq*. In this example, the SW state predictor 233 calculates the respective relative voltage vectors for the two output voltage vectors indicated by the voltage vector information, and the above-mentioned output voltage vector V0 (V7) which is a zero vector, through the calculation of the above-mentioned Expression (1). That is, the SW state predictor 233 can calculate the three relative voltage vectors by subtracting the instruction voltage vector V*=(Vd*, Vq*) indicated by the d-axial voltage instruction signal Vd* and the q-axial voltage instruction signal Vq* from the respective output voltage vectors.

In Step 914, the SW state predictor 233 selects any one of the three relative voltage vectors calculated in Step 913. In this example, the SW state predictor 233 selects the relative voltage vector that falls within the predetermined given d-axial magnetic flux fluctuation range Δφd and q-axial magnetic flux fluctuation range Δφq for the longest time, with respect to the d-axial magnetic flux φd and the q-axial magnetic flux φq, with the magnetic flux at the time of starting the subsequent control cycle as an origin, through the method described with reference to FIGS. 25 to 28. That is, the SW state predictor 233 selects one of the relative voltage vectors in which positions at which the loci intersect with an upper limit or a lower limit of the d-axial magnetic flux fluctuation range Δφd or the q-axial magnetic flux fluctuation range Δφq become the latest time side when the loci are extended from the respective origins in directions corresponding to the respective relative voltage vectors, with respect to the d-axial magnetic flux φd and the q-axial magnetic flux φq.

In Step 915, the SW state predictor 233 determines a subsequent switch changeover time according to the relative voltage vector selected in Step 914. In this example, the SW state predictor 233 determines, as a subsequent switch changeover time, an early one of a time at which the locus of the d-axial magnetic flux φd intersects the upper limit or the lower limit of the d-axial magnetic flux fluctuation range Δφd when the locus is extended from the origin in a direction corresponding to the selected relative voltage vector, and a time at which the locus of the q-axial magnetic flux φq intersects the upper limit or the lower limit of the q-axial magnetic flux fluctuation range Δφq when the locus is extended from the origin in a direction corresponding to the selected relative voltage vector.

In Step 916, the SW state predictor 233 determines whether the subsequent switch changeover time determined in Step 915 falls within the subsequent control cycle, or not. If the subsequent switch changeover time falls within the subsequent control cycle, the SW state predictor 233 returns to Step 914, and once again repeats the processing in the above-mentioned Steps 914 and 915 with the magnetic flux at the subsequent switch changeover time as the origin. On the other hand, if the subsequent switch changeover time is later than the subsequent control cycle, the SW state predictor 233 proceeds to Step 917.

In Step 917, the SW state predictor 233 conducts the selection processing of the zero vector. In this example, when the SW state predictor 233 selects the zero vector, the SW state predictor 233 selects any one of the output voltage vectors V0 and V7 which are the zero vectors. For example, the SW state predictor 233 can select the output voltage vector which is smaller in a state change of the switching element from a relationship with the output voltage vector selected in the previous processing.

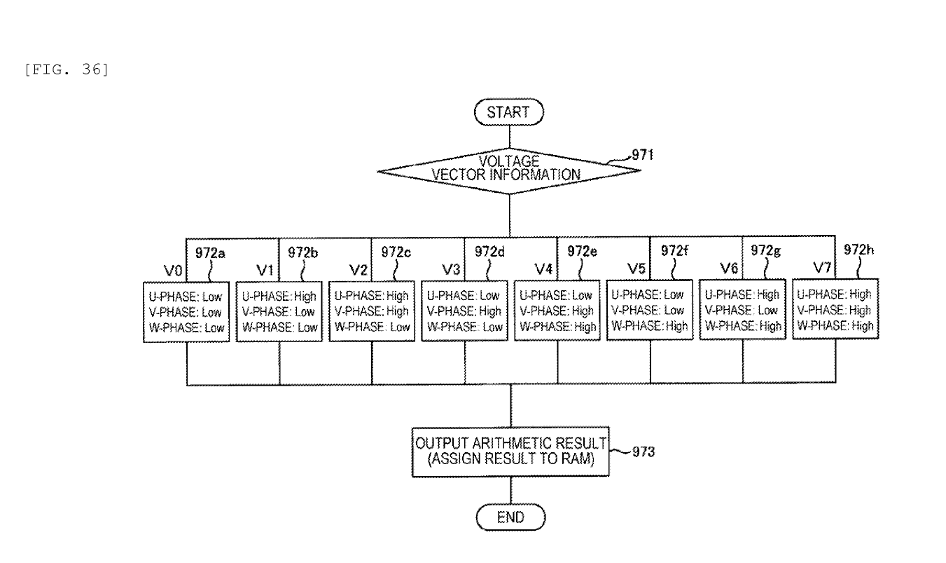

In subsequent Step 970, the SW state predictor 233 conducts three-phase SW state conversion processing for converting the relative voltage vector selected in Step 914 into the three-phase SW state. FIG. 36 is a flowchart illustrating a flow of the three-phase SW state conversion processing.

In Step 971, the SW state predictor 233 determines which of V0 to V7 the output voltage vector corresponding to the relative voltage vector selected in Step 914 is. According to the determination result, the SW state predictor 233 executes any processing of Steps 972a to 972h, and determines the state of the respective U, V, and W phases corresponding to the output voltage vector. That is, the SW state predictor 233 determines whether the respective U, V, and W phases are in a high state or a low state.

In Step 973, the SW state predictor 233 outputs the arithmetic result indicative of the state of the respective U, V, and W phases, which is determined in any one of Steps 972a to 972h. In this example, the SW state predictor 233 assigns the information indicative of the determined state of the respective U, V, and W phases to a RAM not shown to output the arithmetic result. After Step 973 has been executed, the SW state predictor 233 completes the processing of Step 970 in FIG. 35A, and proceeds to Step 918.

In Step 918, the SW state predictor 233 outputs the SW state information and the SW time information to the three-phase SW time arithmetic unit 234 on the basis of the state of the respective U, V, and W phases determined in the three-phase SW state conversion processing of Step 970, and the subsequent switch changeover time determined in Step 915. That is, the SW state predictor 233 outputs the SW state information indicative of the state of the respective U, V, and W phases in the subsequent control cycle, and the SW time information indicative of the subsequent switch changeover time, as the result of the SW state prediction processing. After Step 918 has been executed, the SW state predictor 233 completes the SW state prediction processing, and proceeds to Step 930 in FIG. 32.

In Steps 930 to 933, the processing using the three-phase SW time arithmetic unit 234 is conducted. In this processing, the three-phase SW time arithmetic unit 234 receives the SW state information and the SW time information which are output from the SW state predictor 233, and calculates a rising time and a falling time of the switch of the respective U, V, and W phases within the subsequent control cycle.

In Step 930, the three-phase SW time arithmetic unit 234 determines whether the subsequent switch changeover time determined in the SW state prediction processing of Step 910 is present within the subsequent control cycle, or not, on the basis of the SW time output from the SW state predictor 233. If the subsequent switch changeover time determined in the SW state prediction processing of Step 910 is present within the subsequent control cycle, the three-phase SW time arithmetic unit 234 proceeds to Step 931, and if not present, the three-phase SW time arithmetic unit 234 proceeds to Step 933.

In Step 931, the three-phase SW time arithmetic unit 234 determines whether the switching operation is potentially further conducted in a remaining period of the subsequent control cycle, or not. If yes, the three-phase SW time arithmetic unit 234 returns to Step 890, and if no, the three-phase SW time arithmetic unit 234 proceeds to Step 932. This is determined according to whether any one of a register in a rising time and a register in a falling time of a downstream time counter is free, or not. As described above, each of the register values of rising and falling within one control cycle can be set once.

In Step 932, the three-phase SW time arithmetic unit 234 sets the switching time of the three phases of U, V, and W. In this processing, the three-phase SW time arithmetic unit 234 calculates the rising time and the falling time in the respective U, V, and W phases, on the basis of the SW state information and the SW time information from the SW state predictor 233, and sets the respective register values of the rising and falling according to the calculation result. If the switching operation is not conducted, the three-phase SW time arithmetic unit 234 sets a time larger than the control cycle as the switching time, thereby being capable of preventing the switching time stored in the register from intersecting with the time counter.

In Step 933, the three-phase SW time arithmetic unit 234 sets the switching time so as not to switch the three phases of U, V, and W during the subsequent control cycle. In this example, the three-phase SW time arithmetic unit 234 sets the rising time and the falling time of the respective U, V, and W phases as in Step 932. However, since the switching operation is not conducted during the control cycle, the three-phase SW time arithmetic unit 234 sets values larger than the control cycle as all of the switching times.

The switching time is set in Step 932 or 933 whereby a rising time Ton and a falling time Toff are set for the three phases of U, V, and W, respectively. The information on the rising time Ton and the falling time Toff is output from the three-phase SW time arithmetic unit 234 to the pulse corrector 235.

In Step 940, the pulse correction processing is conducted with the use of the pulse corrector 235. The pulse corrector 235 is a portion for realizing a required function because there are some prohibition laws, when inserting a signal output from the three-phase SW time arithmetic unit 234 into the downstream time counter comparator 236. In Step 940, the pulse corrector 235 conducts pulse correction processing for conducting a minimum pulse width limitation and a pulse continuity compensation on the rising time Ton and the falling time Toff output from the three-phase SW time arithmetic unit 234 in Step 932 or 933. Then, the pulse corrector 235 outputs the results to the time counter comparator 236 as a rising time Ton′ and a falling time Toff′ which have been subjected to pulse correction. A specific content of the pulse correction processing will be described in detail later.

In Steps 960 to 962, processing using the time counter comparator 236 is conducted. In this processing, the time counter comparator 236 generates the pulse signals as the switching instructions to the respective upper and lower arms of the U phase, the V phase, and the W phase, on the basis of the rising time Ton′ and the falling time Toff′ output from the pulse corrector 235, which have been subjected to the pulse correction. Six kinds of pulse signal to the respective upper and lower arms in the respective phases, which have been generated by the time counter comparator 236, are output to the driver circuit 174 as described above. As a result, the drive signals are output from the driver circuit 174 to the respective switching elements.

In Step 960, the time counter comparator 236 sets the rising time Ton′ and the falling time Toff′ output from a pulse corrector 438 in Step 940, which have been subjected to the pulse correction, as the target time values in a subsequent control cycle Tn+1, at a timing of a head of the subsequent control cycle Tn+1, and updates the target time value.

In Step 961, the time counter comparator 236 compares a value of the time counter with the target time value set in Step 960. On the basis of this comparison result, the time counter comparator 236 allows the pulse signal to rise in the rising time Ton′ that has been subjected to the pulse correction, and allows the pulse signal to fall in the falling time Toff′ that has been subjected to the pulse correction, to generate the pulse signal.

In Step 962, the time counter comparator 236 outputs the pulse signal generated in Step 961 to the driver circuit 174.

The processing of Steps 890 to 962 described above is conducted in the pulse modulator 230, to thereby generate the pulse signal in which the fluctuation of the magnetic flux is limited within a given range while the number of switching is reduced as compared with the related art PWM control.

As described above, the pulse signal is output as the modulation wave from the control circuit 172 to the driver circuit 174. According to the modulation wave, the drive signal is output from the driver circuit 174 to the respective IGBTs 328 and 330 of the inverter circuit 140.

In the motor control system illustrated in FIG. 30, the control cycle of, for example, about several hundreds of μs is predetermined as the control cycle to the motor generator 192 in response to a request from a system performance. The pulse modulator 230 repetitively calculates the state of the IGBTs 328 and 330 which are the switching elements, every control cycle. In response to the calculation result, the pulse modulator 230 generates the pulse signal in the subsequent control cycle, and outputs the pulse signal to the driver circuit 174.

In Step 910 of FIG. 32, the SW state predictor 233 may execute the SW state prediction processing of the contents different from the above processing. FIG. 35B is a flowchart illustrating a flow of the SW state prediction processing in another processing method, which is executed in the SW state predictor 233. In Step 911A, the SW state predictor 233 determines whether the voltage vector in the subsequent processing cycle is decided, or not. If the voltage vector in the subsequent processing cycle is decided, the SW state predictor 233 proceeds to Step 912A. In this case, AT of the current locus calculated in the previous cycle is longer than the PWM cycle, and a current locus of a portion carried over in the subsequent cycle as a remainder is recalculated.

On the other hand, if it is determined that the voltage vector in the subsequent processing cycle is not decided in Step 911A, the SW state predictor 233 proceeds to Step 916A. In this case, the SW state predictor 233 obtains a travel time of the current locus within a hysteresis region for each of the obtained vectors, and selects a vector in which the travel time becomes maximal.

This processing obtains a time to the respective intersections between the current locus and the dq axis in the hysteresis region, and sets a smaller value as the travel time of the current locus of its vector. This processing obtains the current locus in which a time until the current locus intersects with the hysteresis region becomes maximal from candidates of the current locus which are obtained for the respective vectors.

In Steps 914A and 919A, the dq axis components Kd and Kg in the respective vectors are obtained. The calculation expressions in this situation are show in the figures.

In Step 970, the SW state predictor 233 conducts the three-phase SW state conversion processing according to a flowchart illustrated in FIG. 36. That is, the SW state predictor 233 configures on/off information in the respective phases of U, V, and W according to mode information of the obtained output voltage vector. Because the state of on/off in each of the phases is uniquely determined according to the output voltage vector, the mode information is determined to decide the state.

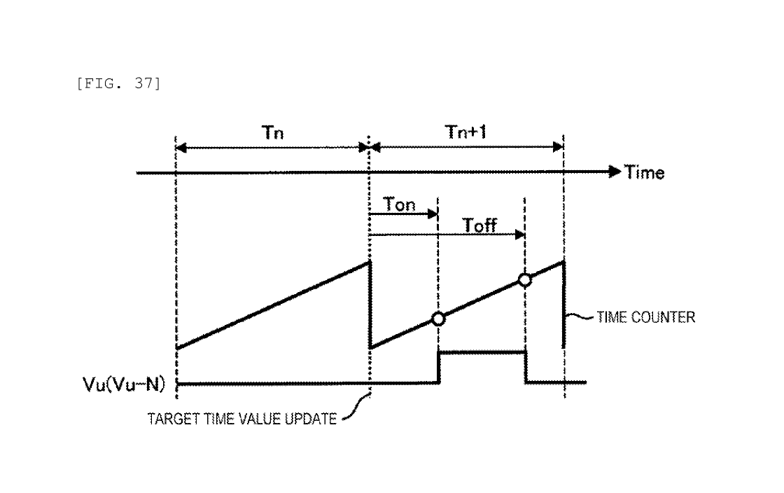

A basic principle of the pulse generation by the pulse modulator 230 according to this embodiment is illustrated in FIG. 37. As illustrated in FIG. 37, the rising time Ton and the falling time Toff are calculated in a head of the control cycle Tn. The rising time Ton′ and the falling time Toff′ which have been subjected to the pulse correction are determined on the basis of the rising time Ton and the falling time Toff, and the pulse signal is output to the respective phases of the U phase, the V phase, and the W phase with the use of a compare-match function. FIG. 37 illustrates only the pulse signal of the U phase, but the same is applied to the V phase and the W phase.

Subsequently, the pulse correction processing to be executed in Step 940 of FIG. 32 will be described. As described above, the pulse correction processing is executed to subject the generated pulse to the minimum pulse width limitation and the pulse continuity compensation in the pulse corrector 235. The minimum pulse width limitation is to output the pulse width corresponding to the rising time Ton and the falling time Toff calculated in Step 932 or 933 as the minimum pulse width when the pulse width becomes lower than a given minimum pulse width. The minimum pulse width in this case is determined according to a response speed of the IGBTs 328 and 330 which are the switching elements. On the other hand, the pulse continuity compensation is to change and output the pulse waveform so that the pulse continuity is kept when the pulse pattern is changed between the pulse waveform generated on the basis of prediction in one previous control cycle, and the pulse waveform to be generated in the present control cycle, and the pulse continuity is not kept without any change. Such a change in the pulse pattern occurs when a state of the motor generator 192 is precipitously changed due to a factor such as disturbance, or a control mode is switched to another.

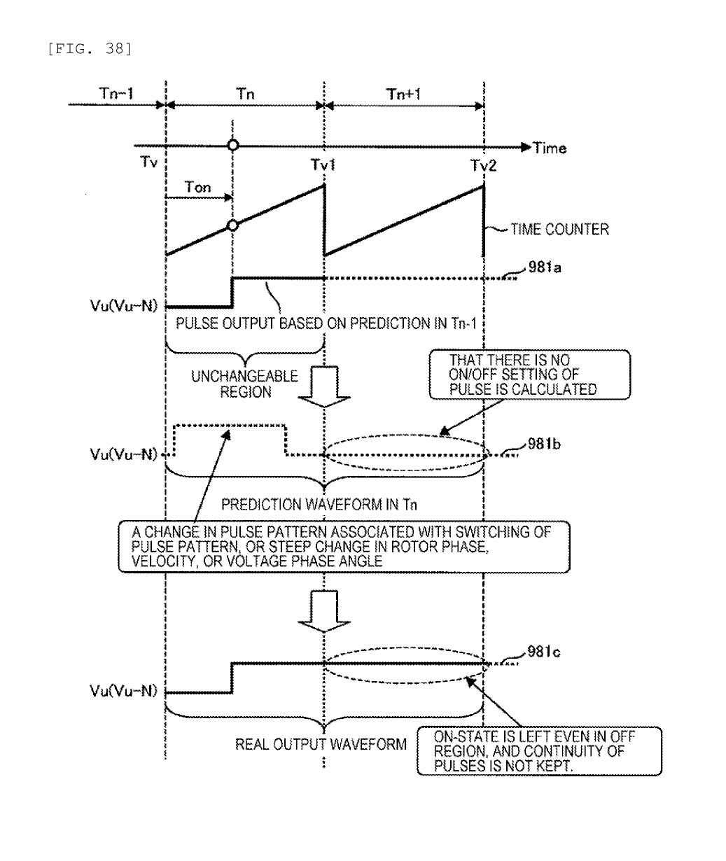

FIG. 38 illustrates an example of the pulse waveforms output when the pulse continuity compensation is not conducted. It is assumed that in the control cycle Tn−1, the rising time Ton is calculated in the above-mentioned method, and a pulse waveform 981a in the control cycle Tn is output. The pulse waveform 981a cannot be changed in the control cycle Tn. Thereafter, it is assumed that the pulse pattern is changed in the control cycle Tn, and a pulse waveform 11b in the subsequent control cycle Tn+1 is calculated. Because a pulse waveform 981b is always off in a period of the control cycle Tn+1, and no pulse is present, the rising time Ton and the falling time Toff are not set in the control cycle Tn+1. However, the pulse waveform 981a that has already been output in the control cycle Tn is not off but on in a time Tv1. For that reason, a real output pulse waveform 981c becomes on in the control cycle Tn+1 although the output pulse waveform. 981c is to be off. In this way, unless the pulse continuity compensation is not conducted, the continuity of the pulses may not be kept when the pulse pattern is changed halfway.

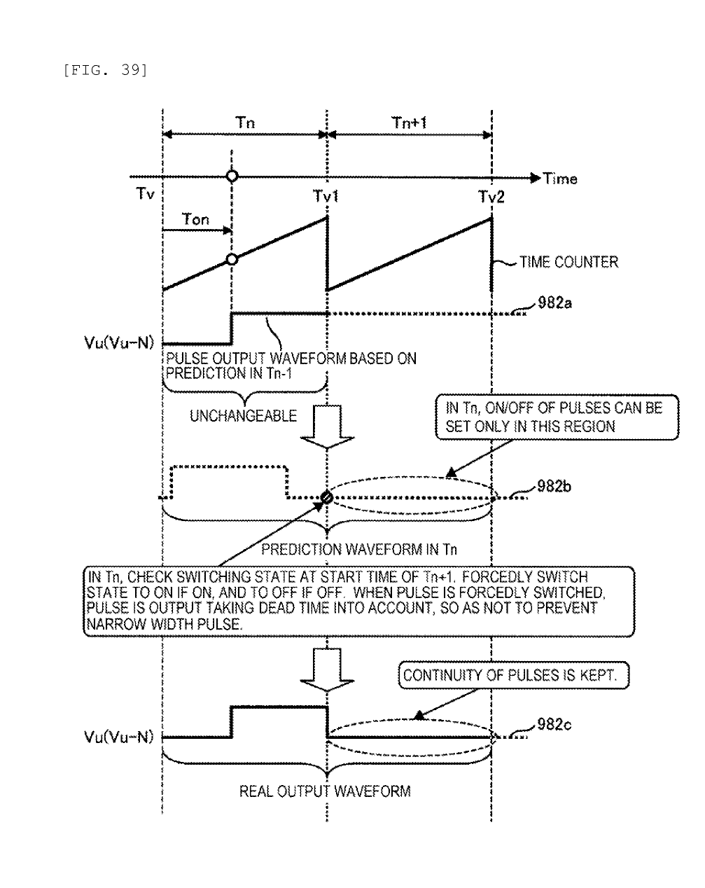

FIG. 39 illustrates an example of the pulse waveforms output when the pulse continuity compensation is conducted. In this case, after a pulse waveform 982b in the subsequent control cycle Tn+1 is calculated in the control cycle Tn, an on/off state in a start time Tv1 of its pulse waveform 12b, that is, a control state of the conduction or cut-off of the IGBTs 328 and 330 which are the switching elements is confirmed, and the pulse waveform 12b is compared with a pulse waveform 982a in the control cycle Tn. As a result, the on/off states of the pulse waveform 982a and the pulse waveform 12b do not match each other at a time Tv1. When both of those pulse waveforms have a discontinuous relationship, the on/off state of a corrected pulse waveform 982c is forcedly switched at the time Tv1. As a result, the continuity of the pulses can be kept.

That is, if the pulse waveform 982a is on, and the pulse waveform 982b is off at the time Tv1 as illustrated in FIG. 39, the corrected pulse waveform 982c is forcedly turned off at the time Tv1. In this case, the time Tv1 is newly set as the falling time Toff′ after the pulse has been corrected. On the other hand, contrary to FIG. 39, if the pulse waveform 982a is off, and the pulse waveform 982b is on in the time Tv1, the corrected pulse waveform 982c is forcedly turned on at the time Tv1. In this case, the time Tv1 is newly set as the rising time Ton′ after the pulse has been corrected. If the on/off states of the pulse waveform 982a and the pulse waveform 982b match each other at the time Tv1, and both of the pulse waveforms are continuous, such a pulse continuity compensation is not conducted.

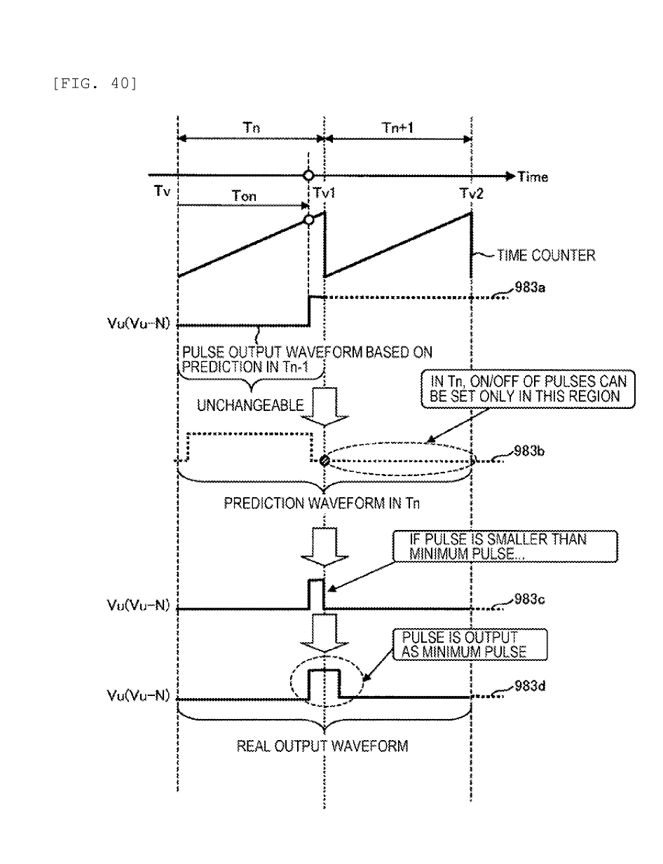

When the corrected pulse waveform is forcedly turned on or off by the pulse continuity compensation, the pulse is output taking a dead time into account so as to prevent the pulse width from being lower than the above-mentioned minimum pulse width by the minimum pulse width limitation. FIG. 40 illustrates an example of the pulse waveforms output when the minimum pulse width limitation is conducted. It is assumed that after the rising time Ton of the control cycle Tn is calculated, and a pulse waveform 983a is output in the control cycle Tn−1, the pulse pattern is changed in the control cycle Tn, and a pulse waveform 983b in the subsequent control cycle Tn+1 is calculated. In this case, a corrected pulse waveform 983c is forcedly turned off at the Tv1 by the above-mentioned pulse continuity compensation, and the pulse width in this situation is lower than the minimum pulse width. In this case, the minimum pulse width limitation is conducted, the pulse width is enlarged to the minimum pulse width. As a result, a corrected pulse waveform 983d which turns off in timing shifted from the time Tv1 is output. In this situation, a time corresponding to the enlarged pulse width is newly set as the falling time Toff′ after the pulse correction. FIG. 40 exemplifies a case in which the corrected pulse waveform is forcedly turned off. However, the same is applied to a case in which the corrected pulse waveform is forcedly turned on.

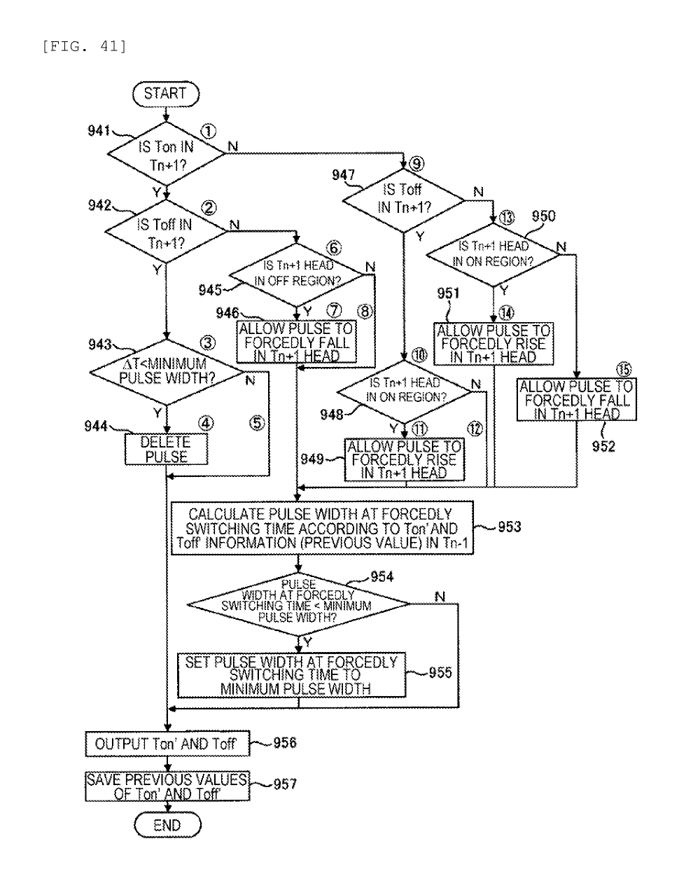

A flowchart illustrating a procedure of the pulse correction processing described above in detail is illustrated in FIG. 41. In this case, a case in which the pulse correction processing is executed in the control cycle Tn will be described. In Step 941, the pulse corrector 235 determines whether the rising time Ton calculated by the three-phase SW time arithmetic unit 234 is present in the subsequent control cycle Tn+1, or not, in Step 932 or 933 of FIG. 32. If the rising time Ton is present in the control cycle Tn+1, the pulse corrector 235 proceeds to Step 942, and if the rising time Ton is absent, the pulse corrector 235 proceeds to Step 947.

In Step 942, the pulse corrector 235 determines whether the falling time Toff calculated by the three-phase SW time arithmetic unit 234 is present in the subsequent control cycle Tn+1, or not, in Step 932 or 933 of FIG. 32. If the falling time Toff is present in the control cycle Tn+1, the pulse corrector 235 proceeds to Step 943, and if the falling time Ton is absent, the pulse corrector 235 proceeds to Step 945.

In Step 943, the pulse corrector 235 determines whether the pulse width ΔT corresponding to a period from the rising time Ton to the falling time Toff, or from the falling time Toff to the rising time Ton is lower than a given minimum pulse width, or not. The pulse width AT can be obtained as a time difference between the rising time Ton and the falling time Toff. Also, the minimum pulse width can be predetermined according to a response speed of the IGBTs 328 and 330 which are the switching elements as described above. If the pulse width AT is lower than the minimum pulse width, the pulse corrector 235 proceeds to Step 944, and if the pulse width AT is equal to or higher than the minimum pulse width, the pulse corrector 235 proceeds to Step 956.

In Step 944, the pulse corrector 235 deletes the pulse calculated by the three-phase SW time arithmetic unit 234. That is, the pulse corrector 235 does not output both of the rising time Ton′ and the falling time Toff′ which have been subjected to the pulse correction to the time counter comparator 236 regardless of the values of the rising time Ton and the falling time Toff output from the three-phase SW time arithmetic unit 234. As a result, the pulse signal generated by the time counter comparator 236 is not changed within the period of the control cycle Tn+1 in Step 962 of FIG. 32, and the control state of conduction or cut-off of the IGBTs 328 and 330 which are the switching elements is maintained. After Step 944 has been executed, the pulse corrector 235 proceeds to Step 956.

In Step 945, the pulse corrector 235 determines whether a head of the subsequent control cycle Tn+1 is in an off region, or not. If the head is in the off region, that is, if the pulse waveform calculated by the three-phase SW time arithmetic unit 234 in the control cycle Tn is off in the time Tv1, the pulse corrector 235 proceeds to Step 946. On the other hand, if the head is in the on region, that is, if the pulse waveform calculated by the three-phase SW time arithmetic unit 234 in the control cycle Tn is on in the time Tv1, the pulse corrector 235 proceeds to Step 953.

In Step 946, the pulse corrector 235 forces the pulse calculated by the three-phase SW time arithmetic unit 234 to fall in the head of the subsequent control cycle Tn+1. That is, the pulse corrector 235 newly sets the time Tv1 as the falling time Toff′ after the pulse has been corrected, to thereby forcedly turn off the pulse signal generated by the time counter comparator 236 in the head of the control cycle Tn+1 in Step 962 of FIG. 32. As a result, the pulse corrector 235 additionally conducts the control of cut-off of the IGBTs 328 and 330 if a relationship between the cut-off state of the IGBTs 328 and 330 in the control cycle Tn, and the cut-off state of the IGBTs 328 and 330 in the subsequent control cycle Tn+1 has a discontinuous relationship. After Step 946 has been executed, the pulse corrector 235 proceeds to Step 953.

In Step 947, the pulse corrector 235 determines whether the falling time Toff calculated by the three-phase SW time arithmetic unit 234 is present in the subsequent control cycle Tn+1, or not, in Step 932 or 933 of FIG. 32. If the falling time Toff is present in the control cycle Tn+1, the pulse corrector 235 proceeds to Step 948, and if the falling time Toff is absent, the pulse corrector 235 proceeds to Step 950.

In Step 948, the pulse corrector 235 determines whether the head of the subsequent control cycle Tn+1 is in an on region, or not. If the head is in the on region, that is, if the pulse waveform calculated by the three-phase SW time arithmetic unit 234 in the control cycle Tn is on in the time Tv1, the pulse corrector 235 proceeds to Step 949. On the other hand, if the head is in the off region, that is, if the pulse waveform calculated by the three-phase SW time arithmetic unit 234 in the control cycle Tn is off in the time Tv1, the pulse corrector 235 proceeds to Step 953.

In Step 949, the pulse corrector 235 forces the pulse calculated by the three-phase SW time arithmetic unit 234 to rise in the head of the subsequent control cycle Tn+1. That is, the pulse corrector 235 newly sets the time Tv1 as the rising time Ton′ after the pulse has been corrected, to thereby forcedly turn on the pulse signal generated by the time counter comparator 236 in the head of the control cycle Tn+1 in Step 962 of FIG. 32. As a result, the pulse corrector 235 additionally conducts the control of conduction of the IGBTs 328 and 330 if a relationship between the conduction state of the IGBTs 328 and 330 in the control cycle Tn, and the conduction state of the IGBTs 328 and 330 in the subsequent control cycle Tn+1 has a discontinuous relationship. After Step 949 has been executed, the pulse corrector 235 proceeds to Step 953.

In Step 950, the pulse corrector 235 determines whether the head of the subsequent control cycle Tn+1 is in the on region, or not. If the head is in the on region, that is, if the pulse waveform calculated by the three-phase SW time arithmetic unit 234 in the control cycle Tn is on in the time Tv1, the pulse corrector 235 proceeds to Step 951. On the other hand, if the head is in the off region, that is, if the pulse waveform calculated by the three-phase SW time arithmetic unit 234 in the control cycle Tn is off in the time Tv1, the pulse corrector 235 proceeds to Step 952.

In Step 951, the pulse corrector 235 forces the pulse calculated by the three-phase SW time arithmetic unit 234 to rise in the head of the subsequent control cycle Tn+1, as in Step 949. That is, the pulse corrector 235 newly sets the time Tv1 as the rising time Ton′ after the pulse has been corrected, to thereby forcedly turn on the pulse signal generated by the time counter comparator 236 in the head of the control cycle Tn+1 in Step 962 of FIG. 32. As a result, the pulse corrector 235 additionally conducts the control of conduction of the IGBTs 328 and 330 if a relationship between the conduction state of the IGBTs 328 and 330 in the control cycle Tn, and the conduction state of the IGBTs 328 and 330 in the subsequent control cycle Tn+1 has a discontinuous relationship. After Step 951 has been executed, the pulse corrector 235 proceeds to Step 953.

In Step 952, the pulse corrector 235 forces the pulse calculated by the three-phase SW time arithmetic unit 234 to fall in the head of the subsequent control cycle Tn+1, as in Step 946. That is, the pulse corrector 235 newly sets the time Tv1 as the falling time Toff′ after the pulse has been corrected, to thereby forcedly turn off the pulse signal generated by the time counter comparator 236 in the head of the control cycle Tn+1 in Step 962 of FIG. 32. As a result, the pulse corrector 235 additionally conducts the control of cut-off of the IGBTs 328 and 330 if a relationship between the cut-off state of the IGBTs 328 and 330 in the control cycle Tn, and the cut-off state of the IGBTs 328 and 330 in the subsequent control cycle Tn+1 has a discontinuous relationship. After Step 952 has been executed, the pulse corrector 235 proceeds to Step 953.

In Step 953, the pulse corrector 235 acquires information on the rising time Ton′ or the falling time Toff′ which have been subjected to the pulse correction, which are calculated in the previous control cycle Tn−1 as a previous value, and calculates the pulse width in the forcedly switching operation on the basis of the previous value. That is, the pulse corrector 235 obtains a time difference between the time Tv1 newly set as the rising time Ton′ or the falling time Toff′ which has been subjected to the present pulse correction in Step 946, 949, 951, or 952, and the rising time Ton′ or the falling time Toff′ of the previous value, to thereby calculate the pulse width in the forcedly switching operation. The information on the rising time Ton′ or the falling time Toff′ of the previous value is acquired from information saved in Step 956 which will be described later. When a plurality of phase values are saved as the rising time Ton′ or the falling time Toff′ of the previous value, a time closest to the time Tv1 among the phase values is acquired.

In Step 954, the pulse corrector 235 determines whether the pulse width in the forcedly switching operation, which is calculated in Step 953, is lower than the minimum pulse width, or not. The minimum pulse width is identical with that used for determination in Step 943. If the pulse width in the forced switching operation is lower than the minimum pulse width, the pulse corrector 235 proceeds to Step 955, and if the pulse width in the forced switching operation is equal to or higher than the minimum pulse width, the pulse corrector 235 proceeds to Step 956.

In Step 955, the pulse corrector 235 sets the pulse width in the forced switching operation which is calculated in Step 953 to becomes the minimum pulse width. A value of the rising time Ton′ or the falling time Toff′ subjected to the present pulse correction, which is set in Step 946, 949, 951, or 952 is changed from θv1 that is a default value thereof, and obtained by adding a time value corresponding to the minimum pulse width to the rising time Ton′ or the falling time Toff′ of the previous value. As a result, the pulse corrector 235 limits the pulse width in the forced switching operation so as not to be lower than the minimum pulse width.

If none of Steps 946, 949, 951, and 952 is executed, the respective processing in Steps 953 to 955 may be omitted.

In Step 956, the pulse corrector 235 outputs the rising time Ton′ or the falling time Toff′ subjected to the pulse correction, which is finally determined by the above respective processing to the time counter comparator 236. That is, if it is determined that the pulse width AT is equal to or higher than the minimum pulse width in Step 943, the pulse corrector 235 outputs the rising time Ton and the falling time Toff from the three-phase SW time arithmetic unit 234 as they are as the rising time Ton′ or the falling time Toff′ which have been subjected to the pulse correction. Also, if the pulse corrector 235 sets the value of the rising time Ton′ or the falling time Toff′ which has been subjected to the pulse correction when the pulse is forced to rise or fall in Step 946, 949, 951, or 952, the pulse corrector 235 outputs the set value. When the set value is changed by execution of Step 955, the pulse corrector 235 outputs the changed set value.

In Step 957, the pulse corrector 235 saves the value of the rising time Ton′ or the falling time Toff′ subjected to the pulse correction, which is output in Step 956 in a memory not shown. The value saved in this situation is acquired as the previous value when the flowchart of FIG. 41 is executed in the subsequent control cycle Tn+1.

Through the processing of Steps 941 to 957 described above, the pulse correction processing is conducted in the pulse corrector 235.

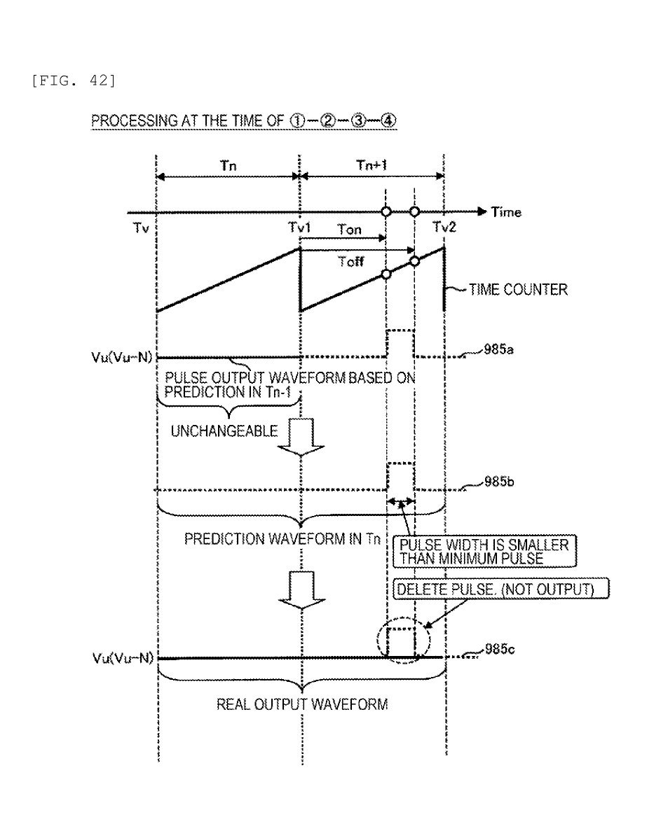

Examples of the pulse waveform output by the above pulse correction processing are illustrated in FIGS. 42 to 49. FIG. 42 illustrates an example of the pulse waveforms when the respective processing of Steps 941, 942, 943, and 944 is executed in sequence in the flowchart of FIG. 41. In this case, for example, a pulse waveform 985a is output in the control cycle Tn. The pulse waveform 985a is based on prediction in the control cycle Tn−1, and cannot be changed in the control cycle Tn. A pulse waveform 985b of the subsequent control cycle Tn+1 is predicted in the control cycle Tn. If it is determined in Step 943 that the pulse width AT in the pulse waveform 985b is lower than the minimum pulse width, the pulse in question is deleted in Step 944. As a result, no pulse is output in a corrected pulse waveform 985c really output. In this way, the minimum pulse width limitation is conducted.

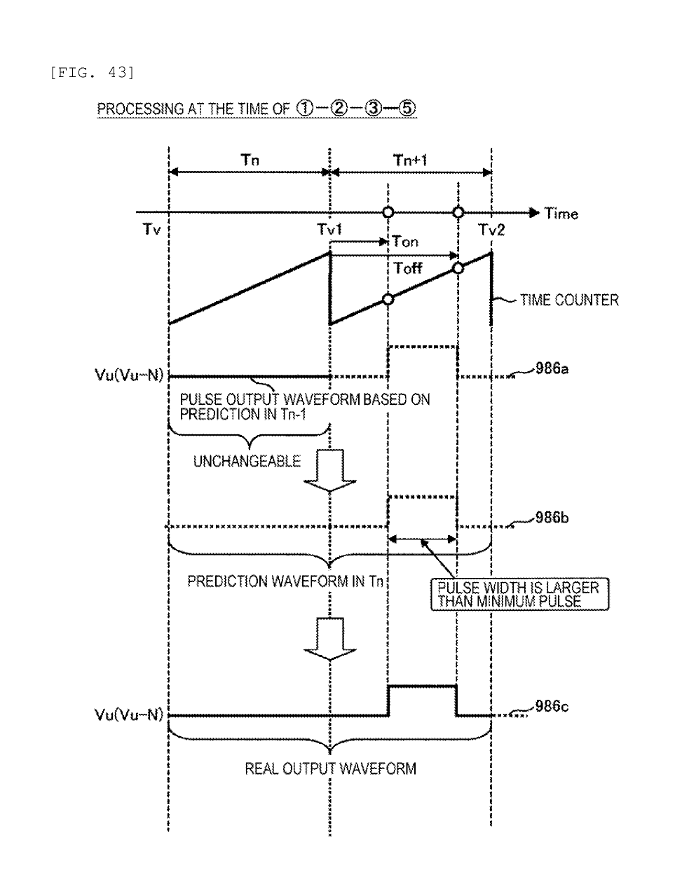

FIG. 43 illustrates an example of the pulse waveforms when the respective processing of Steps 941, 942, and 943 is executed in sequence, and the processing of Step 944 is not executed, in the flowchart of FIG. 41. In this case, for example, a pulse waveform 986a is output in the control cycle Tn. The pulse waveform 986a is based on prediction in the control cycle Tn−1, and cannot be changed in the control cycle Tn. A pulse waveform 986b of the subsequent control cycle Tn+1 is predicted in the control cycle Tn. If it is determined in Step 943 that the pulse width AT in the pulse waveform 986b is equal to or higher than the minimum pulse width, Step 944 is not executed. As a result, the pulse waveform 986b is output as the corrected pulse waveform 986c as it is.

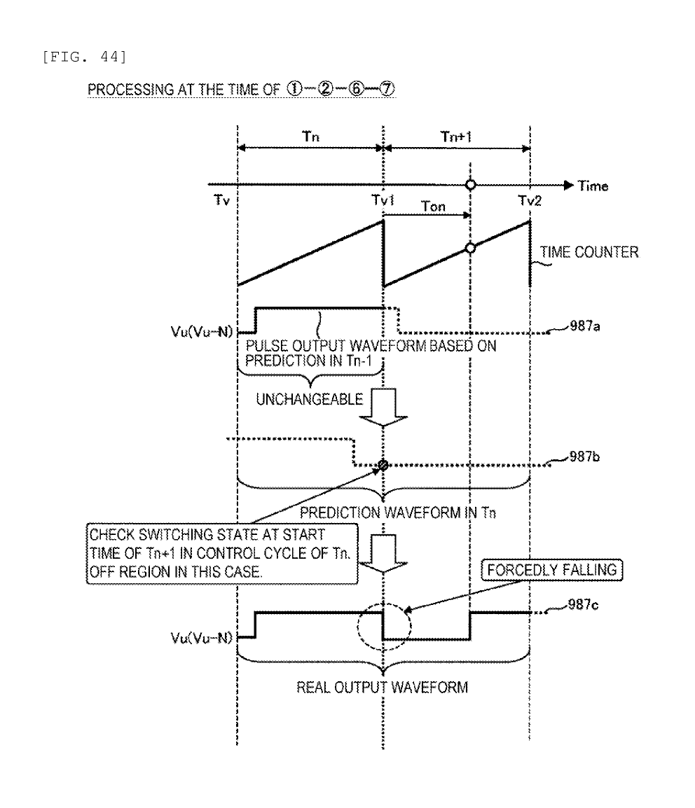

FIG. 44 illustrates an example of the pulse waveforms when the respective processing of Steps 941, 942, 945, and 946 is executed in sequence in the flowchart of FIG. 41. In this case, for example, a pulse waveform 987a is output in the control cycle Tn. The pulse waveform 987a is based on prediction in the control cycle Tn−1, and cannot be changed in the control cycle Tn. A pulse waveform 987b of the subsequent control cycle Tn+1 is predicted in the control cycle Tn. If it is determined by the pulse waveform 987b in Step 945 that the time Tv1 at the time of starting the control cycle Tn+1 is in the off region, the time Tv1 is newly set as the falling time Toff′ that has been subjected to the pulse correction in Step 946. As a result, a corrected pulse waveform 17c really output is forced to fall at a start time of the control cycle Tn+1. In this way, the pulse continuity compensation is conducted.

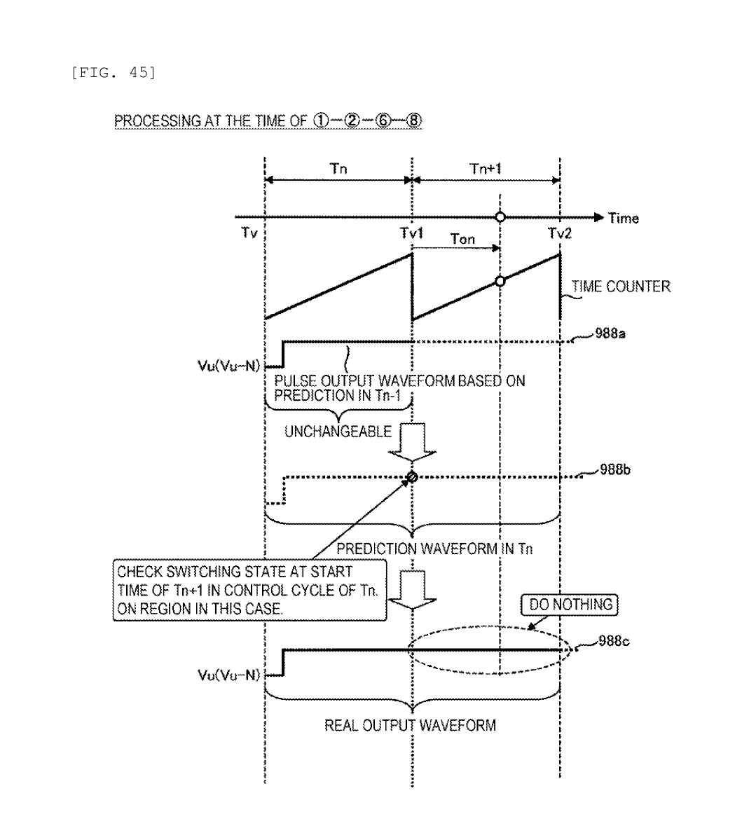

FIG. 45 illustrates an example of the pulse waveforms when the respective processing of Steps 941, 942, and 945 is executed in sequence, and the processing of Step 946 is not executed, in the flowchart of FIG. 41. In this case, for example, a pulse waveform 988a is output in the control cycle Tn. The pulse waveform 988a is based on the prediction in the control cycle Tn−1, and cannot be changed in the control cycle Tn. A pulse waveform 988b of the subsequent control cycle Tn+1 is predicted in the control cycle Tn. If it is determined by the pulse waveform 988b in Step 945 that the time Tv1 at the start time of the control cycle Tn+1 is in the on region, Step 946 is not executed. As a result, the pulse waveform 988b is output as the corrected pulse waveform 988c as it is.

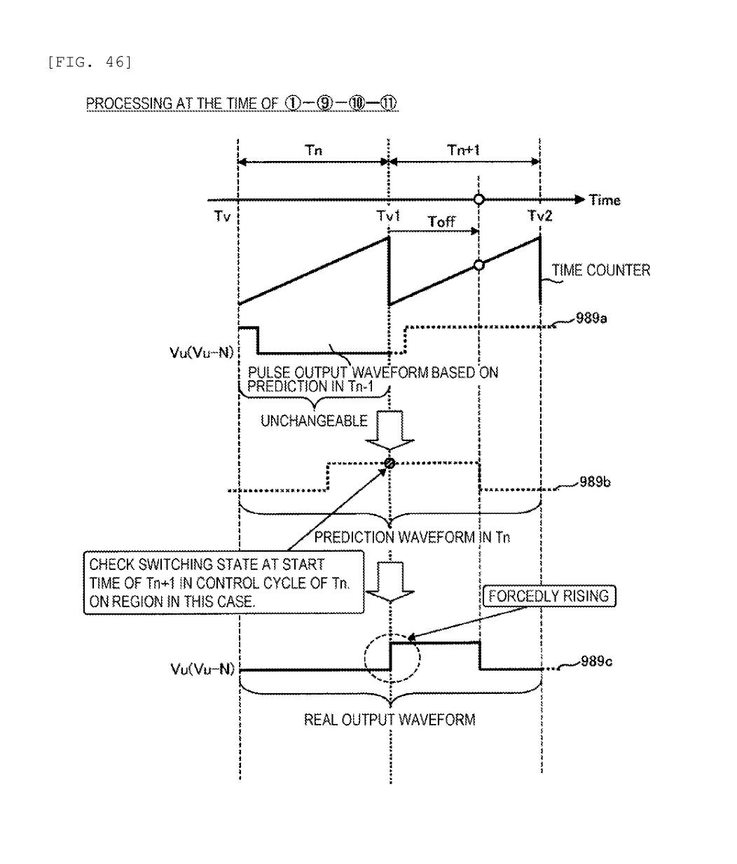

FIG. 46 illustrates an example of the pulse waveforms when the respective processing of Steps 941, 947, 948, and 949 is executed in sequence in the flowchart of FIG. 41. In this case, for example, a pulse waveform 989a is output in the control cycle Tn. The pulse waveform 989a is based on the prediction in the control cycle Tn−1, and cannot be changed in the control cycle Tn. A pulse waveform 989b of the subsequent control cycle Tn+1 is predicted in the control cycle Tn. If it is determined by the pulse waveform 989b in Step 948 that the time Tv1 at the start time of the control cycle Tn+1 is in the on region, the time Tv1 is newly set as the rising time Ton′ that has been subjected to the pulse correction in Step 949. As a result, the corrected pulse waveform 989c really output is forced to rise at the start time of the control cycle Tn+1. In this way, the pulse continuity compensation is conducted.

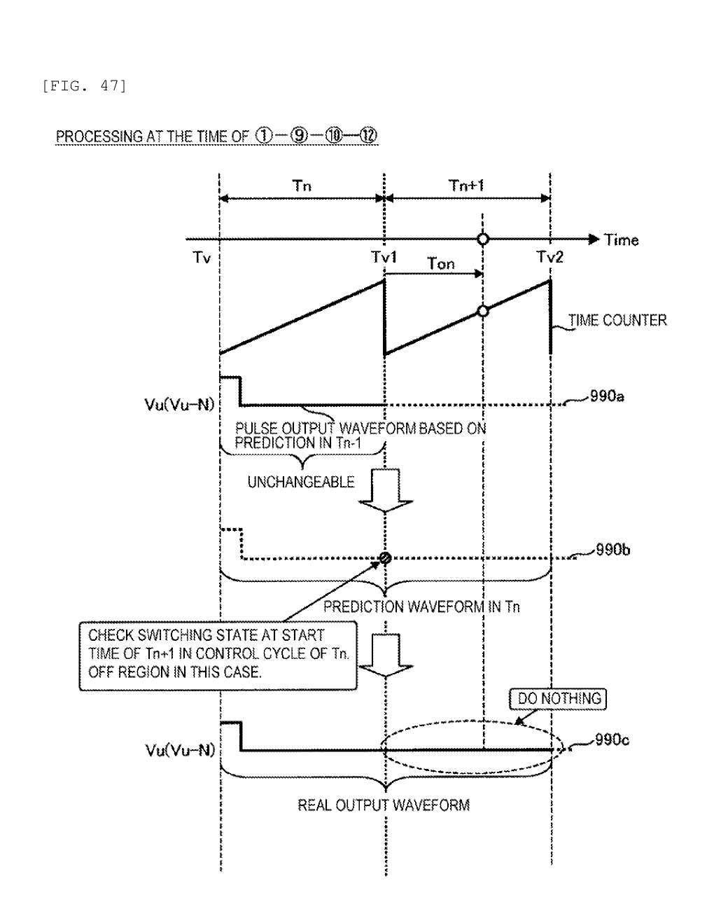

FIG. 47 illustrates an example of the pulse waveforms when the respective processing of Steps 941, 947, and 948 is executed in sequence, and the processing of Step 949 is not executed, in the flowchart of FIG. 41. In this case, for example, a pulse waveform 990a is output in the control cycle Tn. The pulse waveform 990a is based on the prediction in the control cycle Tn−1, and cannot be changed in the control cycle Tn. A pulse waveform 990b of the subsequent control cycle Tn+1 is predicted in the control cycle Tn. If it is determined by the pulse waveform 990b in Step 948 that the time Tv1 at the start time of the control cycle Tn+1 is in the off region, Step 949 is not executed. As a result, the pulse waveform 990b is output as the corrected pulse waveform 990c as it is.

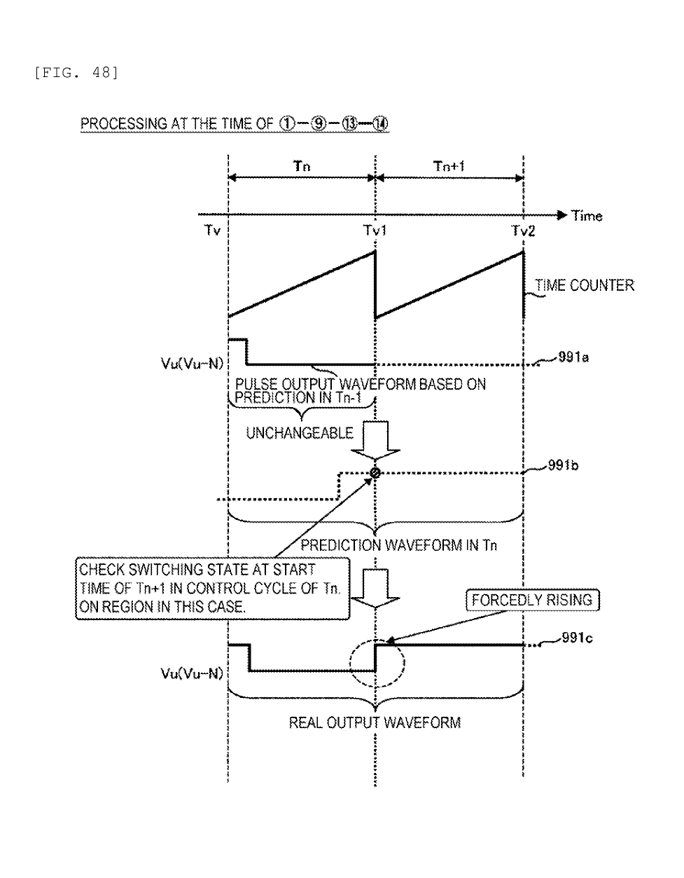

FIG. 48 illustrates an example of the pulse waveforms when the respective processing of Steps 941, 947, 950, and 951 is executed in sequence in the flowchart of FIG. 41. In this case, for example, a pulse waveform 991a is output in the control cycle Tn. The pulse waveform 991a is based on the prediction in the control cycle Tn−1, and cannot be changed in the control cycle Tn. A pulse waveform 21b of the subsequent control cycle Tn+1 is predicted in the control cycle Tn. If it is determined by the pulse waveform 991b in Step 950 that the time Tv1 at the start time of the control cycle Tn+1 is in the on region, the time Tv1 is newly set as the rising time Ton′ that has been subjected to the pulse correction in Step 951. As a result, the corrected pulse waveform 991c really output is forced to rise at the start time of the control cycle Tn+1. In this way, the pulse continuity compensation is conducted.

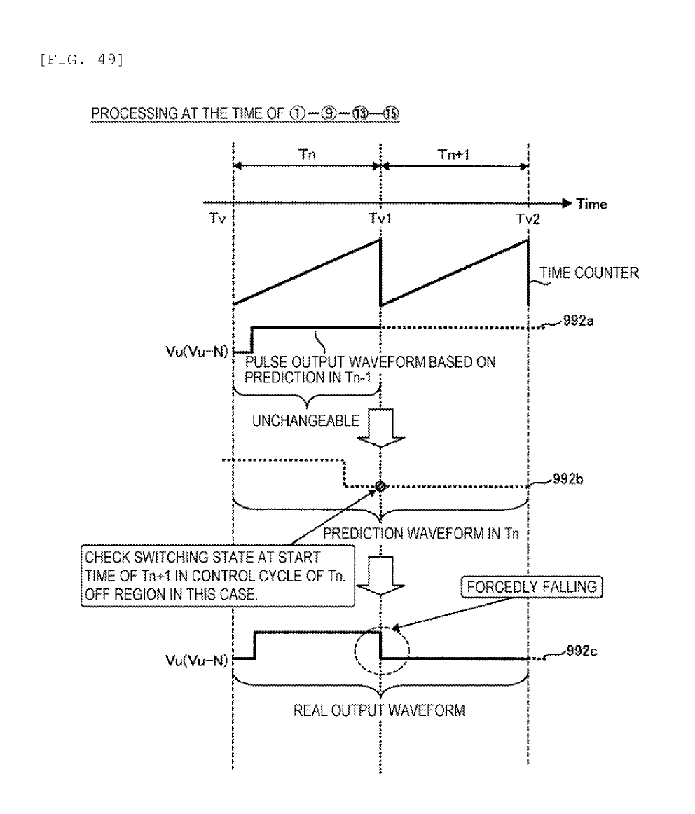

FIG. 49 illustrates an example of the pulse waveforms when the respective processing of Steps 941, 947, 950, and 952 is executed in sequence in the flowchart of FIG. 41. In this case, for example, a pulse waveform 992a is output in the control cycle Tn. The pulse waveform 992a is based on the prediction in the control cycle Tn−1, and cannot be changed in the control cycle Tn. A pulse waveform 992b of the subsequent control cycle Tn+1 is predicted in the control cycle Tn. If it is determined by the pulse waveform 992b in Step 950 that the time Tv1 at the start time of the control cycle Tn+1 is in the off region, the time Tv1 is newly set as the falling time Toff′ that has been subjected to the pulse correction in Step 952. As a result, the corrected pulse waveform 992c really output is forced to fall at the start time of the control cycle Tn+1. In this way, the pulse continuity compensation is conducted.

The embodiments described above obtain the following advantageous effects.

(1) The power conversion device 200 connected to the motor generator 192 (MG1) which is a permanent magnet motor includes the inverter circuit 140 which is a power switching circuit, the control circuit 172, and the driver circuit 174. The inverter circuit 140 includes the plurality of series circuits 150 each having the IGBT 328 which is the switching element for the upper arm connected in series with the IGBT 330 which is the switching element for the lower arm. The inverter circuit 140 receives the DC power from the battery 136 to generate the AC power. Then, the inverter circuit 140 outputs the generated AC power to the motor generator 192. The control circuit 172 repetitively calculates the state of the IGBTs 328 and 330 on the basis of the input information from the host control device every given control cycle, and generates the control signal for controlling the conduction or cut-off of the IGBTs 328 and 330 according to the arithmetic results. The driver circuit 174 generates the drive signal for rendering the IGBTs 328 and 330 conductive or non-conductive on the basis of the control signal from the control circuit 172. In this situation, as illustrated in FIGS. 25 to 28, the control circuit 172 predicts the locus of the d-axial magnetic flux φd which is the d-axial component of the magnetic flux developed in the motor generator 192, and the locus of the q-axial magnetic flux φd which is the q-axial component of the magnetic flux developed in the motor generator 192, and calculates the state of the IGBTs 328 and 330 so that the d-axial magnetic flux φd falls within the given d-axial magnetic flux fluctuation range Δφd, and the q-axial magnetic flux φq falls within the given q-axial magnetic flux fluctuation range Δφq, on the basis of the prediction result. With the above configuration, the power conversion device 200 can suppress an increase in the motor moss to some degree, and further reduce the switching loss.
(2) As illustrated in FIG. 31, the pulse modulator 230 of the control circuit 172 includes the αβ converter 231 as the coordinate converter, the voltage vector region retriever 232, the SW state predictor 233, the three-phase SW time arithmetic unit 234 as the signal output unit, and the time counter comparator 236. The αβ converter 231 converts the d-axial voltage instruction signal Vd* and the q-axial voltage instruction signal Vq* which are the voltage instruction signals of the rotating coordinate system defined by the d-axis and the q-axis, based on the input information from the host control device into the a-axis voltage instruction signal Vα* and the β-axial voltage instruction signal Vβ* which are the voltage instruction signals of the given stationary coordinate system. The voltage vector region retriever 232 retrieves the voltage vector region corresponding to the voltage instruction signal from the region “1” to the region “6” in FIG. 33 on the basis of the a-axis voltage instruction signal Vα* and the β-axial voltage instruction signal Vβ* converted by the αβ converter 231, and determines the output voltage vector corresponding to the retrieved voltage vector region from the voltage vectors V0 to V7. The SW state predictor 233 predicts the locus of the d-axial magnetic flux φq and the locus of the q-axial magnetic flux φg on the basis of the output voltage vector determined by the voltage vector region retriever 232, compares the locus of the predicted d-axial magnetic flux φd with the d-axial magnetic flux fluctuation range Δφd, and the locus of q-axial magnetic flux φq with the q-axial magnetic flux fluctuation range Δφq, respectively, and calculates the state of the IGBTs 328, 330 and the switching time. The three-phase SW time arithmetic unit 234 and the time counter comparator 236 outputs the control signal on the basis of the state of the IGBTs 328 and 330, and the switching time calculated by the SW state predictor 233. With the above configuration, the respective loci of the d-axial magnetic flux φd and the q-axial magnetic flux φq are predicted with precision, and the control signal can be output so that the respective loci surely fall within the d-axial magnetic flux fluctuation range Δφd and the q-axial magnetic flux fluctuation range Δφq.
(3) If the electrical resistance value of the permanent magnet arranged in the rotor of the motor generator 192 is smaller than the electrical resistance value of the iron core of the rotor, the d-axial magnetic flux fluctuation range Δφd can be set to be smaller than the q-axial magnetic flux fluctuation range Δφq. On the contrary, if the electrical resistance value of the permanent magnet arranged in the rotor of the motor generator 192 is larger than the electrical resistance value of the iron core of the rotor, the d-axial magnetic flux fluctuation range Δφd can be set to be larger than the q-axial magnetic flux fluctuation range Δφq. With the above configuration, the loss of the motor generator 192 can be further reduced.

In the above embodiment, the respective loci of the d-axial magnetic flux φd and the q-axial magnetic flux φq developed in the motor generator 192 are predicted, and the state of the IGBTs 328 and 330 which are the switching elements of the respective phases of U, V, and W, and the switching time are determined so that the respective loci fall within the d-axial magnetic flux fluctuation range Δφd and the q-axial magnetic flux fluctuation range Δφq. However, instead of the magnetic flux, the respective loci of the d-axial current Id and the q-axial current Iq flowing in the motor generator 192 may be predicted, and the state of the respective switching elements, and the switching time may be determined so that the respective loci fall within the d-axial current flux fluctuation range ΔId and the q-axial current flux fluctuation range ΔIq. In this case, when it is assumed that an inductance of the d-axis in the motor generator 192 is Ld and an inductance of the q-axis is Lq, a relationship of Expression (4) is satisfied between the d-axial magnetic flux φd and the q-axial magnetic flux φq, and the d-axial current Id and the q-axial current Iq. With the use of this Expression (4), as in the above embodiment, the respective loci of the d-axial current Id and the q-axial current Iq can be predicted, and a control can be conducted by the control circuit 172 so that the respective loci fall within the d-axial current fluctuation range ΔId and the q-axial current fluctuation range ΔIq.

φd=Ld·Id

φq=Lq·Iq (4)

The embodiments and the advantageous effects described above are consistently exemplary, and the present invention is not limited to the configurations of the above embodiments.

Various embodiments and the modified examples have been described above. However, the present invention is not limited to those contents. The other examples conceivable without departing from the technical concept of the present invention are also included in the present invention.

The disclosure of the following basic priority application is incorporated herein by reference in its entirety.

Japanese Patent No. 2011-188155 (filed on Aug. 31, 2011).

1. A power conversion device connected to a permanent magnet motor, comprising:
a power switching circuit that has a plurality of series circuits each having an upper arm switching element connected in series with a lower arm switching element, receives a DC power to generate an AC power, and outputs the generated AC power to the permanent magnet motor;
a control circuit that repetitively calculates a state of the switching elements on the basis of input information for each given control cycle, and generates a control signal for controlling conduction or cut-off of the switching elements according to an arithmetic result; and
a driver circuit that generates a drive signal that renders the switching element conductive or non-conductive on the basis of the control signal from the control circuit,
wherein the control circuit predicts a locus of a d-axial magnetic flux which is a d-axial component of a magnetic flux developed in the permanent magnet motor, and a locus of a q-axial magnetic flux which is a q-axial component of the magnetic flux developed in the permanent magnet motor, and calculates the state of the switching elements so that the d-axial magnetic flux falls within a given d-axial magnetic flux fluctuation range, and the q-axial magnetic flux falls within a given q-axial magnetic flux fluctuation range, on the basis of a prediction result,
wherein the d-axis is a coordinate axis defined along a main magnetic flux direction of a permanent magnet arranged in a rotor of the permanent magnet motor, and
wherein the q-axis is a coordinate axis defined along a direction orthogonal to the d-axis.

2. The power conversion device according to claim 1,
wherein the control circuit comprises:
a coordinate converter that converts a voltage instruction signal of a rotating coordinate system defined by the d-axis and the q-axis based on the input information into a voltage instruction signal of a given stationary coordinate system;
a voltage vector region retriever that retrieves a voltage vector region corresponding to the voltage instruction signal on the basis of the voltage instruction signal converted by the coordinate converter, and determines an output voltage vector corresponding to the retrieved voltage vector region;
a predictor that predicts the locus of the d-axial magnetic flux and the locus of the q-axial magnetic flux on the basis of the output voltage vector determined by the voltage vector region retriever, compares the locus of the predicted d-axial magnetic flux with the d-axial magnetic flux fluctuation range, and the locus of q-axial magnetic flux with the q-axial magnetic flux fluctuation range, respectively, and calculates the state of the switching elements and a switching time; and
a signal output unit that outputs the control signal on the basis of the state of the switching elements and the switching time calculated by the predictor.

3. The power conversion device according to claim 1,
wherein if an electrical resistance value of the permanent magnet is smaller than an electrical resistance value of an iron core of the rotor, the d-axial magnetic flux fluctuation range is set to be smaller than the q-axial magnetic flux fluctuation range, and
wherein if the electrical resistance value of the permanent magnet is larger than the electrical resistance value of the iron core of the rotor, the d-axial magnetic flux fluctuation range is set to be larger than the q-axial magnetic flux fluctuation range.

4. A power conversion device connected to a permanent magnet motor, comprising:
a power switching circuit that has a plurality of series circuits each having an upper arm switching element connected in series with a lower arm switching element, receives a DC power to generate an AC power, and outputs the generated AC power to the permanent magnet motor;
a control circuit that repetitively calculates a state of the switching elements on the basis of input information for each given control cycle, and generates a control signal for controlling conduction or cut-off of the switching elements according to an arithmetic result; and
a driver circuit that generates a drive signal that renders the switching element conductive or non-conductive on the basis of the control signal from the control circuit,
wherein the control circuit predicts a locus of a d-axial current which is a d-axial component of a current flowing in the permanent magnet motor, and a locus of a q-axial current which is a q-axial component of the current flowing in the permanent magnet motor, and calculates the state of the switching elements so that the d-axial current falls within a given d-axial current fluctuation range, and the q-axial current falls within a given q-axial current fluctuation range, on the basis of a prediction result,
wherein the d-axis is a coordinate axis defined along a main magnetic flux direction of a permanent magnet arranged in a rotor of the permanent magnet motor, and
wherein the q-axis is a coordinate axis defined along a direction orthogonal to the d-axis.

5. The power conversion device according to claim 4,
wherein the control circuit comprises:
a coordinate converter that converts a voltage instruction signal of a rotating coordinate system defined by the d-axis and the q-axis based on the input information into a voltage instruction signal of a given stationary coordinate system;
a voltage vector region retriever that retrieves a voltage vector region corresponding to the voltage instruction signal on the basis of the voltage instruction signal converted by the coordinate converter, and determines an output voltage vector corresponding to the retrieved voltage vector region;
a predictor that predicts the locus of the d-axial current and the locus of the q-axial current on the basis of the output voltage vector determined by the voltage vector region retriever, compares the locus of the predicted d-axial current with the d-axial current fluctuation range, and the locus of q-axial current with the q-axial current fluctuation range, respectively, and calculates the state of the switching elements and a switching time; and
a signal output unit that outputs the control signal on the basis of the state of the switching elements and the switching time calculated by the predictor.

6. The power conversion device according to claim 4,
wherein if an electrical resistance value of the permanent magnet is smaller than an electrical resistance value of an iron core of the rotor, the d-axial current fluctuation range is set to be smaller than the q-axial current fluctuation range, and
wherein if the electrical resistance value of the permanent magnet is larger than the electrical resistance value of the iron core of the rotor, the d-axial current fluctuation range is set to be larger than the q-axial current fluctuation range.

7. The power conversion device according to claim 2,
wherein if an electrical resistance value of the permanent magnet is smaller than an electrical resistance value of an iron core of the rotor, the d-axial magnetic flux fluctuation range is set to be smaller than the q-axial magnetic flux fluctuation range, and
wherein if the electrical resistance value of the permanent magnet is larger than the electrical resistance value of the iron core of the rotor, the d-axial magnetic flux fluctuation range is set to be larger than the q-axial magnetic flux fluctuation range.

8. The power conversion device according to claim 5,
wherein if an electrical resistance value of the permanent magnet is smaller than an electrical resistance value of an iron core of the rotor, the d-axial current fluctuation range is set to be smaller than the q-axial current fluctuation range, and
wherein if the electrical resistance value of the permanent magnet is larger than the electrical resistance value of the iron core of the rotor, the d-axial current fluctuation range is set to be larger than the q-axial current fluctuation range.
